(19) United States
(12) Patent Application Publication
(10) Pub. No.: US 2024/0033639 A1
(43) Pub. Date: Feb. 1, 2024

(54) COLLECTING COUPON NFT VIA A CLIENT DEVICE AND METHODS FOR USE THEREWITH

(71) Applicant: Galiant Arts, LLC, Austin, TX (US)

(72) Inventors: Mark Meyers, Austin, TX (US); Bruce E. Stuckman, Austin, TX (US); John W. Howard, Cedar Park, TX (US); Brian G. Howard, Austin, TX (US); Gregory Meador, Austin, TX (US)

(73) Assignee: Galiant Arts, LLC, Austin, TX (US)

(21) Appl. No.: 18/485,587

(22) Filed: Oct. 12, 2023

Related U.S. Application Data
(63) Continuation-in-part of application No. 18/299,217, filed on Apr. 12, 2023.
Application No. 18/299,217 is a continuation of application No. 17/656,084, filed on Mar. 23, 2022, now Pat. No. 11,786,820.
(60) Provisional application No. 63/262,536, filed on Oct. 14, 2021.
(60) Provisional application No. 63/262,762, filed on Oct. 20, 2021.
(60) Provisional application No. 63/262,858, filed on Oct. 21, 2021.
(60) Provisional application No. 63/263,844, filed on Nov. 10, 2021.
(60) Provisional application No. 63/264,811, filed on Dec. 2, 2021.
(60) Provisional application No. 63/265,754, filed on Dec. 20, 2021.
(60) Provisional application No. 63/266,478, filed on Jan. 6, 2022.
(60) Provisional application No. 63/297,394, filed on Jan. 7, 2022.
(60) Provisional application No. 63/302,757, filed on Jan. 25, 2022.
(60) Provisional application No. 63/302,768, filed on Jan. 25, 2022.
(60) Provisional application No. 63/305,559, filed on Feb. 1, 2022.
(60) Provisional application No. 63/305,505, filed on Feb. 1, 2022.
(60) Provisional application No. 63/306,405, filed on Feb. 3, 2022.
(60) Provisional application No. 63/306,412, filed on Feb. 3, 2022.
(60) Provisional application No. 63/307,349, filed on Feb. 7, 2022.
(60) Provisional application No. 63/308,546, filed on Feb. 10, 2022.
(60) Provisional application No. 63/309,382, filed on Feb. 11, 2022.
(60) Provisional application No. 63/310,376, filed on Feb. 15, 2022.
(60) Provisional application No. 63/386,070, filed on Dec. 5, 2022.
(60) Provisional application No. 63/386,074, filed on Dec. 5, 2022.
(60) Provisional application No. 63/386,078, filed on Dec. 5, 2022.
(60) Provisional application No. 63/386,081, filed on Dec. 5, 2022.

(51) Int. Cl. A63F 13/60; H04L 9/00; A63F 13/352; A63F 13/79

(52) U.S. Cl. CPC A63F 13/60; H04L 9/50; A63F 13/352; A63F 13/79

(57) ABSTRACT

A client device operates by: reading an optical code associated with a coupon; sending, in response to reading the optical code, a request to download a coupon NFT associated with the coupon from an NFT distribution platform; downloading from the NFT distribution platform, via the client device, the coupon NFT associated with the coupon; and storing the coupon NFT in a wallet associated with a user of the client device.

### CROSS-REFERENCE TO RELATED APPLICATIONS

The present U.S. Utility Patent application claims priority pursuant to 35 U.S.C. § 120 as a continuation-in-part of U.S. Utility application Ser. No. 18/299,217, entitled “FACILITATING AUTHENTICATED PLAY OF GAMES VIA GAME NFTS”, filed Apr. 12, 2023, which is a continuation of U.S. Utility application Ser. No. 17/656,084, entitled “FACILITATING PLAY OF GAME NFTS VIA A CLIENT DEVICE”, filed Mar. 23, 2022, issued as U.S. Pat. No. 11,786,820 on Oct. 17, 2023, which claims priority pursuant to 35 U.S.C. § 119(e) to U.S. Provisional Application No. 63/262,536, entitled “NFT COLLECTION PLATFORM AND METHODS FOR USE THEREWITH”, filed Oct. 14, 2021; U.S. Provisional Application No. 63/262,762, entitled “NFT COLLECTION PLATFORM FOR PROCESSING NFTS AND DATA AND METHODS FOR USE THEREWITH”, filed Oct. 20, 2021; U.S. Provisional Application No. 63/262,858, entitled “NFT COLLECTION PLATFORM FOR PROCESSING NFTS AND DATA AND METHODS FOR USE THEREWITH”, filed Oct. 21, 2021; U.S. Provisional Application No. 63/263,844, entitled “NFT COLLECTION PLATFORM FOR RENDERING NFTS IN AN ENVIRONMENT AND METHODS FOR USE THEREWITH”, filed Nov. 10, 2021; U.S. Provisional Application No. 63/264,811, entitled “CLIENT DEVICE FOR NFTS AND METHODS FOR USE THEREWITH”, filed Dec. 2, 2021; U.S. Provisional Application No. 63/265,754, entitled “REAL ESTATE NFTS AND METHODS FOR USE THEREWITH”, filed Dec. 20, 2021; U.S. Provisional Application No. 63/266,478, entitled “AUTHENTICATED LICENSE NFTS AND METHODS FOR USE THEREWITH”, filed Jan. 6, 2022; U.S. Provisional Application No. 63/297,394, entitled “GENERATION OF ENHANCEMENT NFTS AND METHODS FOR USE THEREWITH”, filed Jan. 7, 2022; U.S. Provisional Application No. 63/302,757, entitled “GENERATION OF NFT GALLERIES AND METHODS FOR USE THEREWITH”, filed Jan. 25, 2022; U.S. Provisional Application No. 63/302,768, entitled “ENHANCEMENT OF REAL ESTATE NFTS VIA NFT GALLERIES”, filed Jan. 25, 2022; U.S. Provisional Application No. 63/305,559, entitled “AUTHENTICATING NFT TRANSACTIONS VIA CONDITIONAL NFTS”, filed Feb. 1, 2022; U.S. Provisional Application No. 63/305,505, entitled “GENERATING A SECURE REAL-TIME NFT REPOSITORY FOR AUTHENTICATING NFT TRANSACTIONS”, filed Feb. 1, 2022; U.S. Provisional Application No. 63/306,405, entitled “GENERATING NFTS WITH FRACTIONAL RIGHTS IN ASSETS”, filed Feb. 3, 2022; U.S. Provisional Application No. 63/306,412, entitled “GENERATING NFTS WITH FRACTIONAL RIGHTS IN A COLLECTABLE”, filed Feb. 3, 2022; U.S. Provisional Application No. 63/307,349, entitled “STREAMING OF VIDEO NFTS TO A CLIENT DEVICE”, filed Feb. 7, 2022; U.S. Provisional Application No. 63/308,546, entitled “NODE NFTS WITH TRANSACTION UPDATES”, filed Feb. 10, 2022; U.S. Provisional Application No. 63/309,382, entitled “GENERATING PLAYABLE GAME NFTS”, filed Feb. 11, 2022; and U.S. Provisional Application No. 63/310,376, entitled “GENERATING UPDATED TEAM NFTS BASED ON TEAM DATA”, filed Feb. 15, 2022, all of which are hereby incorporated herein by reference in their entirety and made part of the present U.S. Utility Patent Application for all purposes.

The present U.S. Utility Patent application claims priority pursuant to 35 U.S.C. § 119(e) to U.S. Provisional Application No. 63/386,070, entitled “SYSTEMS FOR COUPON NFT TRANSACTIONS AND METHODS FOR USE THEREWITH”, filed Dec. 5, 2022; U.S. Provisional Application No. 63/386,074, entitled “SYSTEMS FOR GENERATING COUPON NFTS AND METHODS FOR USE THEREWITH”, filed Dec. 5, 2022; U.S. Provisional Application No. 63/386,078, entitled “SYSTEMS FOR AUTHENTICATING COUPON NFTS AND METHODS FOR USE THEREWITH”, filed Dec. 5, 2022; and U.S. Provisional Application No. 63/386,081, entitled “SYSTEMS FOR USE WITH LOYALTY PROGRAM NFTS AND METHODS FOR USE THEREWITH”, filed Dec. 5, 2022, all of which are hereby incorporated herein by reference in their entirety and made part of the present U.S. Utility Patent Application for all purposes.

### TECHNICAL FIELD

The present disclosure relates to processing systems and applications used in the collection, generation, display and use of non-fungible tokens (NFTs) or other digital tokens.

### BRIEF DESCRIPTION OF THE SEVERAL VIEWS OF THE DRAWINGS

FIG. 1A presents a block diagram representation of an example system.

FIG. 1B presents a block diagram representation of an example non-fungible token (NFT) collection platform.

FIG. 2 presents a block diagram representation of an example client device.

FIG. 3A presents a flowchart representation of an example method.

FIGS. 3B-3F and 3H present pictorial representations of example screen displays.

FIG. 3G presents a flow diagram representation of an example process.

FIG. 3I presents a flowchart representation of an example method.

FIG. 4A presents a flowchart representation of an example method.

FIG. 4B presents a pictorial representation of an example screen display.

FIG. 4C presents a flow diagram representation of an example process.

FIG. 5A presents a flowchart representation of an example method.

FIGS. 5B and 5C present pictorial representations of example screen displays.

FIG. 6 presents a block diagram/flow representation of an example of NFT generation.

FIG. 7 presents a block diagram representation of an example system.

FIG. 8 presents a block diagram representation of an example client device.

FIG. 9A presents a block diagram/flow representation of an example of NFT generation.

FIG. 9B presents a pictorial representation of an example NFT.

FIG. 9C presents a pictorial representation of an example improvement.

FIG. 9D presents a pictorial representation of an example NFT.

FIG. 9E presents a flowchart representation of an example method.

FIG. 10A presents a block diagram/flow representation of an example of NFT generation.

FIG. 10B presents a flowchart representation of an example method.

FIG. 11A presents a block diagram/flow representation of an example of NFT generation.

FIG. 11B presents a pictorial representation of an example NFT.

FIG. 11C presents a pictorial representation of example enhancements.

FIG. 11D presents a pictorial representation of an example NFT.

FIG. 11E presents a flowchart representation of an example method.

FIG. 12A presents a block diagram representation of an example system.

FIG. 12B presents pictorial representations of a plurality of example screen displays.

FIG. 12C presents a pictorial representation of an example POS NFT.

FIG. 12D presents a flowchart representation of an example method.

FIG. 12E presents a flowchart representation of an example method.

FIG. 12F presents a flowchart representation of an example method.

FIG. 12G presents a flowchart representation of an example method.

FIG. 12H presents a flowchart representation of an example method.

FIG. 12I presents a block diagram of an example system.

FIG. 12J presents a flowchart representation of an example method.

FIG. 13A presents a block diagram representation of an example system.

FIG. 13B presents a flowchart representation of an example method.

FIG. 13C presents a flowchart representation of an example method.

FIG. 13D presents a pictorial block/flow diagram representation of an example system.

FIG. 13E presents a pictorial block/flow diagram representation of an example system.

FIG. 13F presents a flowchart representation of an example method.

FIG. 13G presents a flowchart representation of an example method.

FIG. 13H presents a flowchart representation of an example method.

FIG. 13I presents a flowchart representation of an example method.

FIG. 14A presents a pictorial diagram representation of an example coupon.

FIG. 14B presents a pictorial diagram representation of an example client device.

FIG. 14C presents a flowchart representation of an example method.

FIG. 15A presents a pictorial diagram representation of an example coupon.

FIG. 15B presents a pictorial diagram representation of an example coupon.

FIG. 15C presents a pictorial diagram representation of an example client device.

FIG. 15D presents a pictorial diagram representation of an example client device.

FIG. 15E presents a flowchart representation of an example method.

FIG. 15F presents a flowchart representation of an example method.

FIG. 16A presents a block diagram representation of an example system.

FIG. 16B presents a pictorial block/flow diagram representation of an example system.

FIG. 16C presents a pictorial block/flow diagram representation of an example system.

FIG. 16D presents a flowchart representation of an example method.

FIG. 16E presents a flowchart representation of an example method.

FIG. 17A presents pictorial representations of a plurality of example screen displays.

FIG. 17B presents a pictorial representation of an example Coupon NFT.

FIG. 17C presents a flowchart representation of an example method.

FIG. 17D presents a flowchart representation of an example method.

FIG. 17E presents a flowchart representation of an example method.

FIG. 17F presents a flowchart representation of an example method.

FIG. 17G presents a flowchart representation of an example method.

FIG. 17H presents a flowchart representation of an example method.

FIG. 17I presents a flowchart representation of an example method.

FIG. 17J presents a flowchart representation of an example method.

FIG. 17K presents a flowchart representation of an example method.

FIG. 17L presents a flowchart representation of an example method.

FIG. 17M presents a flowchart representation of an example method.

FIG. 18A presents a pictorial block/flow diagram representation of an example system.

FIG. 18B presents a flowchart representation of an example method.

FIG. 18C presents a flowchart representation of an example method.

FIG. 18D presents a flowchart representation of an example method.

FIG. 18E presents a flowchart representation of an example method.

FIG. 18F presents a flowchart representation of an example method.

FIG. 18G presents a flowchart representation of an example method.

### DETAILED DESCRIPTION

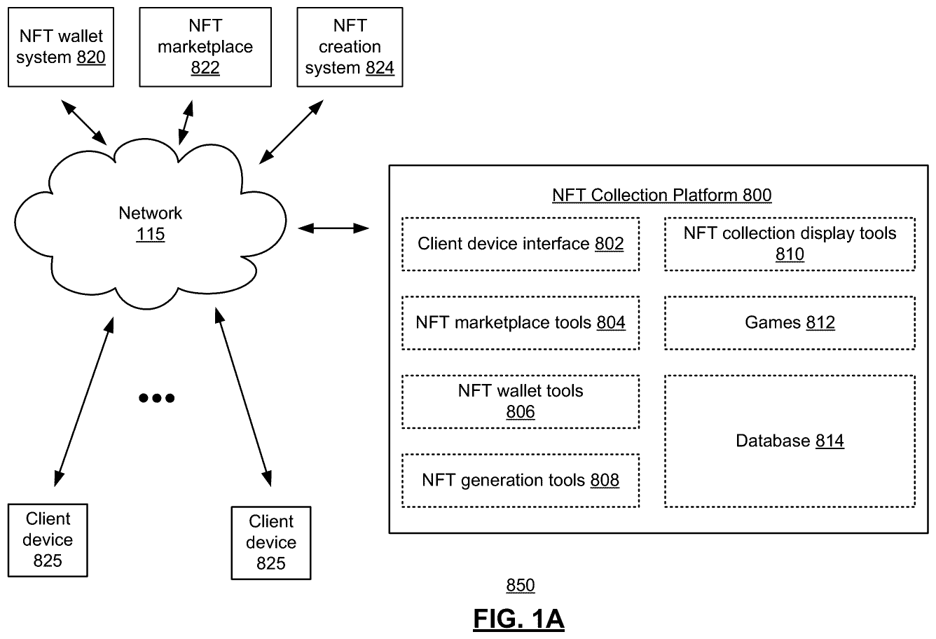

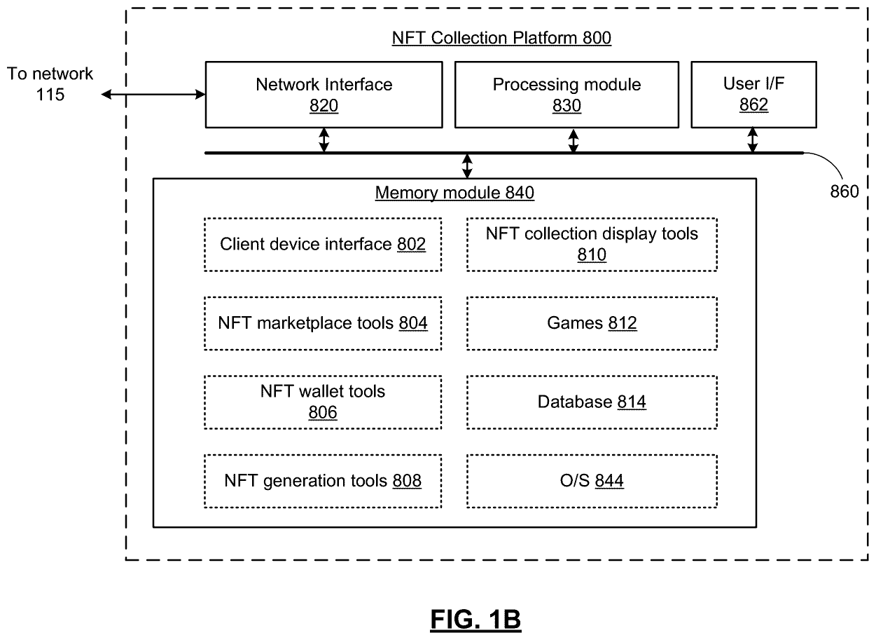

FIG. 1A presents a block diagram representation of an example system in accordance with various examples. In particular, a system 850 is presented that includes an NFT collection platform 800 that communicates with client devices 825 via a network 115. The network 115 can be the Internet or other wide area or local area network, either public or private. The client devices 825 can be computing devices such as laptops, smartphones, smart watches, tablets, desktops, or other computing devices associated with users, for example, buyers, sellers, collectors and/or users of NFTs.

NFT creation and ownership is growing worldwide. Existing platforms provide tools to create NFTs, marketplaces for buying and selling NFTs and wallets to securely hold them. Many NFT purchasers however, view NFTs similarly to cryptocurrency, purely as financial investments to be collected and later sold. Unlike cryptocurrencies which are fungible tokens, NFTs have a non-fungible (e.g. unique or limited) component that can correspond to photographs, graphics, art, video, games or other media or imagery that can be displayed, used in authentication and/or to provide other support for transactions and/or used in game play and for other utilitarian purposes, etc.

In the example shown, the NFT collection platform 800 includes a client device interface 802 for interacting with the client devices 825, NFT marketplace tools 804, NFT wallet tools 806, NFT generation tools 808, NFT collection display tools 810, one or more games 812 that can be played using NFTs that have been collected including game NFTs that include and/or otherwise associated with, or correspond to, playable game content, and a database 814 for storing user and account information, preferences, display settings and other data associated with users of the NFT collection platform 800. The NFT collection platform 800 can include or be implemented via one or more servers, a cloud computing system, an InterPlanetary File System (IPFS) or other decentralized or distributed computer system of individual computers and/or nodes and/or a centralized computing system.

For example, the client device interface 802 can operate in conjunction with each client device 825 and via network 115 to generate a graphical user interface. This graphical user interface is based on display data generated by the NFT collection platform 800 in a format for display on a display device associated with the client devices 825. This graphical user interface generates input data that is received by the NFT collection platform 800 from the client devices 825 in response to user interaction with the graphical user interface.

In various examples, the NFT collection platform 800 can serve the needs of a collector of NFTs by providing a system that offers new experiences that support various collector and/or use behaviors in the NFT world and metaverse including the collection, display, and use of NFTs and their corresponding content. The NFT collection display tools 810 can include a high-fidelity customizable page builder so each collector can personalize and display their NFTs in an environment. The NFT collection platform 800 can provide and support a collection social media site that, for example, is similar to MySpace, Facebook, or OnlyFans, but specifically directed to the arrangement, posting, sharing and/or display of collections of NFTs.

In the most basic mode of operation, the NFT collection platform 800 improves the technology of NFT systems by allowing the user to collect, arrange and display NFTs they have purchased so that the user, and other users, can enjoy and admire the NFTs they have collected. The NFT collection platform 800 not only allows users to curate, display and use their collections, to play games associated with their NFTs and/or also allows users to create a social/professional profile of their NFT property—enabling users to get creative with how their collections are presented, used and displayed. In addition, when a group of NFTs is collected and/or when a personalized/curated collection page, set and/or collection display is built, the NFT collection platform 800 improves the technology of NFT systems by allowing the user to mint a new “collection NFT” using blockchain-based, distributed computer network, and/or other crypto-based NFT creation techniques, for example and authenticated based on the user's ownership of the underlying NFTs.

Furthermore, the NFT collection platform 800 allows users to buy, sell, loan, borrow and trade NFTs with other users, including their own collection NFTs created based on their own collections. In various examples, the NFT collection platform 800 may not include a NFT creator, marketplace or wallet itself. The NFT generation tools 808, NFT wallet tools 806 and NFT marketplace tools 804 can reside on the NFT collection platform 800 and interface with one or more NFT wallet systems 820, NFT marketplaces 822 and/or NFT creation systems 824 to enable transactions/interactions/abilities at a metaverse level, offering collectors new and unique experiences, pre and post purchase, across all different NFT's and blockchains in one place. The NFT collection platform 800 improves the technology of NFT systems by allowing the user to perform the functions above in a fashion, that can be blockchain, wallet, and marketplace agnostic.

It should be noted that the system 850 can operate via blockchain-based technologies. In blockchain, a growing list of records, called “blocks”, are linked together using cryptography and spread over a decentralized computer system/network or other distributed network of participants. Each block contains a cryptographic hash of the previous block, a timestamp, and transaction data (generally represented as a Merkle tree). The timestamp proves that the transaction data existed when the block was published in order to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks. The distributed nature of this process over different nodes, the contemporaneous nature of geographically distinct calculations, coupled with the extreme computational complexity of the required calculations means that these blockchain-based technologies cannot practically be performed by the human mind.

It should be noted, that while the NFT wallet system 820, NFT marketplace 822 and NFT creation system 824 are shown as separate entities and as being external to the NFT collection platform 800, other configurations are possible where two or more of these entities share a common platform and/or the functions and features of one or more of these entities can be incorporated within the NFT collection platform 800 itself.

It should also be noted that while client device interface 802, NFT marketplace tools 804, NFT wallet tools 806, NFT generation tools 808, NFT collection display tools 810, games 812 and database 814 are shown as being internal to the NFT collection platform 800, in other examples, any subset of the various elements of the NFT collection platform 800 can be implemented external to the NFT collection platform 800 and coupled to the other components via the network 115. Furthermore, the NFT collection platform 800 can be implemented in a cloud computing configuration with any or all of the various elements of the NFT collection platform 800 implemented within the cloud.

The further operation of this system will be described in greater detail in conjunction with the figures that that follow, including many optional functions and features and examples thereof.

FIG. 1B presents a block diagram representation of an NFT collection platform 800 in accordance with various examples. In particular, the NFT collection platform 800 includes a network interface 820 such as a 3G, 4G, 5G or other cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating via the network 115.

The NFT collection platform 800 also includes a processing module 830 and memory module 840 that stores an operating system (O/S) 844 such as an Apple, Unix, Linux or Microsoft operating system or other operating system, client device interface 802, NFT marketplace tools 804, NFT wallet tools 806, NFT generation tools 808, NFT collection display tools 810, games 812 and database 814. In particular, the O/S 844, the client device interface 802, NFT marketplace tools 804, NFT wallet tools 806, NFT generation tools 808, NFT collection display tools 810, and games 812 each include operational instructions that, when executed by the processing module 830, cooperate to configure the processing module 830 into a special purpose device to perform the particular functions of the NFT collection platform 800 described herein.

The NFT collection platform 800 may include a user interface (I/F) 862 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to an administrator of the NFT collection platform 800 and that generate data in response to the administrator's interaction with NFT collection platform 800.

The processing module 830 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 840. The memory module 840 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 860, other architectures are possible including additional data buses and/or direct connectivity between one or more elements. Further, the NFT collection platform 800 can include one or more additional elements that are not specifically shown.

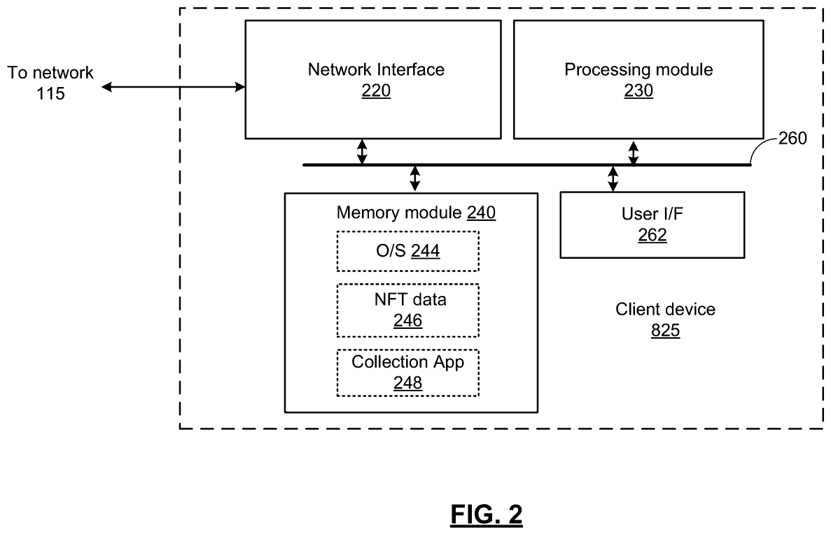

FIG. 2 presents a block diagram representation of an example client device in accordance with various examples. In particular, a client device 825 is presented that includes a network interface 220 such as a 3G, 4G, 5G or other cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating via network 115.

The client device 825 also includes a processing module 230 and memory module 240 that stores an operating system (O/S) 244 such as an Apple, Unix, Linux or Microsoft operating system or other operating system, NFT data 246 associated with one or more NFTs owned by the user, and/or a collection applications 248. In particular, the O/S 244 and collection application 248 each include operational instructions that, when executed by the processing module 230, cooperate to configure the processing module into a special purpose device to perform the particular functions of the client device 825 described herein.

The client device 825 also includes a user interface (I/F) 262 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to a user of the client device 825 and that generate data in response to the user's interaction with the client device 825.

The processing module 230 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 240. The memory module 240 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 260, other architectures are possible including additional data buses and/or direct connectivity between one or more elements. Further, the client device 825 can include one or more additional elements that are not specifically shown.

The client device 825 operates, via network interface 220, network 115 and NFT collection platform 800. In various examples, the client device 825 operates to display a graphical user interface generated based on display data from the NFT collection platform 800, including corresponding screen displays. Furthermore, the graphical user interface can operate in response to interactions by a user to generate input data that is sent to the NFT collection platform 800 to control the operation of the NFT collection platform 800 and/or to provide other input.

It should be noted that while the client devices 825 and NFT collection platform 800 are shown as separate devices that communicate via the network 115, it should be noted that any and all of the functionality attributed to the NFT collection platform 800, including the NFT marketplace tools 804, NFT wallet tools 806, NFT generation tools 808, NFT collection display tools 810, games 812, and database 814, etc. can likewise be incorporate directly into the client device 825. In this fashion, a client device 825 through the application of its operating system 244 and one or more applications can provide a graphical user interface to operate via network 115 but independently from any NFT collection platform to perform any of the functions and features described herein. In particular, the client device 825 can perform the functions of both the client device and the NFT collection platform 800 without requiring communications to be sent to the client device 825 from a NFT collection platform and communications sent to a NFT collection platform from the client device 825.

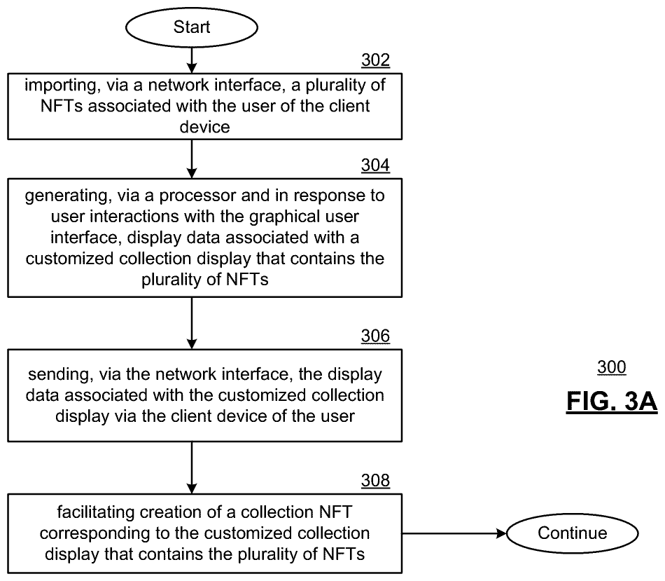

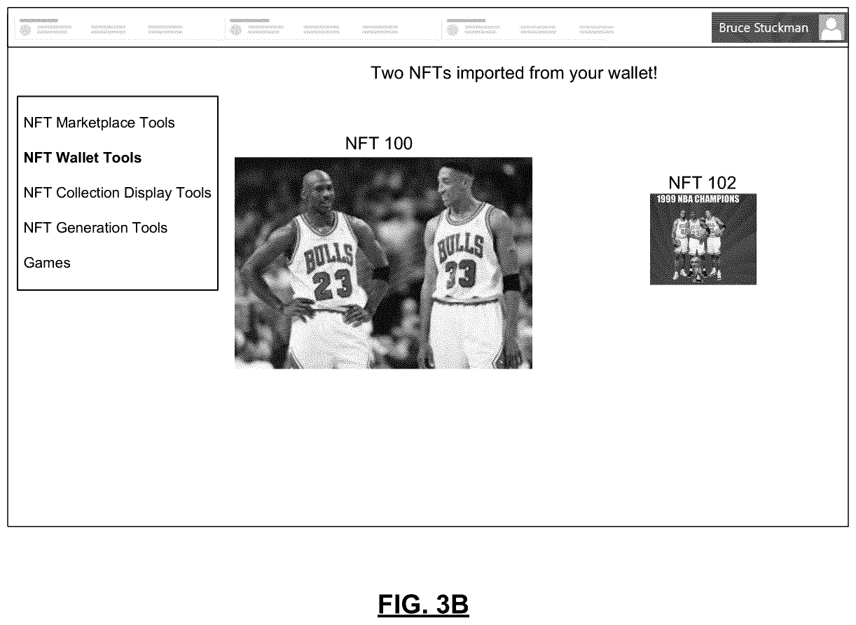

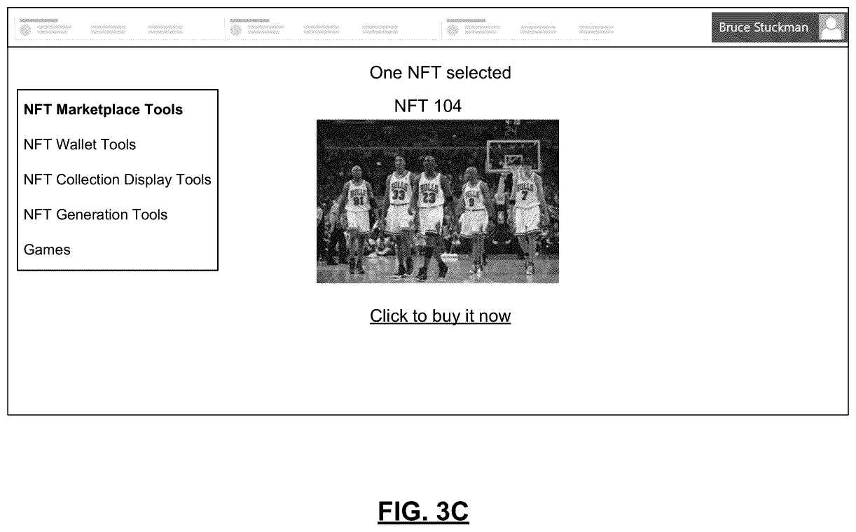

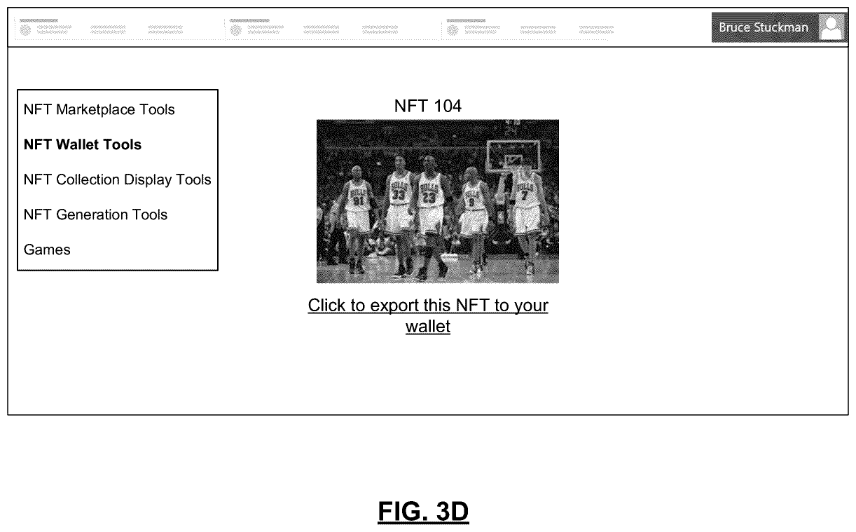

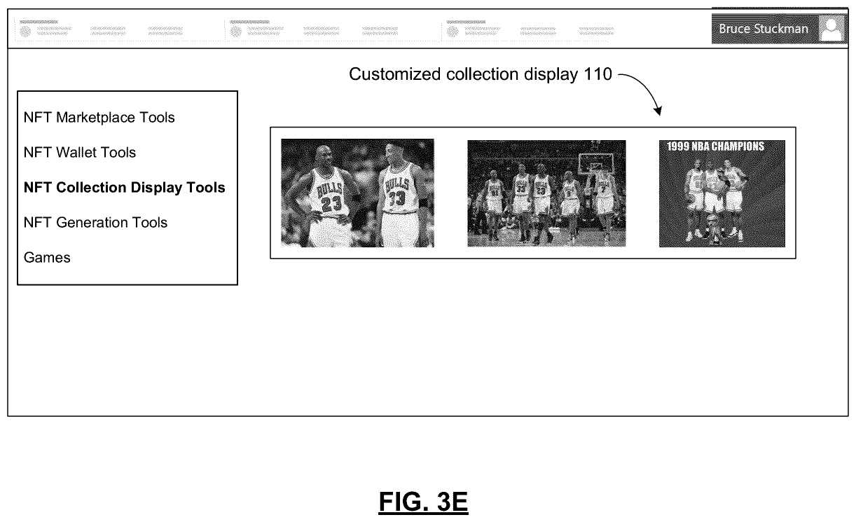

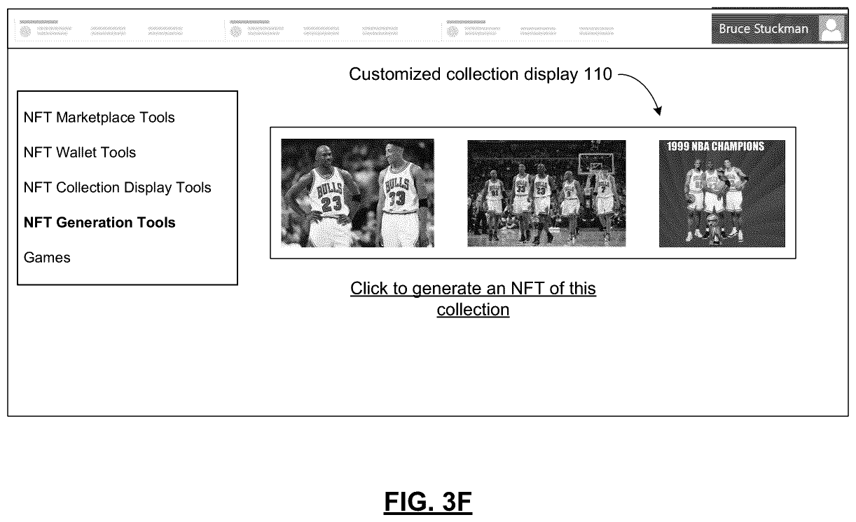

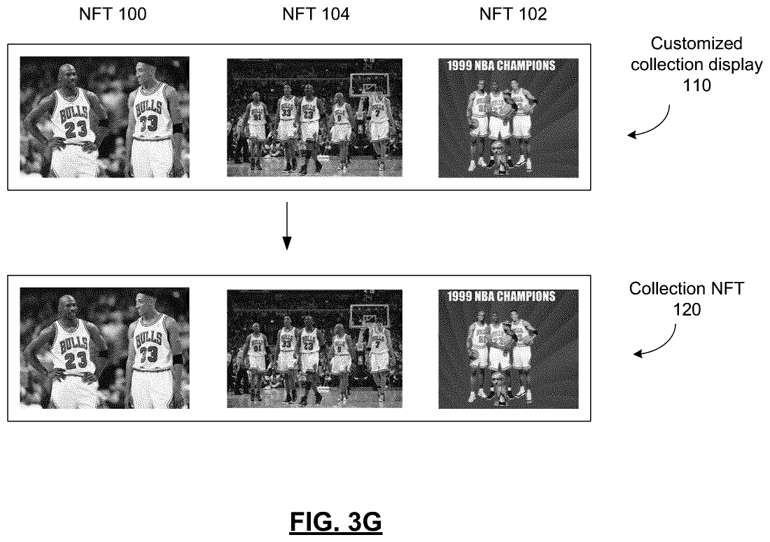

FIG. 3A presents a flowchart representation of an example method in accordance with various examples. In particular, a method 300 for use in conjunction with any of the functions and features described herein for generating a collection NFT based on NFTs in a user's collection.

Step 302 includes importing, via a network interface, a plurality of NFTs associated with the user of the client device. Step 304 includes generating, via a processor and in response to user interactions with the graphical user interface, display data associated with a customized collection display that contains the plurality of NFTs. Step 306 includes sending, via the network interface, the display data associated with the customized collection display via the client device of the user. Step 308 includes facilitating creation of a collection NFT corresponding to the customized collection display that contains the plurality of NFTs.

FIGS. 3B-3F and 3H present pictorial representations of example screen displays. In particular, screen displays of a graphical user interface generated based on display data from the NFT collection platform 800 are shown. In the example below, three NFTs are used to design and create a new collection NFT based on a common theme, the 1999 Chicago Bulls team in the National Basketball association.

In FIG. 3B, the user “Bruce Stuckman” is logged into the NFT collection platform 800. The user has interacted with NFT wallet tools, such as NFT wallet tools 804, to import NFTs 100 and 102 from his wallet residing in NFT wallet system 820. In this example, the NFTs 100 and 102 are blockchain authenticated original photographs depicting two different images of the 1999 Chicago Bulls.

In FIG. 3C, the user has interacted with the NFT marketplace tools, such as NFT marketplace tools 804, to select a new NFT 104 for purchase via an NFT marketplace such as NFT marketplace 822. In FIG. 3D, the wallet tools are used again, this time to export the NFT 104 to the user's wallet. In FIG. 3E, the user has selected and used NFT collection display tools, such as NFT collection display tools 810, to create a customized collection display 110 contain all three 1999 Chicago Bulls-related NFTs he now owns. In the example shown, the user has “dragged and dropped” NFTs he owns in a custom display window and has sized and arranged them into the particular collage that is shown. In other examples, the NFT collection display tools 810 can operate, based on metadata associated with the NFTs of a user indicating content, theme, color themes, subject matter, dates of creation, authorship, ownership, prior ownership, number of prior owners, size, resolution, and other NFT information and metadata, to automatically generate arrangements of custom collection display 110 that may be accepted by the user and/or that may be further arranged by the user to create the final customized collection display 110.

In FIG. 3F, the user has selected NFT generation tools, such as NFT generation tools 808, in order to facilitate, via NFT creation system 824 for example, the creation of a collection NFT from the customized collection display 110.

FIG. 3G presents a flow diagram representation of an example process. In the example shown, the collection NFT 120 is created from the customized collection display 110. As previously discussed, the NFT generation tools can operate by, for example, first authenticating the user's rights in the three NFTs and then creating, via NFT creation system 824, a new NFT of the unique customized image with its own blockchain authentication. In various examples, the collection NFT 120 can contain metadata indicating, for example attributions to the sources of the original NFTs in the collection, the creator of the collection NFT, a date of creation, promotion data and coupons related to offers, privileges and/or discounts, title data with respect to title to tangible or intangible real or personal property, warrant data with respect to tangible or intangible real or personal property, transaction data regarding one or more transactions, and/or other metadata. This metadata can be protected via the blockchain and/or other crypto-based NFT creation technology that is employed to create and protect the collection NFT itself—with or without associated image data. In FIG. 3H, the wallet tools are used again, this time to export the collection NFT 120 to the user's wallet.

FIG. 3I presents a flowchart representation of an example method in accordance with various examples. In particular, a method 310 is presented for use in conjunction with any of the functions and features described herein for generating a collection NFT based on NFTs in a user's collection.

Step 312 includes importing, via a network interface, a plurality of NFTs associated with the user of the client device. Step 314 includes generating, via a processor and in response to metadata associated with the plurality of NFTs, display data associated with a customized collection display that contains the plurality of NFTs. Step 316 includes sending, via the network interface, the display data associated with the customized collection display via the client device of the user. Step 318 includes facilitating creation of a collection NFT corresponding to the customized collection display that contains the plurality of NFTs.

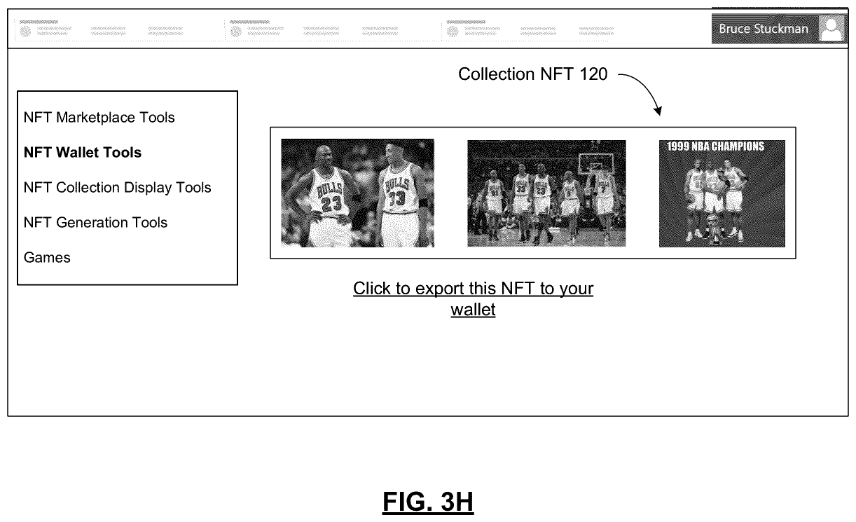

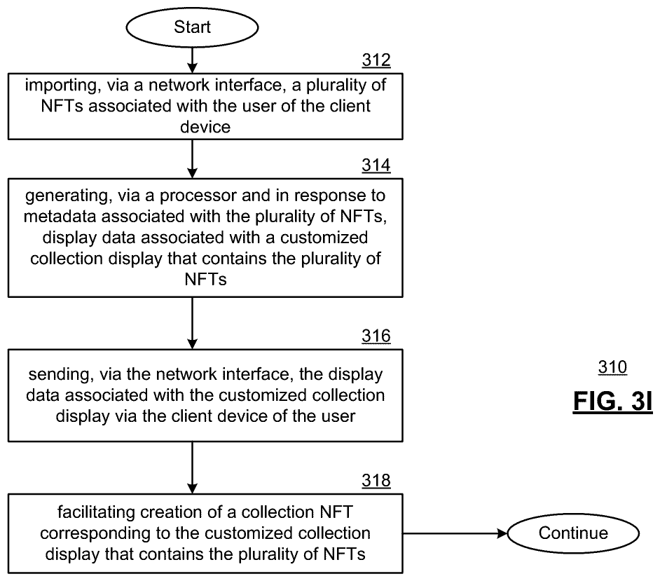

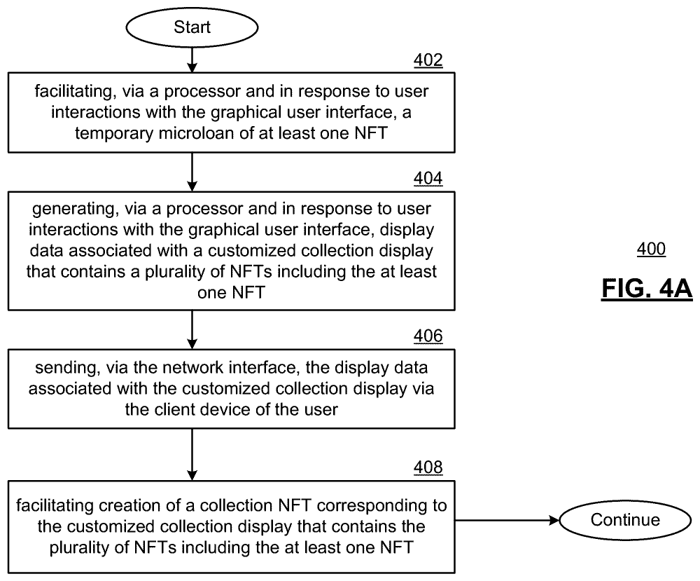

FIG. 4A presents a flowchart representation of an example method. In particular, a method 400 for use in conjunction with any of the functions and features described herein in generating a collection NFT based on at least one NFT accessed via a temporary micro-loan.

Step 402 includes facilitating, via a processor and in response to user interactions with the graphical user interface, a temporary micro-loan of at least one NFT. Step 404 includes generating, via the processor and in response to user interactions with the graphical user interface, display data associated with a customized collection display that contains a plurality of NFTs including the at least one NFT. Step 406 includes sending, via the network interface, the display data associated with the customized collection display via the client device of the user. Step 408 includes facilitating creation of a collection NFT corresponding to the customized collection display that contains the plurality of NFTs including the at least one NFT.

FIG. 4B presents a pictorial representation of an example screen display. In particular, the user has used the marketplace tools to select NFTs 100-1, 102-1, and 104-1. Instead of putting these NFTs up for purchase, the original owners have made them available for temporary micro-loan. This process allows the users can engage to, in exchange for a fee, “borrow” NFTs in order to create a collection NFT. After the Collection NFT is created, or upon the expiration of some predetermined time period (such as 15 minutes, 30 minutes, an hour, a day, etc.) the micro-loaned NFT(s) are returned, expire, deleted or destroyed. Transaction fees apply, a portion of which can be credited to the original NFT owner, the author, including an upfront cost, reward-based payment based on the use and/or performance of the micro-loaned NFT etc. In the alternative, a fixed fee could be charged to the user and credited to the original NFT owner. In various examples, the NFT collection platform 800 may be configured to operate with a single user and/or within a single wallet, and/or to otherwise prohibit the sale or borrowing of micro-loaned NFTs to avoid dilution of the value of the original itself. Furthermore, original and/or derivative NFTs can include restrictions on the total number of micro-loan transactions, the number of simultaneous/contemporaneous micro-loans, restrictions on types of microloan transactions such as normal use loans, staking loans, death match loans, loans less than a predetermined length of time, loans greater than a predetermined length of time, etc.

Consider the following example where an NFT is put up for loan. The proposed loan transaction can include restrictions including an expiration time and/or date, one or N time use in creating a collection NFT or in a game, tournament or challenge, etc. Once the loan is accepted by the borrower, an additional NFT, such as a derivative NFT of the original NFT being loaned, is created on a side chain, layer 1 or 2 blockchain (or “parachain”) that can be different from (and/or independent from) the blockchain used to create the original NFT. This new NFT can be created and transferred to the wallet of the borrower via a smart contract that is based on the restrictions. A cryptocurrency market can be used to fund the transaction and/or to collateralize the micro-loan. The new NFT can then be set via the smart contract to automatically expire (e.g. be deleted from the wallet, destroyed or otherwise disabled), when the restrictions are met. In this fashion, if the purpose of the micro-loan is the creation of a collection NFT, the borrowed NFT can automatically expire once the collection NFT is created. It should be noted that the collection NFT can be created via the same blockchain platform (e.g. Ethereum) used to create the original NFT (e.g. not the parachain).

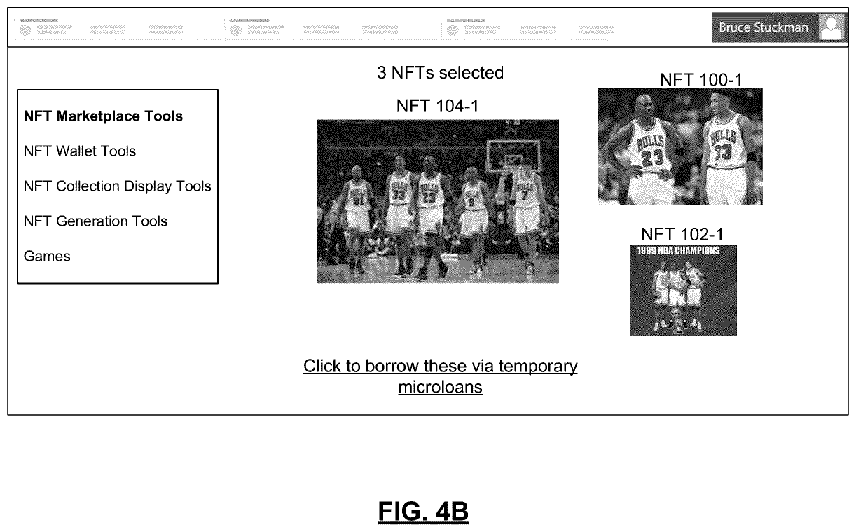

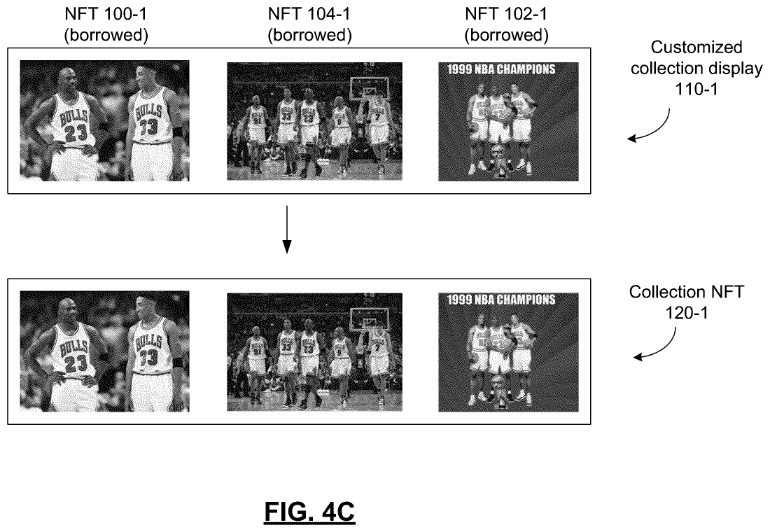

FIG. 4C presents a flow diagram representation of an example process where a collection NFT 120-1 is generated based on a customized collection display 110-1 created by the user based on the borrowed NFTs 100-1, 102-1 and 104-1. In various examples, the collection NFT 120-1 metadata can also indicate the original sources of the micro-loans as well as the micro-loaned status of NFTs 100-1, 102-1 and 104-1. While not expressly shown, the collection NFTs based on one or more micro-loaned NFTs, can be created with a visual indication of the original vs. micro-loaned status of the NFTs as appropriate. FIG. 5A presents a flowchart representation of an example method. In particular, a method 1300 for use in conjunction with any of the functions and features previously described facilitates the collection of endorsements associated with an NFT. Step 1302 includes importing, via a network interface, an NFT associated with the user of the client device. Step 1304 includes collecting, via a processor and in response to user interactions with the graphical user interface, endorsement data associated with the NFT. Step 1306 includes generating, via the processor and in response to user interactions with the graphical user interface, display data associated with a customized collection display that contains the NFT and the endorsement data. Step 1308 includes sending, via the network interface, the display data associated with the customized collection display via the client device of the user. Step 1310 includes facilitating creation of a collection NFT corresponding to the customized collection display.

FIGS. 5B and 5C present pictorial representations of example screen displays. In FIG. 5B, the user is interacting with the graphical user interface to use the NFT marketplace tools to seek an endorsement for a selected NFT. After an endorsement in the form of a signature has been received it can be appended to the customized collection display of the NFT. In FIG. 5C, the user interacts with the NFT generation tools to generate a collection NFT that includes both the NFT and the signature. In various examples, this collection NFT 120-6 metadata can also indicate an attribution associated the endorsement itself. Furthermore, the endorsement itself can be an original NFT, a derivative NFT, a micro-loaned NFT or other NFT.

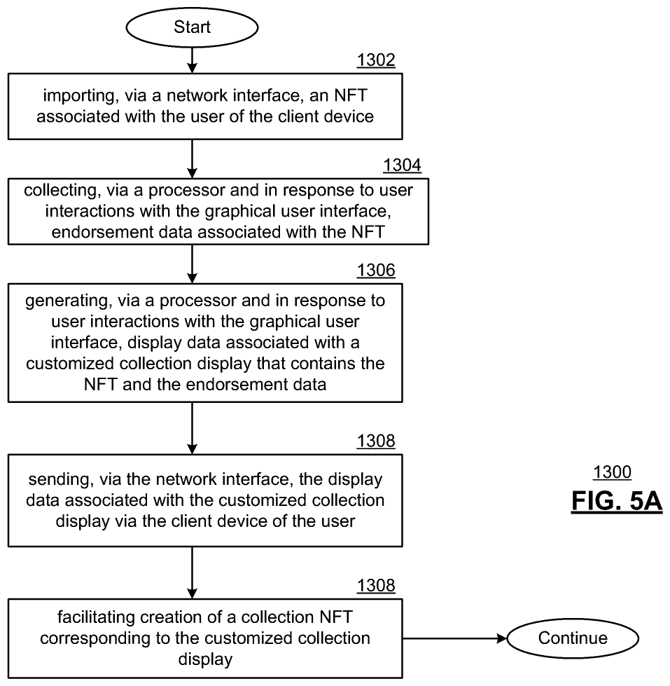

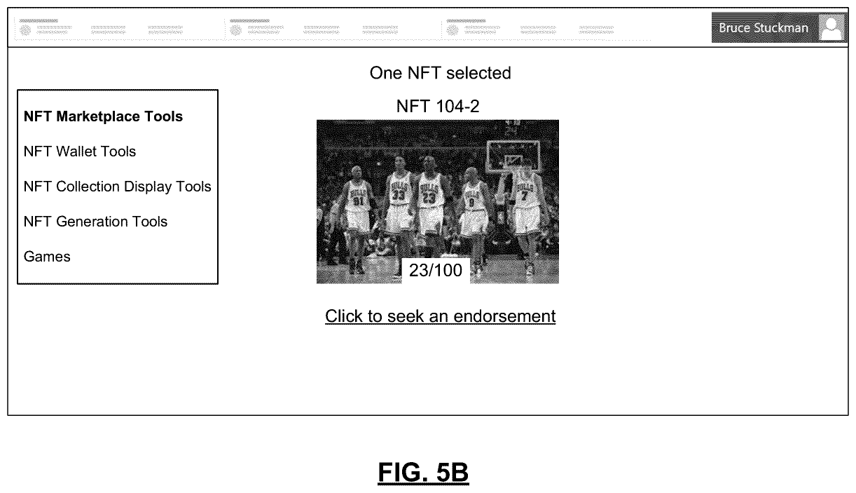

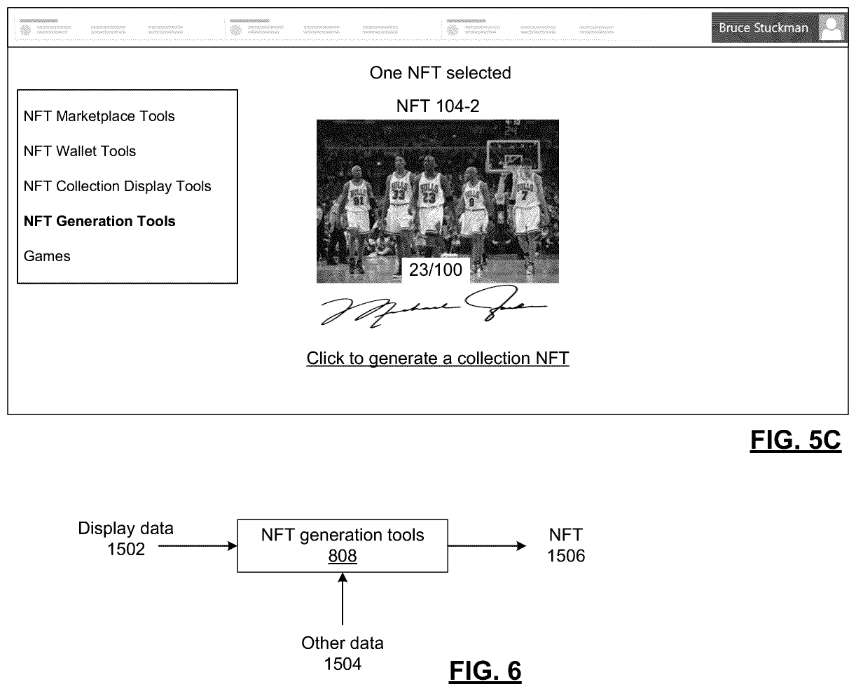

FIG. 6 presents a block diagram/flow representation of an example of NFT generation. In the example shown, NFT generation tools 808 operate to convert display data 1502 and other data 1504 into an NFT 1506. The display data 1502 can correspond to an original NFT, borrowed (e.g. temporary micro-loaned) NFT, a derivative NFT, a customized collection display 110, an original image, and/or other derivatives or micro-loans thereof or other display or image data. In various examples, the NFT generation tools 808 can operate to verify the credentials of any NFTs whose images are contained in the display data 1502, prior to creating the NFT 1506. In this fashion, derivative NFTs can only be created when the source NFT or NFTs are verified—preventing the creation of unauthorized or counterfeit NFTs.

The other data 1504, can be image data including signatures and other endorsement images, visual indications of derivative series, originality classification, attributions, or other image data, metadata of all kinds including metadata indicating one or more originality classifications, attributions, endorsement data, other derivative data indicating the series number and total number in a derivative series, restrictions on micro-loans or other derivatives, restrictions on derivatives with artistic effects, restrictions that derivatives must include attributions to the original source, restrictions on numbers of derivatives or micro-loans or the sizes of derivative series, restrictions on the creation of collection NFTs, the number of collection NFTs, the creation of collection NFTs including NFTs from other sources, from prohibited sources or with prohibited content, geographical restrictions, time restrictions (e.g., can be used to create derivatives or collection NFTs or can be temporarily micro-loaned for 1 month, one year, etc., other restrictions and/or other data associated with, or to be associated with, the display data 1502.

This other data 1504 can be used to generate an NFT and/or combined with the display data 1502 to create a dataset that includes both the display data 1502 and the other data 1504. This other data 1504 or combined dataset can be protected via the blockchain and/or other crypto-based NFT creation technology that is employed by the NFT generation tools 808 and via the NFT creation system 824 to create and protect the new NFT 1506 itself. It should be noted that the NFT 1506 can include a single derivative or a number of derivatives, including a limited series of derivatives. It should be noted further that some or all of the other data 1504, including restriction data and/or attribution data, can be derived from one or more original NFTs whose images are associated with the display data 1502. Furthermore, some or all of the other data 1504 can be generated in response to user interactions with a graphical user interface generated in conjunction with the NFT collection platform 800.

FIG. 7 presents a block diagram representation of an example system. In particular, a system 2850 is presented that includes an NFT distribution platform 2800 that communicates with client devices 825 via a network 115. The network 115 can be the Internet or other wide area or local area network, either public or private. The client devices 825 can be computing devices associated with users, for example, buyers, sellers, collectors, game players and/or other users of NFTs.

In the example shown, the NFT distribution platform 2800 includes a client device interface 2802 for interacting with the client devices 825, NFTs 2804 to be distributed, and an operating system 2844. One or more of the NFTs 2804 can have geographical restrictions as to distribution that are either part of the NFTs themselves or have restriction data that is stored separately.

The NFT distribution platform 2800 includes a network interface 2820 such as a 3G, 4G, 5G or another cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating via the network 115.

The NFT distribution platform 2800 also includes a processing module 2830 and memory module 2840 that stores an operating system (O/S) 2844 such as an Apple, Unix, Linux or Microsoft operating system or another operating system, the client device interface 2802, and the NFTs 2804. The O/S 2844 and the client device interface 802 each include operational instructions that, when executed by the processing module 830, cooperate to configure the processing module 830 into a special purpose device to perform the particular functions of the NFT distribution platform 2800 described herein.

The NFT distribution platform 2800 may include a user interface (I/F) 2862 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to an administrator of the NFT distribution platform 2800 and that generate data in response to the administrator's interaction with NFT distribution platform 2800.

The processing module 2830 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 2840. The memory module 2840 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 2860, other architectures are possible including additional data buses and/or direct connectivity between one or more elements. Further, the NFT distribution platform 2800 can include one or more additional elements that are not specifically shown.

For example, the client device interface 2802 can operate in conjunction with each client device 825 and via network 115 to generate a graphical user interface. This graphical user interface is based on display data generated by the NFT distribution platform 2800 in a format for display on a display device associated with the client devices 825. This graphical user interface generates input data that is received by the NFT distribution platform 2800 from the client devices 825 in response to user interaction with the graphical user interface.

In various examples, the NFT distribution platform 2800 can operate to respond to input data from client devices in the form of read requests for NFTs and geolocation data such as GPS coordinates, connection to or proximity with a network element of network 115 or other location data indicating a location of the client device 825. The NFT distribution platform 2800 sends the requested NFT(s) to the requesting client device—only when the geolocation data conforms with restriction data—for example, when the geolocation data indicates a position of the requesting client device within a limited area or proximity indicated by the restriction data.

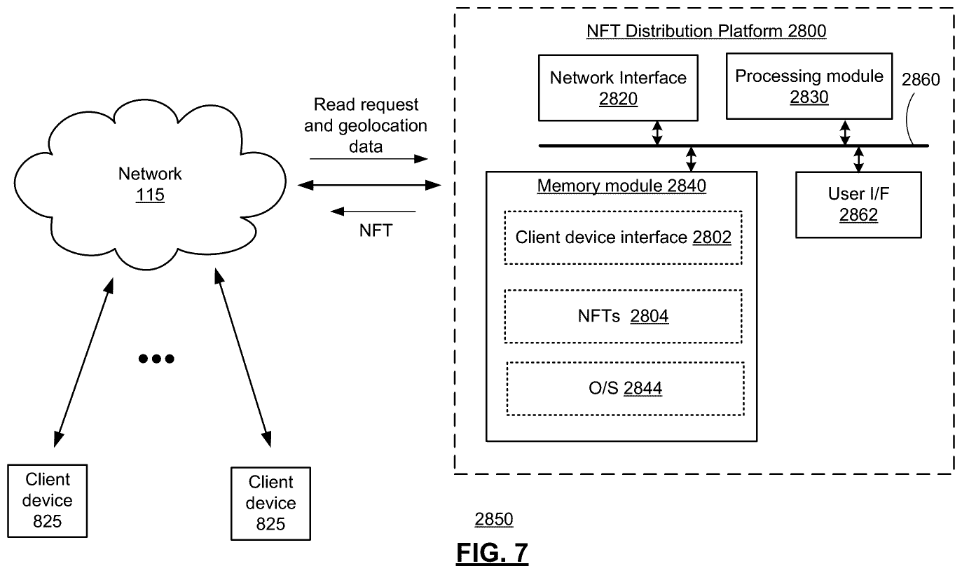

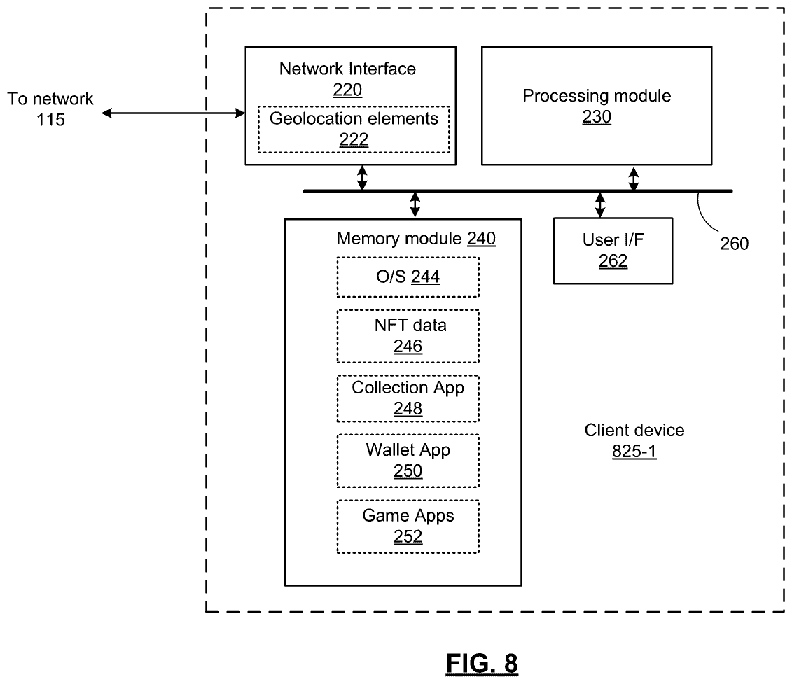

FIG. 8 presents a block diagram representation of an example client device. In particular, a client device 825-1 is presented that functions similarly to client device 825, and includes several elements of client device 825 that are referred to by common reference numerals. The client device 825-1 is capable of operating to client device 825 described herein.

In addition, the memory module 240 includes a wallet application (app) 250 that is capable of engaging in financial transactions including credit card transactions and traditional digital payments, is capable of holding crypto-currency and engaging in crypto-currency transactions and is further capable of storing one or more NFTs that are either original NFTs, derivative NFTs, borrowed (temporarily micro-loaned) NFTs, collection NFTs and/or combinations thereof. In various examples, the wallet app 250 is capable of operating in conjunction with the NFT collection platform 800, the NFT distribution platform 2800, the NFT wallet system 820, the NFT marketplace 822, and/or the NFT creation system 824 via network 115.

As will be understood by one skilled in the art, unlike a normal wallet, which can physically hold cash, credit cards, etc., NFT wallets “store” NFTs by storing the NFT data necessary to access the NFT. So, even though a wallet can be said to store an NFT, technically the NFT content is stored on the blockchain, which can only be accessed via the NFT data in the wallet. This NFT data includes metadata, other off-chain data corresponding to the NFT and in particular, a private key. This private key can be considered an indicator of ownership of the NFT and is required to access the NFT via the blockchain. If the NFT data (including the private key) is lost, the NFT can no longer be accessed—and the NFT is itself “lost” for all intents and purposes, even though it remains immutably stored on the blockchain.

Also, the memory module 240 includes one or more game apps 252 that represent either stand alone games of the client device 825-1 or that operate in conjunction with the games 812 of the NFT collection platform 800 and/or interface with the NFT distribution platform 2800. This allows, for example, a user of client device 825-1 to engage in (e.g. play) games associated with NFT content, and engage in other activities that involve the acquisition, collection, display, distribution, and/or use of one or more NFTs that are either original NFTs, derivative NFTs, borrowed (temporarily micro-loaned) NFTs, collection NFTs and/or combinations thereof.

Furthermore, the network interface 220 includes one more geolocations elements 222 such as a GPS receiver, a ultra-wideband (UWB) transceiver, a Bluetooth transceiver and/or other component(s) that that facilitate the generation of geolocation data and/or facilitate other location-based services. Consider the case where the client device 825 is a smartphone or tablet and the wallet app 250 is an Apple or Android wallet or mobile wallet card that is in an Apple or Android wallet. Once the wallet app 250 is activated, NFTs can be easily added to the wallet. In addition, the wallet app 250 can access the location services of the device, and for example, generate push notifications regarding NFTs that are available near the current location.

In various examples, the geolocation data generating in such a fashion can facilitate the generation of geolocation data discussed in conjunction with the operation of NFT distribution platform 2800. In particular, the NFT distribution platform 2800 can automatically detect the presence of the user at a venue based on geolocation data received from the user's client device 825-1 and automatically prompted the user to click to send a read request. In this fashion, the user can be geo-authorized, before the request. In other examples, the NFT distribution platform 2800 can distribute NFTs to client devices 825 based on payments, authentication and/or other criteria that does not rely on geolocation data.

Furthermore, while the client device 825-1 and NFT collection platform 800 (or NFT distribution platform) are shown as separate devices that communicate via the network 115, it should be noted that any and all of the functionality attributed to the NFT collection platform 800 (or NFT distribution platform), including the NFT marketplace tools 804, NFT wallet tools 806, NFT generation tools 808, NFT collection display tools 810, games 812, and database 814, etc. can likewise be incorporate directly into the client device 825. In this fashion, a client device 825 through the application of its operating system 244 and one or more applications can provide a graphical user interface to operate via network 115 but independently from any NFT collection platform to perform any of the functions and features described herein. In particular, the client device 825 can perform the functions of both the client device and the NFT collection platform 800 without requiring communications to be sent to the client device 825 from a NFT collection platform (or NFT distribution platform) and communications sent to a NFT collection platform (or NFT distribution platform) from the client device 825.

In addition, NFT generation tools 808 can be used to protect, encrypt and/or authenticate any digital information that could be stored in the wallet app 250, including for example rewards cards, coupons, movie tickets, event tickets, boarding passes, public transit cards, student ID cards, credit cards, debit cards, prepaid cards, and loyalty cards. In addition, the functionality of the wallet app 250 can be further expanded to protect other information such as vehicle titles, warranty cards, driver's licenses and other IDs, vaccination records, prescriptions, and/or other medical records, social security cards, financial records, authentication tokens, insurance cards, passwords, user IDs and/or other images and information of a personal and/or sensitive nature. Any of these types of digital information can be protected via an NFT or other blockchain transaction in conjunction, with or without associated image or display data, and with or without metadata and/or “other data” as that term has been used herein in association with the NFT generation tools 808.

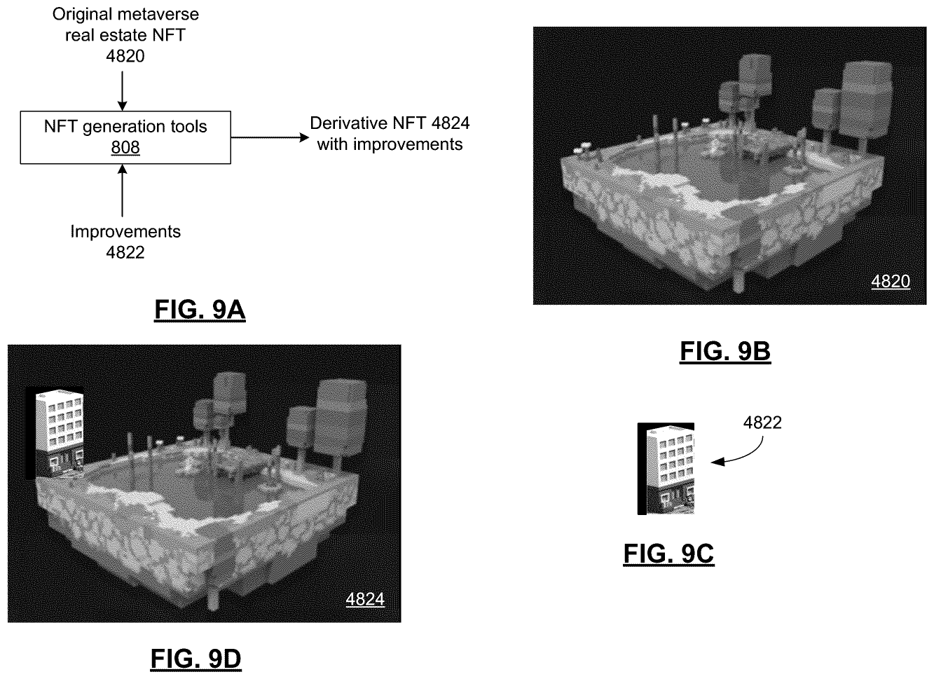

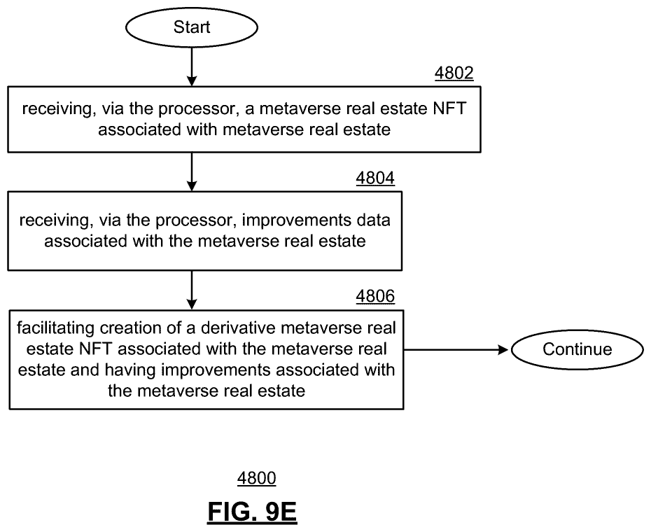

FIG. 9A presents a block diagram/flow representation of an example of NFT generation. In the example shown, an original metaverse real estate NFT 4820 corresponds to a portion/plot of real estate that is used in a game or metaverse application. An example is shown in FIG. 9B. The original metaverse real estate NFT 4820 can be purchased by the user, created or leveled-up via game play or otherwise acquired by the user of a metaverse application or game.

The NFT generation tools 808 are used to generate a derivative NFT 4824 or other metaverse real estate NFT that is based on the improvements 4822 shown in FIG. 9C. In the example shown the improvements 4822 correspond to a building or other structure, however, other real estate improvements can likewise be implemented. In various example, the derivative NFT 4824 with improvements shown in FIG. 9D can be created on a parachain or other sidechain that is different from the blockchain on which the original metaverse real estate NFT 4820 resides or the same blockchain on which the original metaverse real estate NFT 4820 resides.

FIG. 9E presents a flowchart representation of an example method. In particular, a method 4800 is presented for use in conjunction with any of the functions and features described herein. Step 4802 includes receiving, via the processor, a metaverse real estate NFT associated with metaverse real estate. Step 4804 includes receiving, via the processor, improvements data associated with the metaverse real estate. Step 4806 includes facilitating creation of a derivative NFT associated with the metaverse real estate and having improvements associated with metaverse real estate.

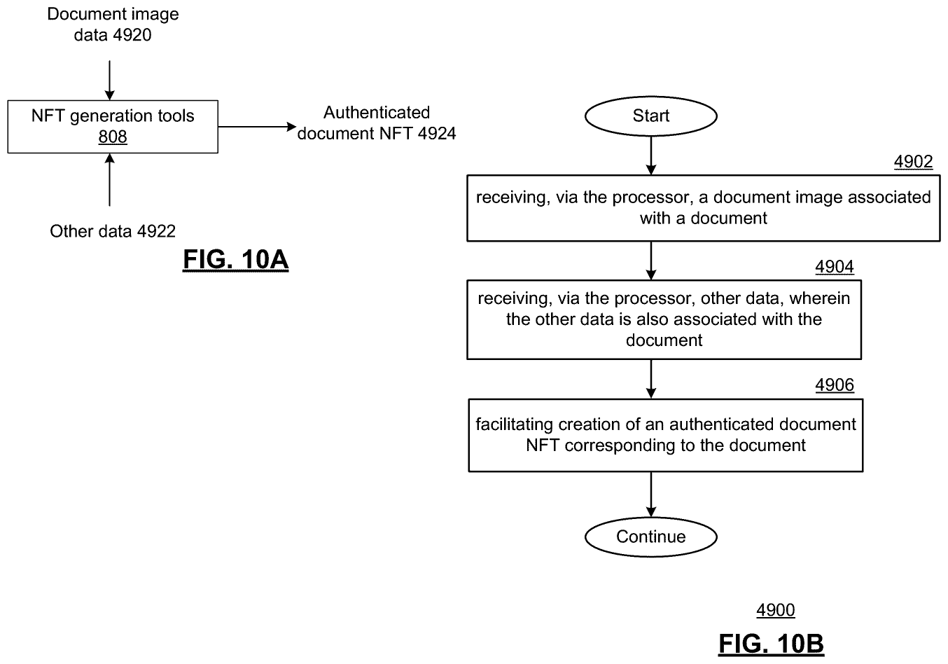

FIG. 10A presents a block diagram/flow representation of an example of NFT generation. In the example shown, document image data 4920 and other data corresponding to a document are used to generate an authenticated document NFT 4924 via the NFT generation tools 808. These authenticated document NFTs 4924 can be stored in an NFT wallet associated with the mobile phone or other client device associated with the user and can be used, for example, in place of coupons, cards, legal documents, medical documents, financial documents, IDs, credit cards, licenses and/or other important documents associated with a user that normally exist in non-digital, e.g. paper or plastic form. The authenticated document NFT 4924 can be used to prevent fraud and/or promote privacy in transactions via secure user and/or document authentication. In various examples, the authenticated document NFT 4924 can be presented and analyzed via secured blockchain or other crypto transactions at the time of a transaction in order to authenticate the identity of the user and/or to verify the accuracy and authentic nature of the other data 4922 and/or to facilitate the security of the transaction.

FIG. 10B presents a flowchart representation of an example method. In particular, a method 4900 is presented for use in conjunction with any of the functions and features described herein. Step 4902 includes receiving, via the processor, a document image associated with a document. Step 4904 includes receiving, via the processor, other data, wherein the other data is also associated with the document. Step 4906 includes facilitating creation of an authenticated document NFT corresponding to the document.

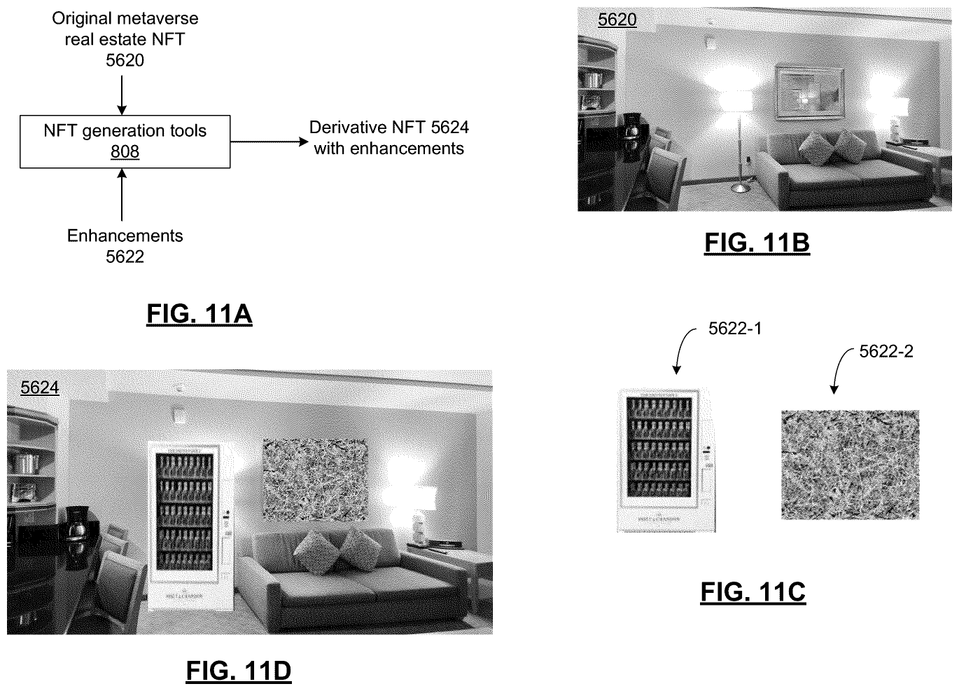

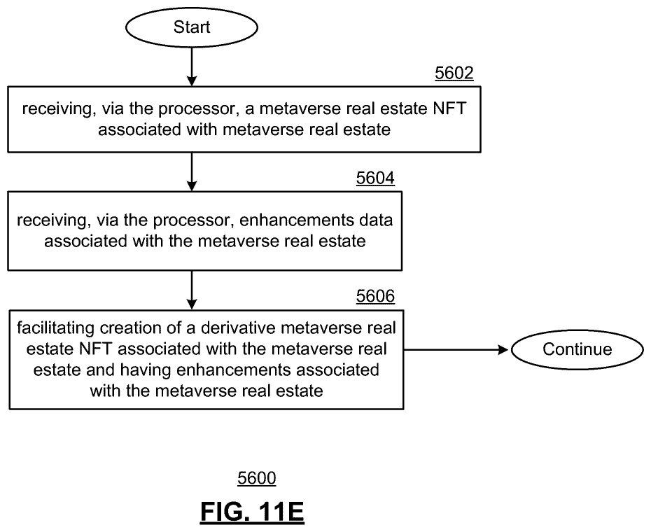

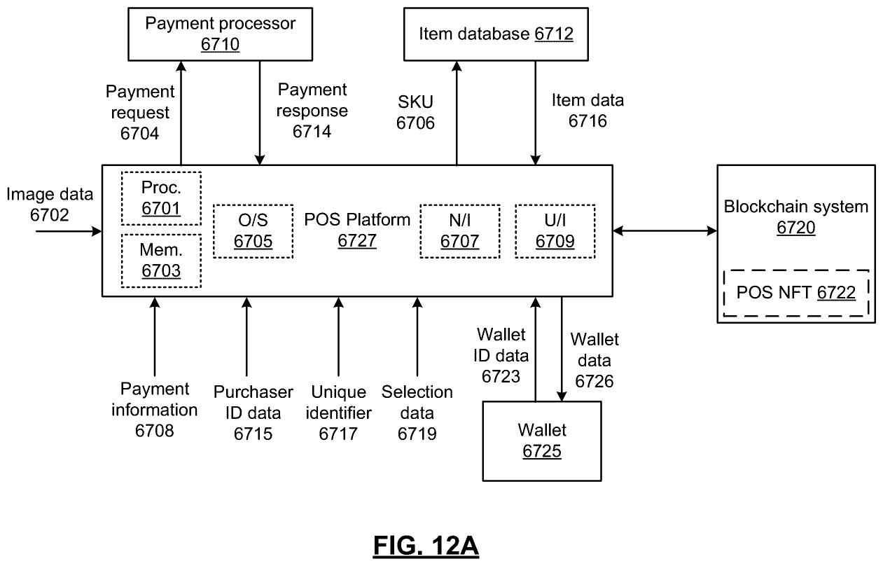

FIG. 11A presents a block diagram/flow representation of an example of NFT generation. The NFT generation tools 808 are used to generate a derivative NFT 5624 based on an original metaverse real estate NFT 5620 and based on the enhancement data 5622.

In the example shown in FIG. 11B, an original metaverse real estate NFT 5620 corresponds to real estate having an interior room that is used in a game or metaverse application. The original metaverse real estate NFT 5620 can be purchased by the user, created or leveled-up via game play or otherwise acquired by the user of a metaverse application or game.

The NFT generation tools 808 are used to generate a derivative NFT 5624 or other metaverse real estate NFT that is based on the enhancements data 5622 shown in FIG. 11C. In the example shown the enhancements 5622-1 and 5622-2 correspond to a Moet & Chandon vending machine and a Jackson Pollock painting that are acquired either as image data or as individual NFTs. While particular enhancements are shown, other real estate enhancements can likewise be implemented including statues and other art, rugs, lamps, furniture and other furnishings and accessories, outdoor objects, appliances, knick-knacks, machinery and other virtual objects for decorating or finishing an office, home, factory, venue or other real estate.

In the example shown in FIG. 11D, the user has placed the enhancements 5622-1 and 5622-2 as desired before creating the derivative NFT 5624. The derivative NFT 5624 with improvements shown can be created on a parachain or other sidechain that is different from the blockchain on which the original metaverse real estate NFT 5620 resides or the same blockchain on which the original metaverse real estate NFT 5620 resides.

FIG. 11E presents a flowchart representation of an example method. In particular, a method 5600 is presented for use in conjunction with any of the functions and features described herein. Step S602 includes receiving, via the processor, a metaverse real estate NFT associated with metaverse real estate. Step S604 includes receiving, via the processor, enhancement data associated with the metaverse real estate. Step S606 includes facilitating creation of a derivative NFT associated with the metaverse real estate and having enhancements associated with metaverse real estate.

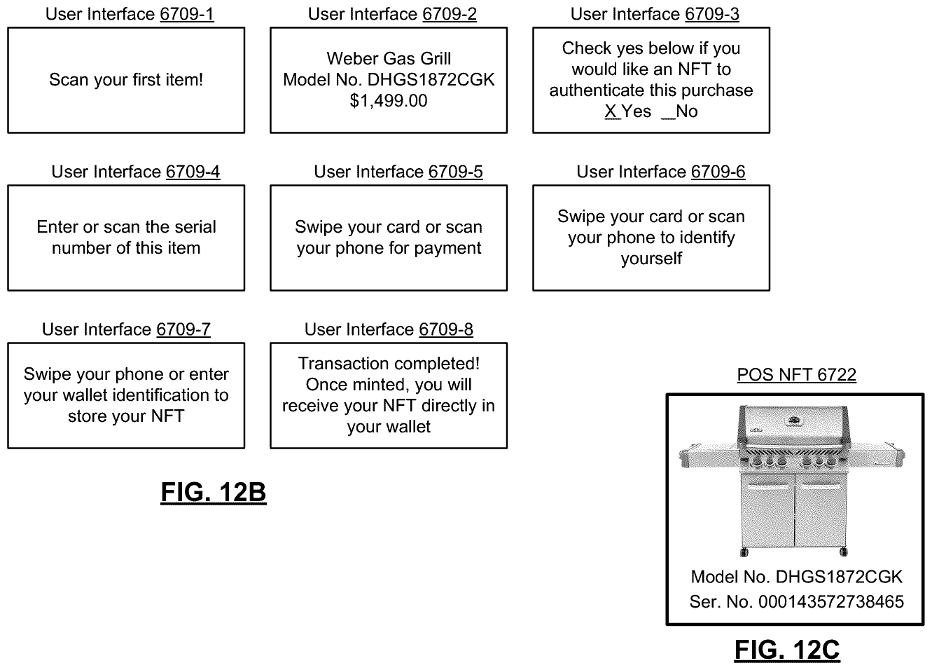

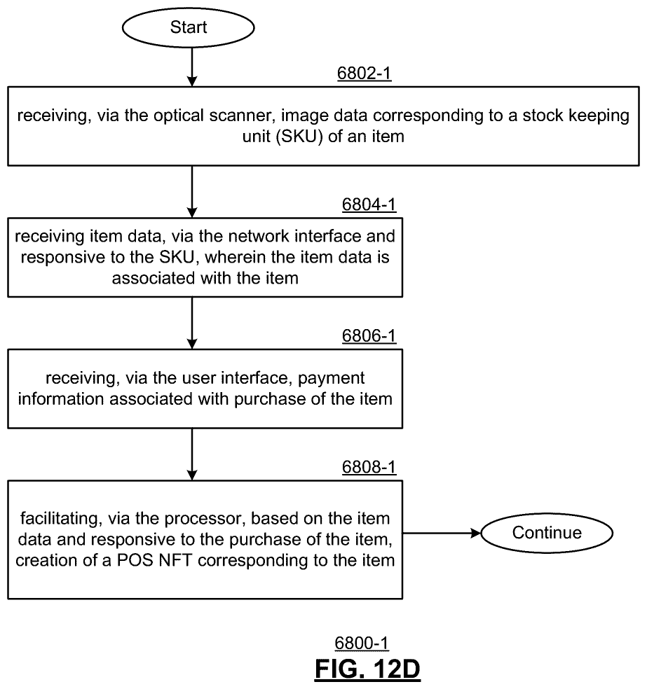

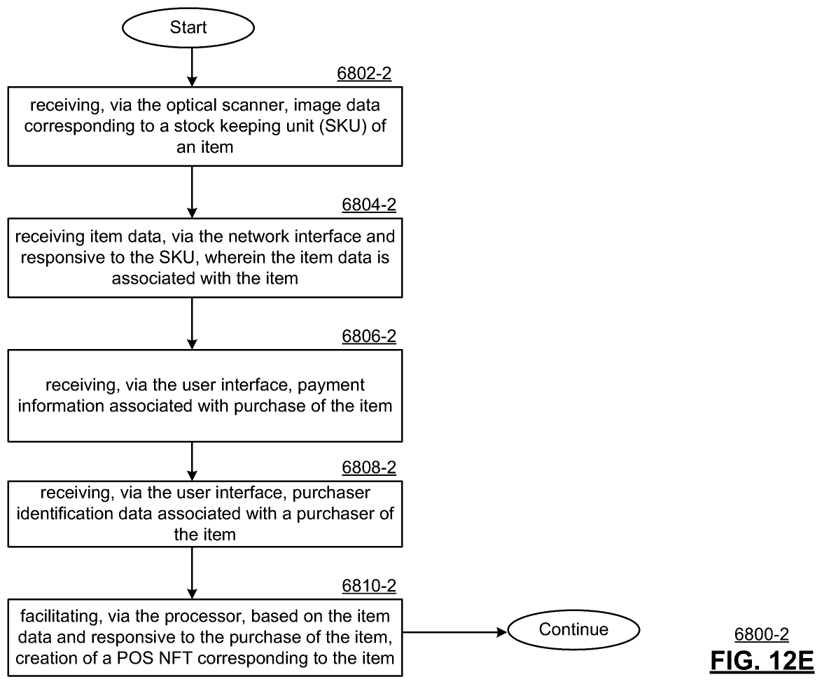

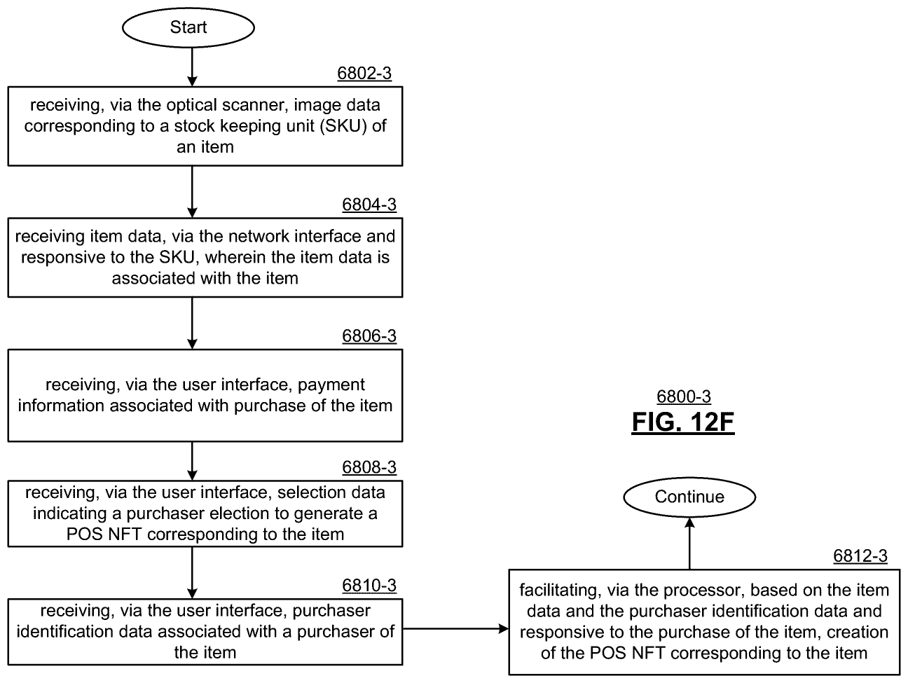

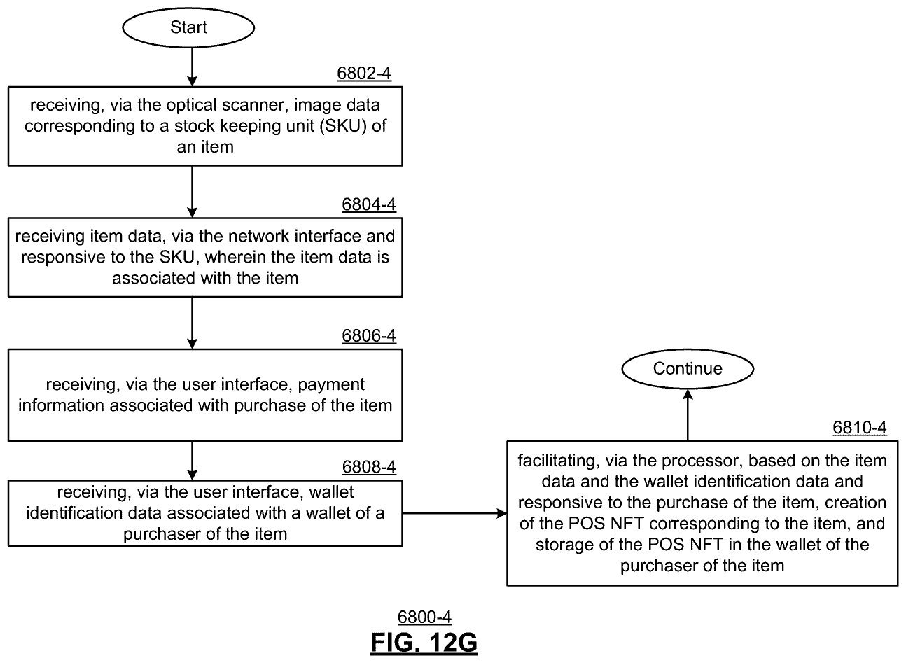

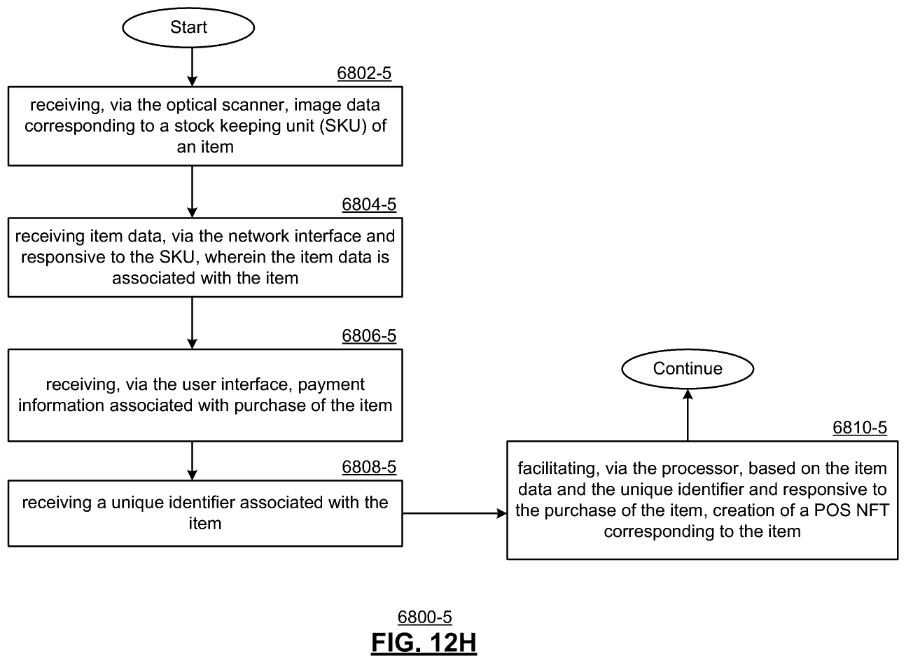

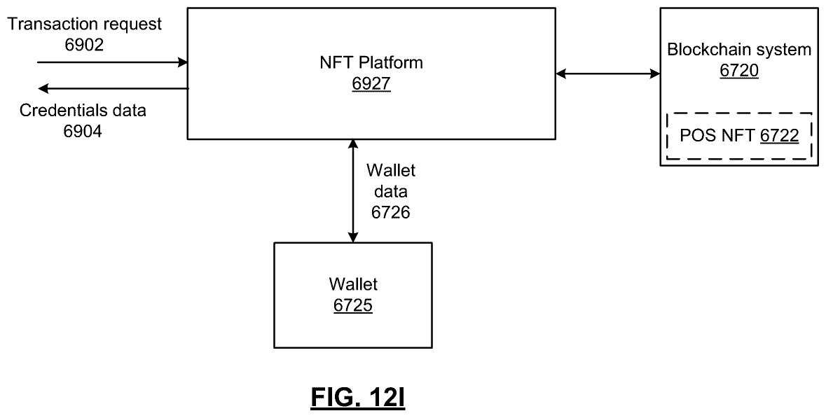

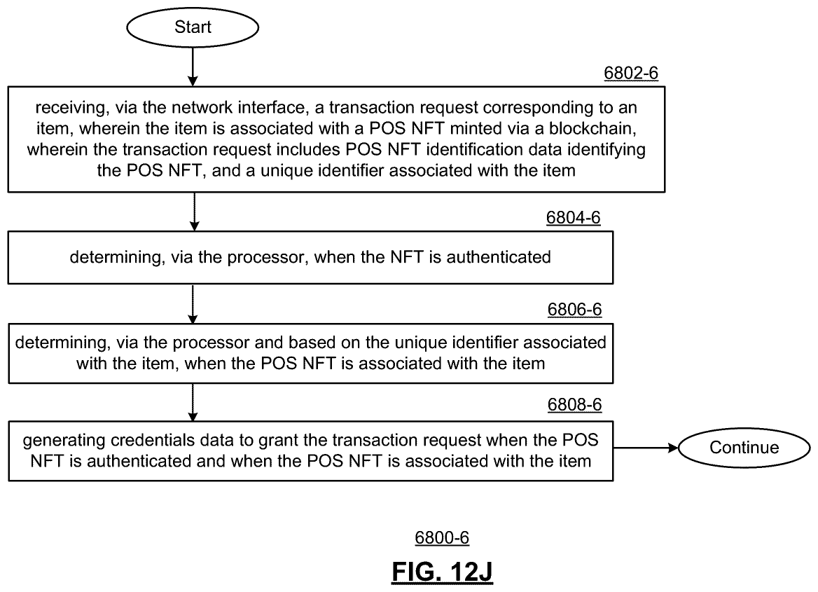

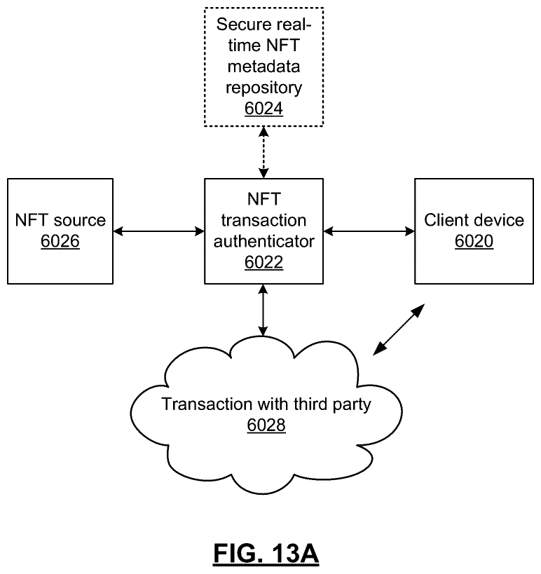

FIG. 12A presents a block diagram representation of an example system. The system includes a point of sale (POS) platform 6727 that can be implemented in conjunction with an NFT collection platform 800, NFT distribution platform 2800 or other NFT platform that operates to facilitate the creation of new NFTs such as POS NFTs or other NFTs associated with items purchased via the POS system. The POS platform 6727 includes a processor 6701, a memory 6703, an optical scanner (O/S) 6705, a network interface 6707 for communicating with other portions of the system via a network, and a user interface 6709 such as a display screen, touch screen, one or more buttons, a keyboard and/or keypad, an NFC interface or other wireless interface, a card scanner, a chip reader and/or one or more other interface devices for sending/receiving information to/from a user (e.g. a purchaser).

The system further includes an item database 6812 containing SKUs and item data associated with items that are for sale, a payment processor 6810 or other marketplace or marketplace tool, a blockchain system 6820, such as NFT creation system 824 or other decentralized computer system and a wallet 6825, such as NFT wallet system 820, a wallet application associated with client device 825 or other electronic wallet.

In an example of operation, the POS system 6727 receives, via the optical scanner 6705, image data corresponding to a stock keeping unit (SKU) 6706 of an item to be purchased. The SKU 6706 is sent to the item database 6712 via the network interface 6707. Item data 6716 is received, via the network interface 6707 and responsive to the SKU 6706. The item data 6716 is associated with the item to be purchased and can include one or more images or other media associated with the item, a model number, manufacturer, price, warranty information, vender information and/or other data associated with the item and further other data that can be used to generate a POS NFT 6722 corresponding to the sale of the item. The POS platform 6727 receives, via the user interface 6709, payment information 6708 associated with purchase of the item, such as credit card information, cryptocurrency data or other source of electronic funds which is sent to the payment processor 6710. If/when a payment response 6714 is received indicating successful payment and authorization for the item purchase, the processor 6701 facilitates generation (e.g., minting) of the POS NFT 6722 via the blockchain system 6720 and based on the item data 6716.

In further examples, the POS platform 6727 can further receive, via the user interface 6709, purchaser identification (ID) data 6715 associated with a purchaser of the item. This purchaser identification (ID) data 6715 can also be part of the NFT data and/or metadata used in the minting of the POS NFT 6722 and be further used, for example in authenticating the purchaser's ownership of the NFT and/or the purchased item.

In further examples, the POS platform 6727 can further receive, via the user interface 6709, selection data 6719 from the purchaser of the item that, for example, specifically indicates that the purchaser wishes to have a POS NFT minted in association with the sale. This selection data 6719 can be helpful in allowing purchasers to opt-in to POS NFT generation and to opt-out if they are not equipped to receive an NFT, or do not wish to pay an additional fee for an NFT (when additional payment is required).

In further examples, the POS platform 6727 can further receive, via the user interface 6709, wallet identification (ID) data 6723 associated with a purchaser of the item. This wallet identification (ID) data 6715 can also be part of the NFT data and/or metadata used in the minting of the POS NFT 6722 and be further used, in the process of minting of the POS NFT 6722. In various examples, this wallet ID data 6723 can be used to identify where to send the wallet data 6726 for storage. The wallet 6726 can include, for example, one or more portions of the item data 6716 that facilitates, for example, display of a representation of the POS NFT 6722 via the wallet 6725. The wallet data 6726 can further include a private key or other encryption key and/or other data required by the wallet 6725 to access the POS NFT 6722 via the blockchain system 6720.

In further examples, the POS platform 6727 can further receive, via the user interface 6709, a unique identifier 6717 associated with the item. This unique identifier 6717 can be a serial number, unique token, signature and/or certificate associated with the item that can be used to uniquely identify that item. This unique identifier 6717 can also be part of the NFT data and/or metadata used in the minting of the POS NFT 6722 and be further used, for example in identifying and/or authenticating the purchased item via the POS NFT 6722.

While a particular architecture is shown, other configurations, combinations and connections are likewise possible. For example, while the wallet 6825 is shown separately from a client device 825, the wallet can be implemented as an application, such as wallet app 250 of the client device 825 as previously discussed. Furthermore, payment processor 6710 and/or item database 6712 can be implemented as an integral part of the POS platform 6727. The blockchain system 6720 can be implemented via a blockchain, IPFS or other distributed computer system with immutable storage.

FIG. 12B presents pictorial representations of a plurality of example screen displays. This set of example screen displays represent instances of user interface 6709 that are numbered 6709-1 through 6709-8 that are presented to a user in conjunction with the sale of a Weber gas grill. In 6709-1 the user (e.g., the purchaser) is prompted to scan their first item. In 6709-2 the user has scanned the bar code for the grill, and an item description, model number and price are presented. In 6709-3, the user was prompted to select whether or not they wish to receive a POS NFT and has elected to receive such an NFT. In 6907-4, the was prompted to scan the serial number for the item, (e.g., via an optical image, barcode, QR code, etc.) or to enter the serial number (e.g., via a keypad or keyboard). As discussed this information can be used as a unique identifier. In 6709-5, the user is prompted to present payment information via their phone or card that can be entered, for example, via card reader, smartphone NFC, etc. In 6709-6, the user is prompted to enter purchaser ID data. This information can be entered manually, via credit card, via interaction with the user's smartphone and/or via capturing or scanning a driver's license or other identification. In 6709-7 the user is prompted to enter their wallet ID data. This information can be entered, for example, manually or via interaction with the user's smartphone. In 6709-8, the system indicates that the transaction has been completed. An example representation of the minted POS NFT 6722 is presented in FIG. 12C.

It should be noted that the example above provides a number of interactions via a user interface. In other examples, these interactions can be modified and/or presented in a different order, one or more of the interactions can be skipped and/or additional interactions (not specifically shown) may be presented.

FIG. 12D presents a flowchart representation 6800-1 of an example method. In particular, a method is presented for use in conjunction with one or more functions or features described herein. For example, the method can be implemented via a POS platform such as POS platform 6727, an NFT platform or other system. Step 6802-1 includes receiving, via the optical scanner, image data corresponding to a stock keeping unit (SKU) of an item. Step 6804-1 includes receiving item data, via the network interface and responsive to the SKU, wherein the item data is associated with the item. Step 6806-1 includes receiving, via the user interface, payment information associated with purchase of the item. Step 6808-1 includes facilitating, via the processor, based on the item data and responsive to the purchase of the item, creation of a POS NFT corresponding to the item.

FIG. 12E presents a flowchart representation 6800-2 of an example method. In particular, a method is presented for use in conjunction with one or more functions or features described herein. For example, the method can be implemented via a POS platform such as POS platform 6727, an NFT platform or other system. Step 6802-2 includes receiving, via the optical scanner, image data corresponding to a stock keeping unit (SKU) of an item. Step 6804-2 includes receiving item data, via the network interface and responsive to the SKU, wherein the item data is associated with the item. Step 6806-2 includes receiving, via the user interface, payment information associated with purchase of the item. Step 6808-2 includes receiving, via the user interface, purchaser identification data associated with a purchaser of the item. Step 6810-2 includes facilitating, via the processor, based on the item data and responsive to the purchase of the item, creation of a POS NFT corresponding to the item.

FIG. 12F presents a flowchart representation 6800-3 of an example method. In particular, a method is presented for use in conjunction with one or more functions or features described herein. For example, the method can be implemented via a POS platform such as POS platform 6727, an NFT platform or other system. Step 6802-3 includes receiving, via the optical scanner, image data corresponding to a stock keeping unit (SKU) of an item. Step 6804-3 includes receiving item data, via the network interface and responsive to the SKU, wherein the item data is associated with the item. Step 6806-3 includes receiving, via the user interface, payment information associated with purchase of the item. Step 6808-3 includes receiving, via the user interface, selection data indicating a purchaser election to generate a POS NFT corresponding to the item. Step 6810-3 includes receiving, via the user interface, purchaser identification data associated with a purchaser of the item. Step 6812-3 includes facilitating, via the processor, based on the item data and the purchaser identification data and responsive to the purchase of the item, creation of the POS NFT corresponding to the item.

FIG. 12G presents a flowchart representation 6800-4 of an example method. In particular, a method is presented for use in conjunction with one or more functions or features described herein. For example, the method can be implemented via a POS platform such as POS platform 6727, an NFT platform or other system. Step 6802-4 includes receiving, via the optical scanner, image data corresponding to a stock keeping unit (SKU) of an item. Step 6804-4 includes receiving item data, via the network interface and responsive to the SKU, wherein the item data is associated with the item. Step 6806-4 includes receiving, via the user interface, payment information associated with purchase of the item. Step 6808-4 includes receiving, via the user interface, wallet identification data associated with a wallet of a purchaser of the item. Step 6810-4 includes facilitating, via the processor, based on the item data and the wallet identification data and responsive to the purchase of the item, creation of the POS NFT corresponding to the item, and storage of the POS NFT in the wallet of the purchaser of the item.

FIG. 12H presents a flowchart representation 6800-5 of an example method. In particular, a method is presented for use in conjunction with one or more functions or features described herein. For example, the method can be implemented via a POS platform such as POS platform 6727, an NFT platform or other system. Step 6802-5 includes receiving, via the optical scanner, image data corresponding to a stock keeping unit (SKU) of an item. Step 6804-5 includes receiving item data, via the network interface and responsive to the SKU, wherein the item data is associated with the item. Step 6806-5 includes receiving, via the user interface, payment information associated with purchase of the item. Step 6808-5 includes receiving a unique identifier associated with the item. Step 6810-5 includes facilitating, via the processor, based on the item data and the unique identifier and responsive to the purchase of the item, creation of a POS NFT corresponding to the item.

FIG. 12I presents a block diagram of an example system. In the example shown, an NFT platform 6927 such as NFT collection platform 800, NFT distribution platform 2800 and/or other NFT platform that includes a processor and a memory and that operates to facilitate access to POS NFT 6722 via blockchain system 6720 and wallet 6725 (e.g. an NFT wallet) for purposes the validation/authentication of the NFT. As previously discussed, unlike a normal wallet, which can physically hold cash, credit cards, etc., NFT wallets “store” NFTs by storing the NFT data necessary to access the NFT. So, even though a wallet can be said to store a POS NFT 6722, technically the NFT content is stored on the blockchain, which can only be accessed via the NFT data (e.g., wallet data 6726) in the wallet. This NFT data includes metadata, other off-chain data corresponding to the POS NFT 6722 and in particular, a private key that is stored in the wallet 6725. This private key can be considered an indicator of ownership of the POS NFT 6722 and is required to access the NFT via the blockchain and furthermore to authorize transactions associated with the NFT. When the POS NFT 6722 is successfully accessed in the blockchain system 6720 via the wallet data 6726, the POS NFT 6722 can be said to be “authenticated” or “validated”. If the NFT data (including the private key) is lost or corrupted, the POS NFT 6722 can no longer be accessed—and the NFT is itself “lost” for all intents and purposes, even though it remains immutably stored on the blockchain system 6720. Furthermore, if the POS NFT 6722 has been terminated, superseded or expired (e.g., based on the transfer of ownership or prior sale of the item to another purchaser), then the POS NFT 6722 can no longer be authenticated or validated.

In an example of operation, the NFT data of the POS NFT 6722 includes a unique identifier of a purchased/owned item along with other NFT data. the POS platform 6927 operates by:
receiving, at the processor, a transaction request 6902 corresponding to an item, wherein the item is associated with a POS NFT 6722 minted via a blockchain such as blockchain system 6720. The transaction request includes POS NFT identification data identifying the POS NFT 6722, and the unique identifier associated with the item. In various examples, the transaction request could correspond to a sale, rental or lease, warranty request and/or other transaction involving the item where the authenticity of the item and/or ownership of the item and/or the NFT is considered as part of authorizing the request.
determining, via the processor, when the POS NFT 6722 is authenticated based on, for example, wallet data 6726 shared via the wallet 6725;
determining, via the processor and based on the unique identifier associated with the item, when the POS NFT 6722 is associated with the item, in particular, when the unique identifier accessed via the POS NFT matches the unique identifier received as part of the transaction request;
generating credentials data 6904 to grant the transaction request 6902 when the POS NFT 6722 is authenticated and when the POS NFT is associated with the item, otherwise, the NFT platform 6927 can indicate that the transaction is denied and/or may be fraudulent given that either the unique identifiers do not match or the POS NFT 6722 cannot be validly accessed, validated and/or authenticated.

FIG. 12J presents a flowchart representation 6800-6 of an example method. In particular, a method is presented for use in conjunction with one or more functions or features described herein. For example, the method can be implemented via a NFT platform such as NFT platform 6927, a POS platform or other system. Step 6802-6 includes receiving, at the processor, a transaction request corresponding to an item, wherein the item is associated with a POS NFT minted via a blockchain, wherein the transaction request includes POS NFT identification data identifying the POS NFT, and a unique identifier associated with the item. Step 3804-6 includes determining, via the processor, when the NFT is authenticated. Step 6806-6 includes determining, via the processor and based on the unique identifier associated with the item, when the POS NFT is associated with the item. Step 6808-6 includes generating credentials data to grant the transaction request when the POS NFT is authenticated and when the POS NFT is associated with the item.

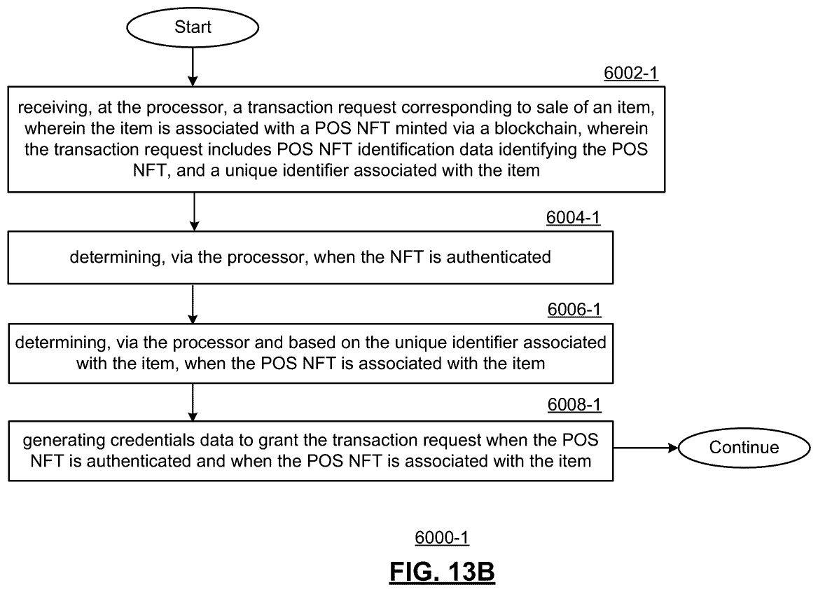

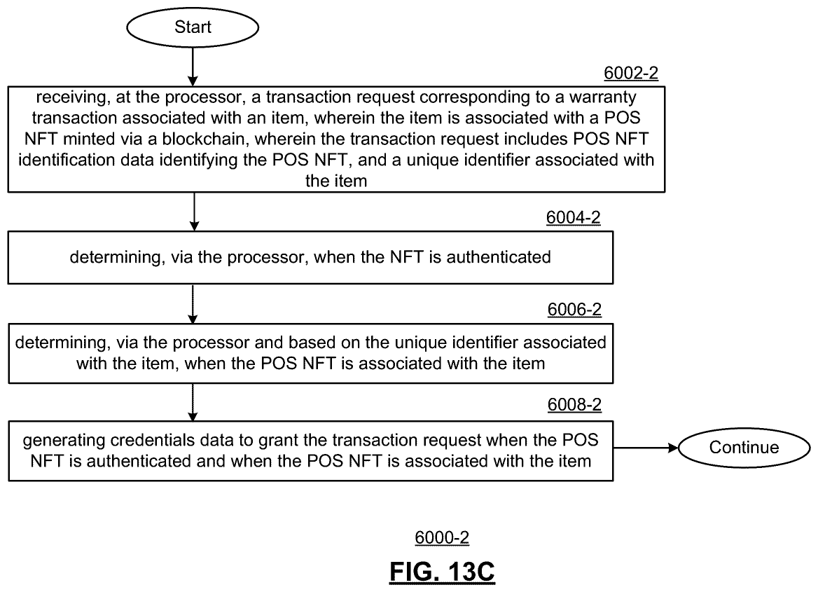

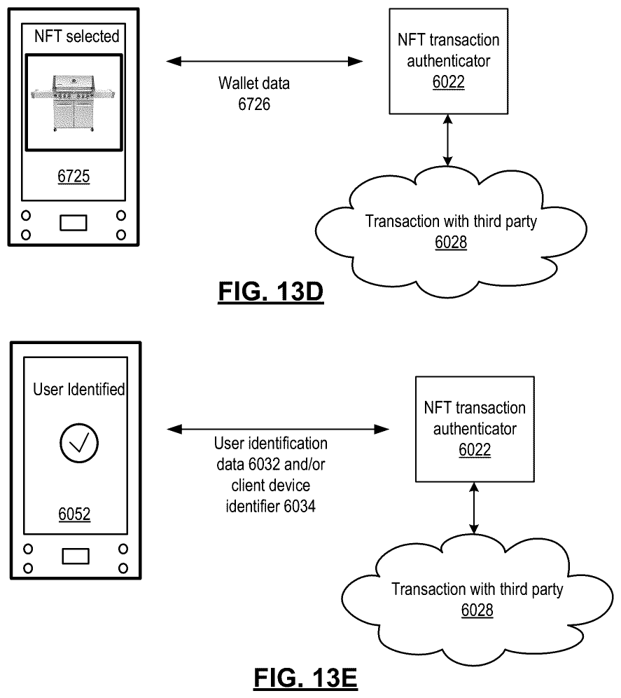

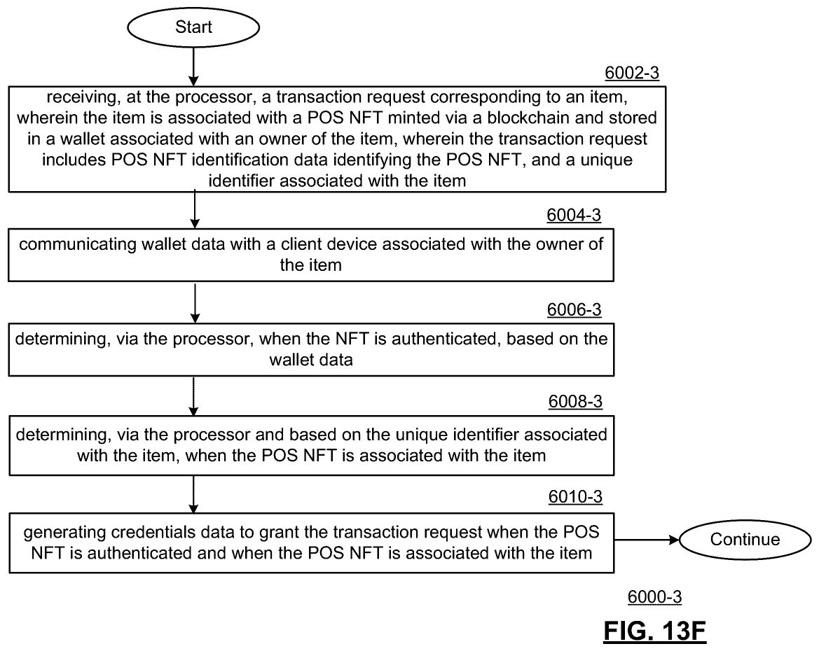

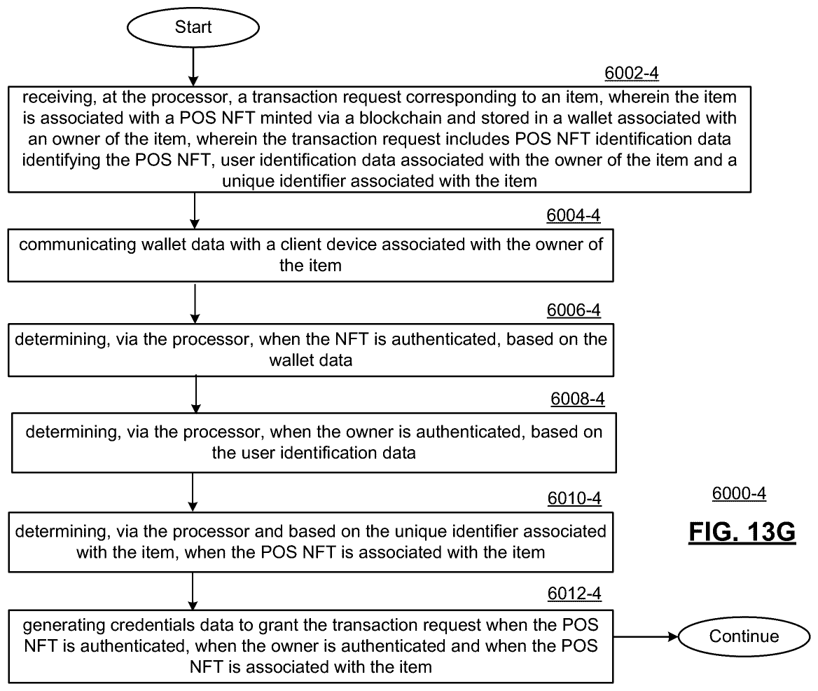

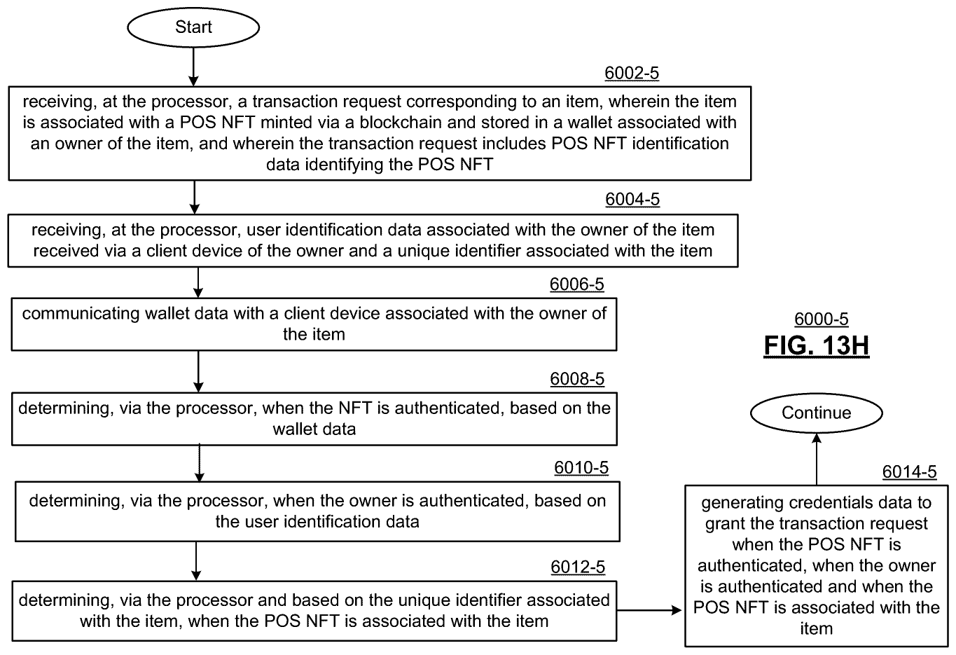

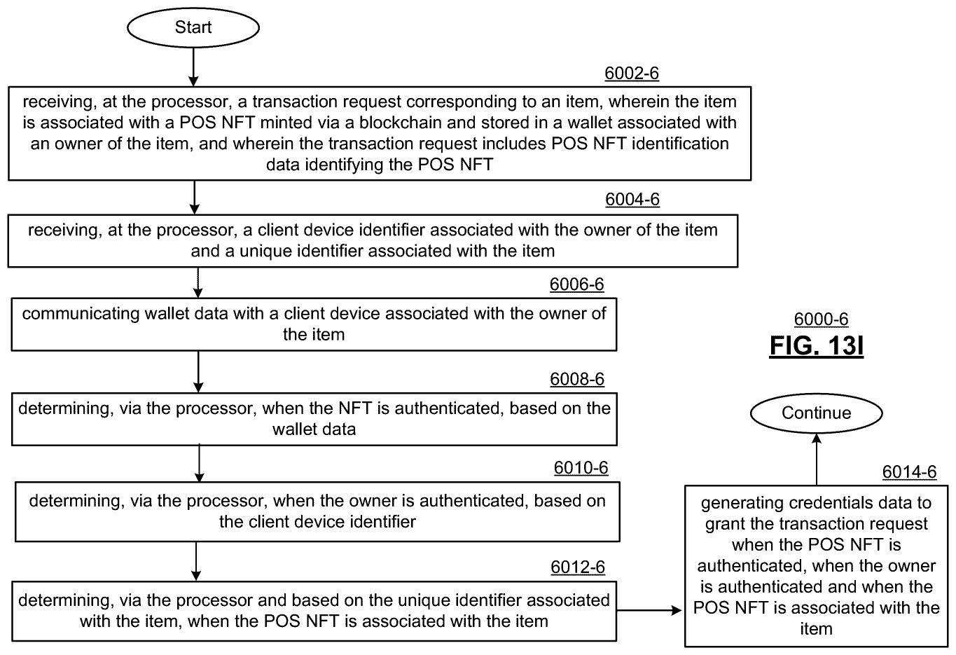

FIG. 13A presents a block diagram of an example system. In particular, a system is shown that can be implemented similarly to, or in conjunction with, NFT collection platform 800, NFT platform 2800 and/or NFT platform 6727. The system includes an NFT transaction authenticator 6022 that can be implemented via one or more modules that include a network interface, processing circuitry and memory. The NFT source 6026, such as blockchain system 6720, NFT creation systems 824 or other immutable storage stores, NFT data and/or metadata associated NFTs of one or more client devices/users 6020.

In operation, the NFT transaction authenticator 6022 responds to transaction requests corresponding to a user associated with an NFT (e.g. a POS NFT or other NFT) to authenticate the NFT—and in some cases, the user/owner and/or an item associated with NFT—or otherwise to determine the validity of a transaction that is requested. If the user and the NFT (and optionally the item and/or the user/owner) are authenticated and the requested transaction is otherwise permissible (e.g. not restricted by conditions on use or other transaction restrictions), then the NFT transaction authenticator 6022 responds by issuing credentials to facilitate the transaction with a third party 6028. A further example of operation of the NFT transaction authenticator 6022 is presented in conjunction with the method of FIG. 12J.

The system optionally includes a secure real-time NFT metadata repository 6024. In various examples, the secure real-time NFT metadata repository 6024 can be implemented via one or more modules that include a network interface, processing circuitry and memory. When included, the secure real-time NFT metadata repository 6024 stores NFT metadata received in conjunction with NFTs created via metadata source 6026. The maintenance and use of the secure real-time NFT metadata repository 6024 allows authentication of NFT related transactions in real-time—avoiding possible delays in performing, for example, complex blockchain transactions via an NFT source 6026 where the NFT was minted and/or otherwise maintained.

Consider the further example where an NFT is created via NFT source 6026. In addition to other NFT data, the NFT has metadata that uniquely identifies the NFT, a hash or other NFT authentication metadata that can be used to authenticate the NFT and/or transaction restriction metadata indicating possible restrictions on transactions/use conditions involving the NFT. Furthermore, when the NFT is created and/or acquired by a user, user-specific user authentication metadata is acquired or created and stored on the blockchain with the NFT with the other metadata. This user authentication metadata can include one or more passwords, answers to security questions, identifiers of recognized devices such as a device identifier of a personal cellphone, laptop, tablet, computer or other known and/or trusted device, one or more trusted networks of the user, other multifactor authentication data such as personal information, known answers to security questions, biometric data related to fingerprints, retinal scans, facial features or other biometrics of the user and/or other user authentication data that can be used to determine if a user is the owner of the NFT or otherwise an authorized user and in particular, whether or not the user is (or is not) who they claim to be.

The metadata associated with the NFT is indexed by NFT identifier and stored on the secure real-time NFT metadata repository 6024 for use by the NFT transaction authenticator 6022 in authenticating NFT-related transactions. This metadata is available from the repository on a real-time basis (e.g., is available with an acceptable amount of latency associated with a corresponding transaction). The metadata in the secure real-time NFT metadata repository 6024 is also synced periodically with the NFT via the NFT source 6026 to reflect any changes in the NFT itself. While some metadata, such as an NFT identifier, NFT authentication metadata and/or transaction restriction metadata may be made accessible to the user who holds the NFT, in various examples, the user authentication metadata in particular, can be encrypted in such a fashion that is decryptable by the secure real-time NFT metadata repository 6024—but not by the user. In various examples, the secure real-time NFT metadata repository 6024 lacks a general network connection and is connected to the NFT transaction authenticator 6022 via a dedicated and/or otherwise secured connection or is otherwise walled-off from other network connections of the NFT transaction authenticator 6022. This helps prevent unauthorized tampering with the sensitive data stored therein.

When a user or a client device 6020, such as client device 825, and/or third party 6028 proposes an NFT-related transaction, the NFT transaction authenticator 6022 collects from the user as part of the transaction request (a) an identifier of the NFT, and NFT authentication data corresponding to the NFT (b) user authentication data user, and (c) information on the proposed transaction. The NFT transaction authenticator 6022 determines whether or not the identifier corresponds to a valid NFT. If so, it retrieves the metadata associated with the NFT from secure real-time NFT metadata repository 6024 or NFT source 6026. The NFT transaction authenticator 6022 authenticates the NFT by comparing the NFT authentication data to the NFT authentication metadata to determine if they match. The NFT transaction authenticator 6022 can also authenticate the user 6020 to the NFT by comparing the user authentication data to the user authentication metadata to determine if they match. If authentication succeeds, the NFT transaction authenticator 6022 facilitates the transaction with the third party 6028 by authorizing completion of the transaction, e.g. by issuing a credential to the third party 6028. The credential can include any message, object, or data structure that vouches for the identity of the user, the authenticity of the NFT and/or the validity of the transaction, through some method of security, trust and/or authentication.

In this fashion, the NFT transaction authenticator 6022 can authenticate transactions such as sale and warranty transactions, access to a flight via a driver's license or passport NFT, sale of a vehicle, real estate via a title NFT, a credit, debit or gift card transaction via a credit, debit or gift card NFT, the sale of a stock or bond via a stock or bond certificate NFT, warranty transactions via a warranty card NFT, access to events via venue ticket NFTs and/or vaccination card NFTs, coupon redemption via a coupon NFT, access to a vehicle, dwelling or office via a key NFT, etc. Furthermore, the NFT transaction authenticator 6022 can authenticate transactions such as sales and/or micro-loans of NFTs itself.

It should be noted that some NFTs are conditional, e.g. that have restrictions on their use and/or the transactions that are permitted. Depending on the type of transaction, the NFT transaction authenticator 6022 can also operate to compare transaction data received from the user to transaction restrictions metadata to determine if a transaction is permitted—before it is authorized. In this fashion, a credit, debit or gift card transaction can be halted if an expiration date or transaction limit has been exceeded. A warranty transaction can be halted if the warranty has expired. A key access for a pool, gym or office can be halted based on date, day of week or time of day restrictions, etc.

Furthermore, in sales transactions and/or micro-loans that have been authorized, the NFT transaction authenticator 6022 can also operate to note the pending sale or micro-loan in the secure real-time NFT metadata repository 6024 or otherwise place a hold on the NFT to prevent another sales or micro-loan until the repository is updated in a future sync with the NFT source 6026. Furthermore, in some cases the NFT corresponds to an expendable asset such as a venue ticket, gift card, coupon, etc. The NFT transaction authenticator 6022 can also operate to determine that the NFT is expended, based on the transaction restrictions metadata and the transaction data. In response to such a determination, NFT transaction authenticator 6022 can then update the secure real-time NFT metadata repository to indicate the NFT is expended. In any of these cases above, the secure real-time NFT metadata repository may facilitate updating of the NFT source 6026 to reflect an authorized transaction via notifications and/or that an NFT has been expended.

FIG. 13B presents a flowchart representation 6000-1 of an example method. In particular, a method is presented for use in conjunction with one or more functions or features described herein. For example, the method can be implemented via a NFT platform such as NFT transaction authenticator 6022, NFT platform 6927, a POS platform or other system. Step 6002-1 includes receiving, at the processor, a transaction request corresponding to sale of an item, wherein the item is associated with a POS NFT minted via a blockchain, wherein the transaction request includes POS NFT identification data identifying the POS NFT, and a unique identifier associated with the item. Step 6004-1 includes determining, via the processor, when the NFT is authenticated. Step 6006-1 includes determining, via the processor and based on the unique identifier associated with the item, when the POS NFT is associated with the item. Step 68008-1 includes generating credentials data to grant the transaction request when the POS NFT is authenticated and when the POS NFT is associated with the item.

FIG. 13C presents a flowchart representation 6000-2 of an example method. In particular, a method is presented for use in conjunction with one or more functions or features described herein. For example, the method can be implemented via a NFT platform such as NFT transaction authenticator 6022, NFT platform 6927, a POS platform or other system. Step 6002-2 includes receiving, at the processor, a transaction request corresponding to a warranty transaction associated with an item, wherein the item is associated with a POS NFT minted via a blockchain, wherein the transaction request includes POS NFT identification data identifying the POS NFT, and a unique identifier associated with the item. Step 6804-2 includes determining, via the processor, when the NFT is authenticated. Step 6006-2 includes determining, via the processor and based on the unique identifier associated with the item, when the POS NFT is associated with the item. Step 6008-2 includes generating credentials data to grant the transaction request when the POS NFT is authenticated and when the POS NFT is associated with the item.

FIG. 13D presents a pictorial block/flow diagram/flow representation of a further example of transaction authentication. In this case a client device, such as client device 825 or 6020 of an NFT owner includes an NFT wallet 6725 that stores one or more NFTs. These NFTs can include a POS NFT to be used to authenticate a transaction associated with in item of the owner via an NFT platform such as NFT transaction authenticator 6022. The client device and the NFT transaction authenticator 6022 share wallet data 6726 via a secure link, such as via NFC communication or other secure link, that can be used to authenticate the NFT as part of the transaction.

FIG. 13E presents a pictorial block/flow diagram/flow representation of a further example of transaction authentication. In this case a client device, such as client device 825 or 6020 of an NFT owner shares user identification data 6032 such as biometric data, username, password, a user name retrieved or generated by the client device and/or a client device identifier 6034 and or other unique identifier to be used to authenticate a transaction associated with an item of the owner via an NFT platform such as NFT transaction authenticator 6022. The client device and the NFT transaction authenticator 6022 communicate user identification data 6032 and/or a client device identifier 6034 via a secure link, such as via NFC communication or other secure link, that can be used to authenticate the NFT as part of the transaction. The user identification data 6032 and/or a client device identifier 6034 can be communicated in conjunction with a transaction request and/or can be considered to be included in the transaction request, i.e., information that is required to process a transaction request associated with the user/owner and a third party.

Consider an example where an NFT, such as a POS NFT is minted with NFT metadata or other NFT data that includes an indication of the user identification data 6032 and/or a client device identifier 6034. When the NFT is accessed via the NFT transaction authenticator 6022, this user identification data 6032 and/or a client device identifier 6034 can be retrieved from the NFT and compared with the corresponding information received from the client device. If the information matches, the user's ownership can be authenticated. In this fashion, transactions can be credentialed only when the true owner (as recorded in the NFT) is present to authorize the transaction.

FIG. 13F presents a flowchart representation 6000-3 of an example method. In particular, a method is presented for use in conjunction with one or more functions or features described herein. For example, the method can be implemented via a NFT platform such as NFT transaction authenticator 6022, NFT platform 6927, a POS platform or other system. Step 6002-3 includes receiving, at the processor, a transaction request corresponding to an item, wherein the item is associated with a POS NFT minted via a blockchain and stored in a wallet associated with an owner of the item, wherein the transaction request includes POS NFT identification data identifying the POS NFT, and a unique identifier associated with the item. Step 6004-3 includes communicating wallet data with a client device associated with the owner of the item. Step 6006-3 includes determining, via the processor, when the NFT is authenticated, based on the wallet data. Step 6008-3 includes determining, via the processor and based on the unique identifier associated with the item, when the POS NFT is associated with the item. Step 6010-3 includes generating credentials data to grant the transaction request when the POS NFT is authenticated and when the POS NFT is associated with the item.

FIG. 13G presents a flowchart representation 6000-4 of an example method. In particular, a method is presented for use in conjunction with one or more functions or features described herein. For example, the method can be implemented via a NFT platform such as NFT transaction authenticator 6022, NFT platform 6927, a POS platform or other system. Step 6002-4 includes receiving, at the processor, a transaction request corresponding to an item, wherein the item is associated with a POS NFT minted via a blockchain and stored in a wallet associated with an owner of the item, wherein the transaction request includes POS NFT identification data identifying the POS NFT, user identification data associated with the owner of the item and a unique identifier associated with the item. Step 6004-4 includes communicating wallet data with a client device associated with the owner of the item. Step 6006-4 includes determining, via the processor, when the NFT is authenticated, based on the wallet data.

Step 6008-4 includes determining, via the processor, when the owner is authenticated, based on the user identification data. Step 6010-4 includes determining, via the processor and based on the unique identifier associated with the item, when the POS NFT is associated with the item. Step 6012-4 includes generating credentials data to grant the transaction request when the POS NFT is authenticated, when the owner is authenticated and when the POS NFT is associated with the item.

FIG. 13H presents a flowchart representation 6000-5 of an example method. In particular, a method is presented for use in conjunction with one or more functions or features described herein. For example, the method can be implemented via a NFT platform such as NFT transaction authenticator 6022, NFT platform 6927, a POS platform or other system. Step 6002-5 includes receiving, at the processor, a transaction request corresponding to an item, wherein the item is associated with a POS NFT minted via a blockchain and stored in a wallet associated with an owner of the item, and wherein the transaction request includes POS NFT identification data identifying the POS NFT. Step 6004-5 includes receiving, at the processor, user identification data associated with the owner of the item received via a client device of the owner and a unique identifier associated with the item. Step 6006-5 includes communicating wallet data with a client device associated with the owner of the item.

Step 6008-5 includes determining, via the processor, when the NFT is authenticated, based on the wallet data. Step 6010-5 includes determining, via the processor, when the owner is authenticated, based on the user identification data. Step 6012-5 includes determining, via the processor and based on the unique identifier associated with the item, when the POS NFT is associated with the item. Step 6014-5 includes generating credentials data to grant the transaction request when the POS NFT is authenticated, when the owner is authenticated and when the POS NFT is associated with the item.

FIG. 13I presents a flowchart representation 6000-6 of an example method. In particular, a method is presented for use in conjunction with one or more functions or features described herein. For example, the method can be implemented via a NFT platform such as NFT transaction authenticator 6022, NFT platform 6927, a POS platform or other system. Step 6002-6 includes receiving, at the processor, a transaction request corresponding to an item, wherein the item is associated with a POS NFT minted via a blockchain and stored in a wallet associated with an owner of the item, and wherein the transaction request includes POS NFT identification data identifying the POS NFT. Step 6004-6 includes receiving, at the processor, user identification data associated with the owner of the item received via a client device of the owner and a unique identifier associated with the item. Step 6006-6 includes communicating wallet data with a client device associated with the owner of the item.

Step 6008-6 includes determining, via the processor, when the NFT is authenticated, based on the wallet data. Step 6010-6 includes determining, via the processor, when the owner is authenticated, based on the user identification data. Step 6012-6 includes determining, via the processor and based on the unique identifier associated with the item, when the POS NFT is associated with the item. Step 6014-6 includes generating credentials data to grant the transaction request when the POS NFT is authenticated, when the owner is authenticated and when the POS NFT is associated with the item.

As used herein, the terms “game piece” and “game character” can be used interchangeably to refer to a game character, an ancillary article or other article or object that is used in a game.

As used herein “blockchain” and “blockchain node” refer to traditional blockchain technology. However, other decentralized computer network technologies that, for example, maintain a secure and decentralized record of transactions and/or otherwise protect the security of digital information can likewise be employed. In various examples, a blockchain can operate to collect information together in groups, such as blocks, that hold sets of information. These blocks have certain storage capacities and, when filled, are closed and linked to the previously filled blocks, forming a chain of data. New information that follows that freshly added block is compiled into newly formed blocks that, once filled, can also be added to the chain.

As used herein the term “tool” corresponds to a utility, application and/or other software routine that performs one or more specific functions in conjunction with a computer.

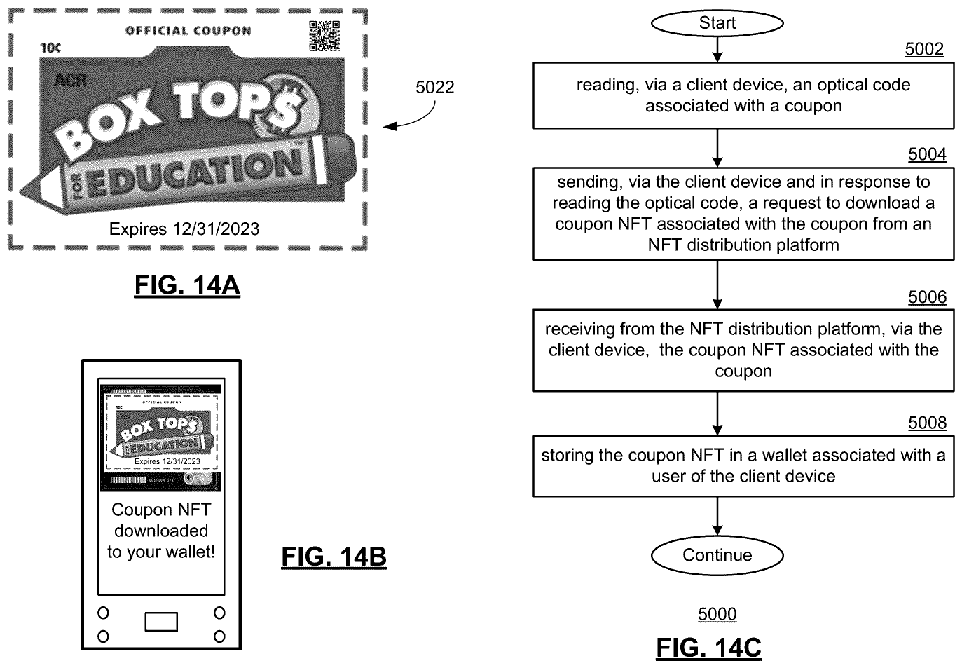

FIG. 14A presents a pictorial representation of an example coupon. In the example shown, a box top or other coupon 5022 includes an optical code such as the QR code that is shown that provides a link to an associated coupon NFT that, for example, is generated to be associated with the coupon that provides a discount, free sample, promotional benefit and/or other reward associated with a product or service.

FIG. 14B presents a pictorial representation of an example client device. In the example shown, the user of the client device has scanned the QR code and collected the coupon NFT for later redemption. In particular the, coupon NFT can be stored in a wallet, such as a crypto/NFT wallet associated with the user and implemented via an application of the client device. As previously discussed, unlike a normal wallet, which can physically hold cash, credit cards, etc., NFT wallets “store” NFTs by storing the NFT data necessary to access the NFT. So, even though a wallet can be said to store an NFT, technically the NFT content is stored on the blockchain, which can only be accessed via the NFT data in the wallet.

While the foregoing has focused on the use of QR codes in association with the distribution of coupon NFTs, other types of codes such as bar codes, numerical codes, alphanumeric codes, alphabetic codes, symbolic codes and/or other identification data can be read/scanned/entered and/or wireless received in order to provide access to a coupon NFT or other NFT in a similar fashion.

FIG. 14C presents a flowchart representation 5000 of an example method. In particular, a method 5000 is presented for use in conjunction with an NFT platform or system and/or any of the other functions and features previously described. In various examples, a method is presented for use with a non-fungible token (NFT) client device that includes a processor and a memory and that utilizes a graphical user interface to interact with a user.

Step S002 includes reading, via the client device, an optical code associated with a coupon. Step S004 includes sending, via the client device and in response to reading the optical code, a request to download a coupon NFT associated with the coupon from an NFT distribution platform. Step S006 includes receiving from the NFT distribution platform, via the client device, the coupon NFT associated with the coupon. Step S008 includes storing the coupon NFT in a wallet associated with a user of the client device.

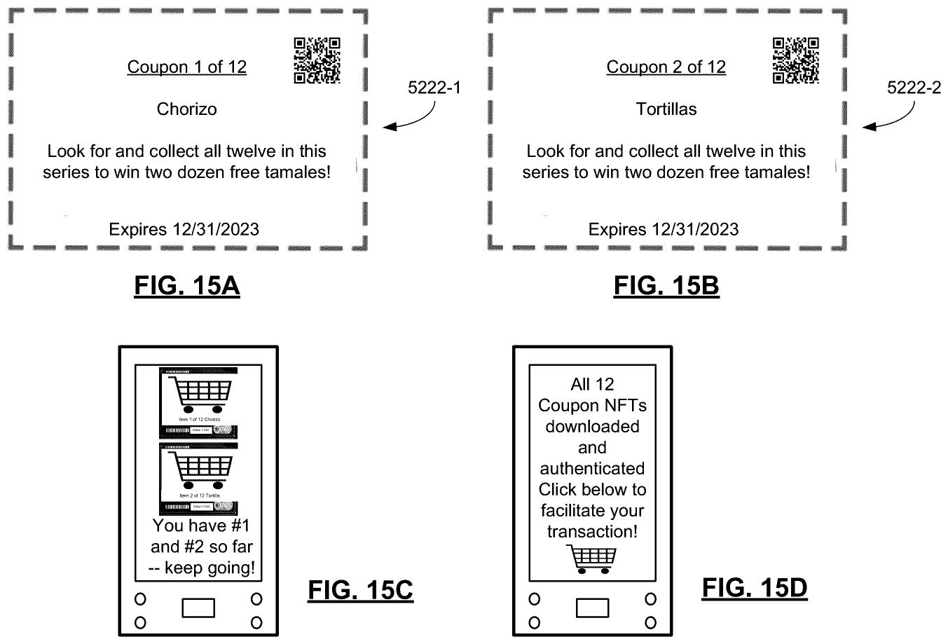

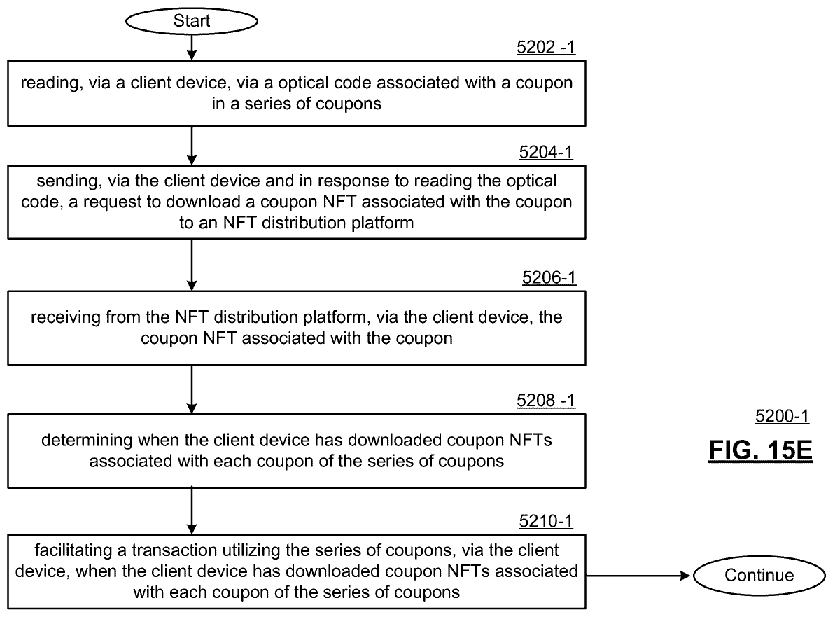

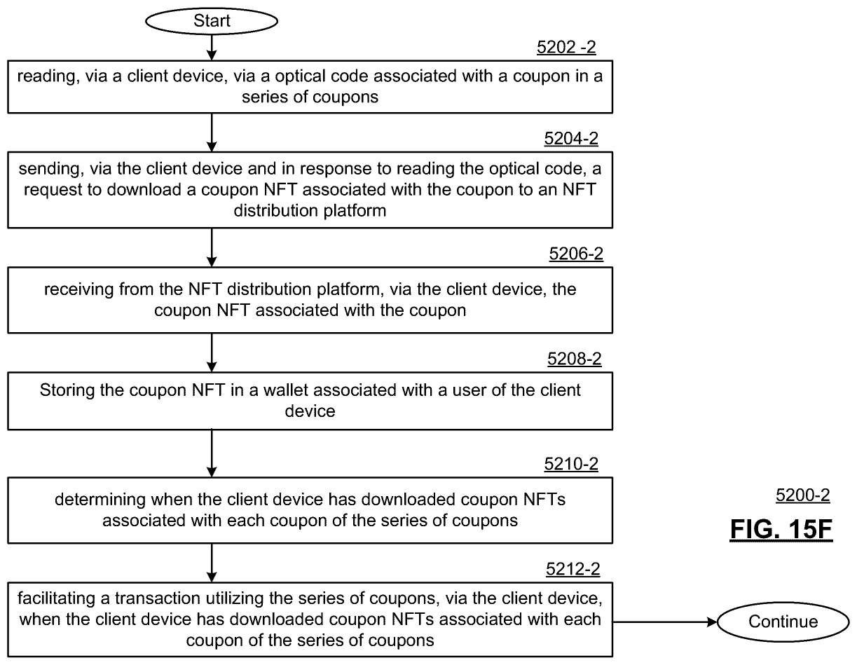

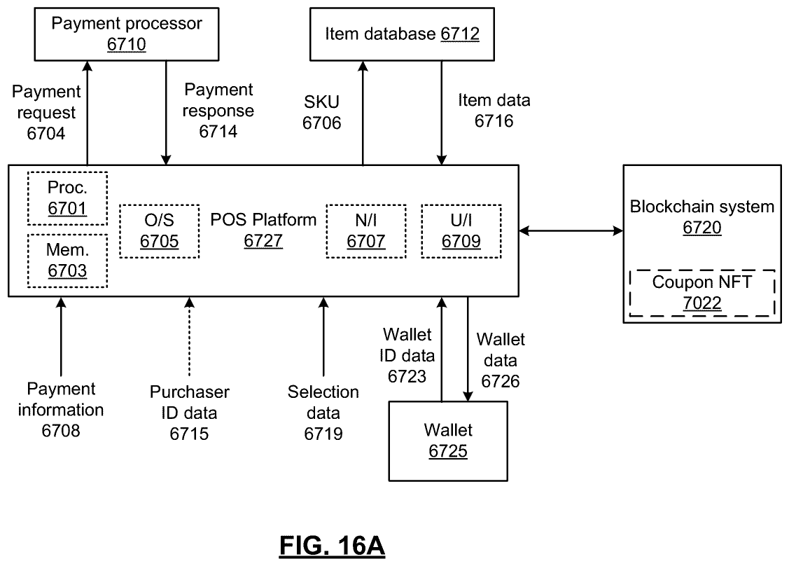

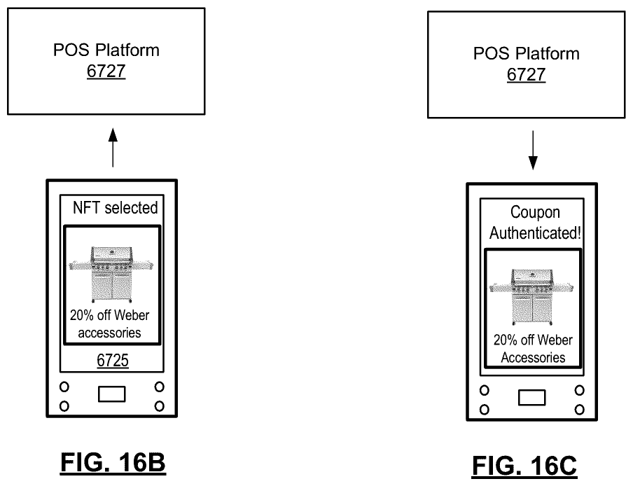

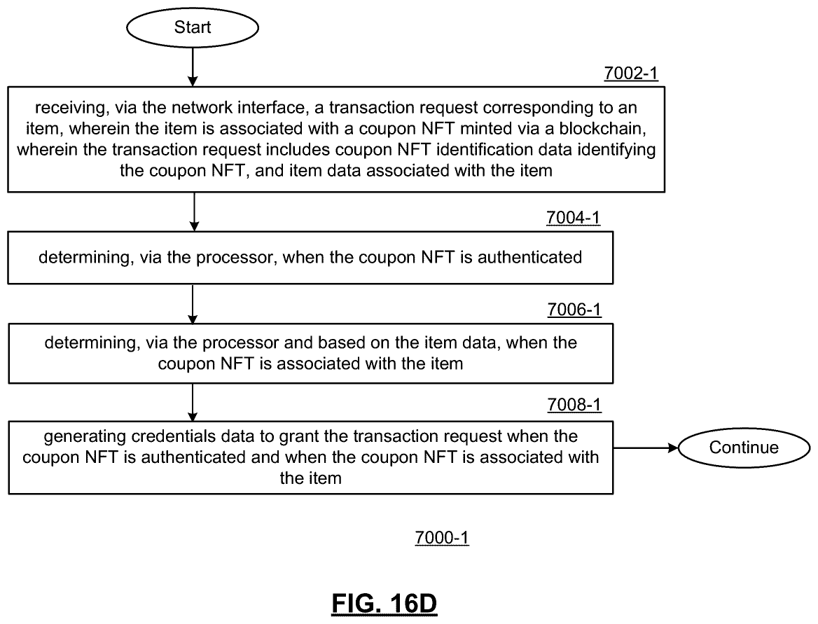

FIGS. 15A-15B present pictorial representations of example coupons in accordance with the example promotion involving the collection of a specific set of coupons. Consider an example where the coupons are generated for a promotion, such as a market basket promotion where, as selected items are purchased, corresponding coupon NFTs can be collected. When a required number or set of the selected items are purchased, the collected/set of corresponding coupon NFTs can be used to trigger/unlock the acquisition of an asset or other reward such as an amount of cash, an amount of crypto currency, a limited edition NFT, a special bonus item, a game piece or other game item, a product, a purchase discount and/or other award.

The coupons 5222-1 and 5222-2 are presented in association with the sale of the items “chorizo” and “tortillas” and each include links to corresponding coupon. In various examples, the coupons could be included with the items themselves and/or printed on a receipt for each item by a POS terminal or other device, verifying that the item has been purchased. While shown as individual coupons and QR codes, in other examples, these can be combined with multiple items being represented by a single coupon/QR code when all or some proper subset of the items are purchased together. As previously discussed, the use of QR codes in association with the distribution of coupon NFTs, other types of codes such as bar codes, numerical codes, alphanumeric codes, alphabetic codes, symbolic codes and/or codes can be read/scanned/entered and/or wireless received in order to provide access to a coupon NFT or other NFT in a similar fashion.

FIGS. 15C-15D present pictorial representations of an example client device. In FIG. 15C, the user has purchased the tortillas and chorizo and consequently has been able to download the corresponding coupon NFTs. In FIG. 15D, all 12 coupon NFTs required by the promotion have been downloaded and authenticated, facilitating the collection of the corresponding reward.

FIG. 15E presents a flowchart representation of an example method. In particular, a method 5200-1 is presented for use in conjunction with an NFT platform or system and/or any of the other functions and features previously described. In various examples, a method is presented for use with a non-fungible token (NFT) client device that includes a processor and a memory and that utilizes a graphical user interface to interact with a user.

Step S202-1 includes reading, via the client device, via an optical code associated with a coupon. Step S204-1 includes sending, via the client device and in response to reading the optical code, a request to download a coupon NFT associated with the coupon to an NFT distribution platform. Step S206-1 includes receiving from the NFT distribution platform, via the client device, the coupon NFT associated with the coupon. Step S208-1 includes determining when the client device has downloaded coupon NFTs associated with each coupon of the series of coupons. Step S210-1 includes facilitating a transaction utilizing the series of coupons, via the client device, when the client device has downloaded coupon NFTs associated with each coupon of the series of coupons.

FIG. 15F presents a flowchart representation of an example method. In particular, a method 5200-2 is presented for use in conjunction with an NFT platform or system and/or any of the other functions and features previously described. In various examples, a method is presented for use with a non-fungible token (NFT) client device that includes a processor and a memory and that utilizes a graphical user interface to interact with a user.

Step S202-2 includes reading, via the client device, via an optical code associated with a coupon. Step S204-2 includes sending, via the client device and in response to reading the optical code, a request to download a coupon NFT associated with the coupon to an NFT distribution platform. Step S206-2 includes receiving from the NFT distribution platform, via the client device, the coupon NFT associated with the coupon. Step S208-2 includes storing the coupon NFT in a wallet associated with a user of the client device. Step S210-2 includes determining when the wallet has stored coupon NFTs associated with each coupon of the series of coupons. Step S212-2 includes facilitating a transaction utilizing the series of coupons, via the client device, when the client device has downloaded coupon NFTs associated with each coupon of the series of coupons.

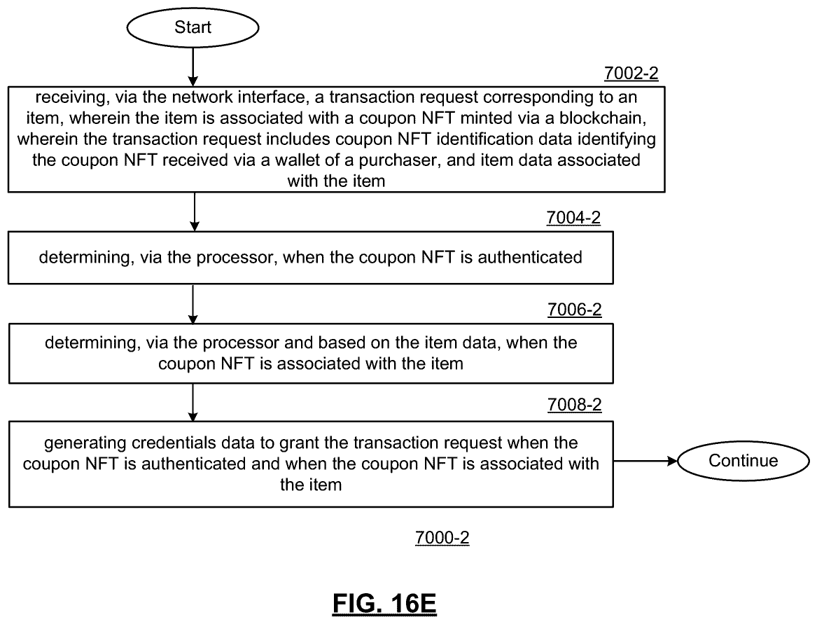

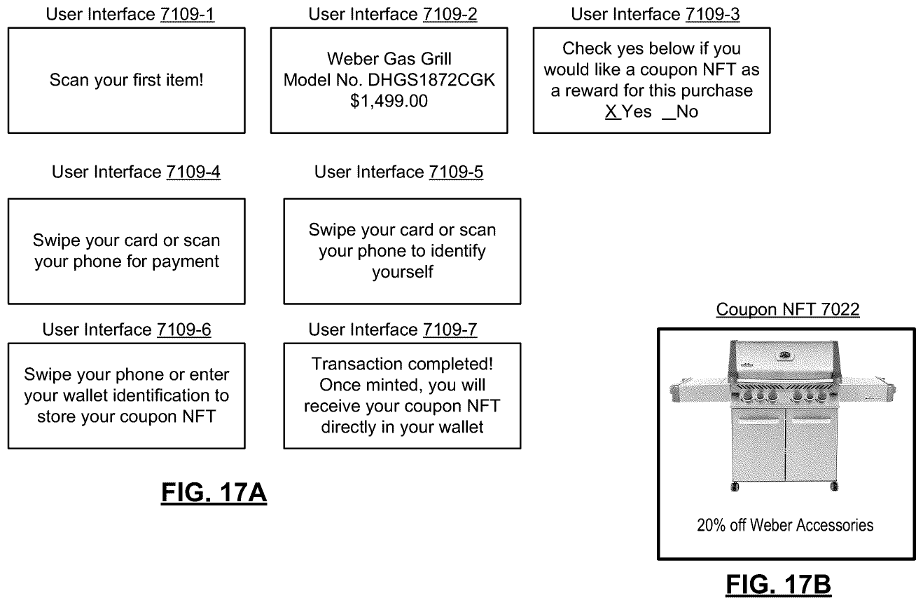

FIG. 16A presents a block diagram representation of an example system. The system includes a further example of a point of sale (POS) platform 6727 that can be implemented in conjunction with an NFT collection platform 800, NFT distribution platform 2800 or other NFT platform that operates to facilitate the creation of new NFTs such as coupon NFTs 7022 or other NFTs associated with items purchased via the POS system. In addition, the POS platform 6727 can be further used to authenticate coupon NFTs in association with sale of an item and/or other transaction to which the coupon NFT is to be applied.

As previously discussed, the POS platform 6727 includes a processor 6701, a memory 6703, an optical scanner (O/S) 6705, a network interface 6707 for communicating with other portions of the system via a network, and a user interface 6709 such as a display screen, touch screen, one or more buttons, a keyboard and/or keypad, an NFC interface or other wireless interface, a card scanner, a chip reader and/or one or more other interface devices for sending/receiving information to/from a user (e.g. a purchaser). The system further includes an item database 6812 containing SKUs and item data associated with items that are for sale, a payment processor 6810 or other marketplace or marketplace tool, a blockchain system 6820, such as NFT creation system 824 or other decentralized computer system and a wallet 6825, such as NFT wallet system 820, a wallet application associated with client device 825 or other electronic wallet.

In an example of operation, the POS system 6727 receives, via the optical scanner 6705, image data (e.g., optical data generated by the scanner in response to a bar code, QR code or other item identifier) corresponding to a stock keeping unit (SKU) 6706 of one or more items to be purchased. The SKU 6706 is sent to the item database 6712 via the network interface 6707. Item data 6716 is received, via the network interface 6707 and responsive to the SKU 6706. The item data 6716 is associated with the item to be purchased and can include one or more images or other media associated with the item, a model number, manufacturer, price, warranty information, vender information and/or other data associated with the item. The POS platform 6727 receives wallet ID data 6723 from the wallet 6725 that indicates a coupon NFT that can be authenticated via the POS platform 6727 and/or blockchain system 6720. In this fashion, the coupon NFT 7022 (once authenticated) can be used in the event the coupon applies a discount, promotion or other award that is properly associated with the purchase of the item or items. For example, the coupon NFT can be used in lieu of, or in addition to, traditional payment information 6708 to complete a sale of the item or items. In circumstances where the coupon NFT provides a benefit that is limited to the purchase of certain item(s) and/or certain purchase terms and conditions and/or limits, etc., this process can include, for example, correlating coupon information from the coupon NFT to the item or items to be purchased to verify that the coupon, in fact, applies to the proposed purchase transaction.

In FIG. 16B, the user is completing a purchase of BBQ accessories and is attempting to use a coupon NFT corresponding to the 20% off coupon. In FIG. 16C, the coupon has been authenticated and the user can then complete the sale using the associated coupon—when the coupon applies to the proposed purchase.

FIG. 16D presents a flowchart representation of an example method. In particular, a method 7000-1 is presented for use in conjunction with an NFT platform or system and/or any of the other functions and features previously described. In various examples, a is presented method for use with a non-fungible token (NFT) platform that includes a processor and a memory.

Step 7002-1 includes receiving, at the processor, a transaction request corresponding to an item, wherein the item is associated with a coupon NFT minted via a blockchain, wherein the transaction request includes coupon NFT identification data identifying the coupon NFT, and item data associated with the item. Step 7004-1 includes determining, via the processor, when the coupon NFT is authenticated. Step 7006-1 includes determining, via the processor and based on the item data, when the coupon NFT is associated with the item. Step 7008-1 includes generating credentials data to grant the transaction request when the coupon NFT is authenticated and when the coupon NFT is associated with the item.

FIG. 16E presents a flowchart representation of an example method. In particular, a method 7000-2 is presented for use in conjunction with an NFT platform or system and/or any of the other functions and features previously described. In various examples, a is presented method for use with a non-fungible token (NFT) platform that includes a processor and a memory.

Step 7002-2 includes receiving, at the processor, a transaction request corresponding to an item, wherein the item is associated with a coupon NFT minted via a blockchain, wherein the transaction request includes coupon NFT identification data identifying the coupon NFT received via a wallet of a purchaser, and item data associated with the item. Step 7004-2 includes determining, via the processor, when the coupon NFT is authenticated. Step 7006-2 includes determining, via the processor and based on the item data, when the coupon NFT is associated with the item. Step 7008-2 includes generating credentials data to grant the transaction request when the coupon NFT is authenticated and when the coupon NFT is associated with the item.

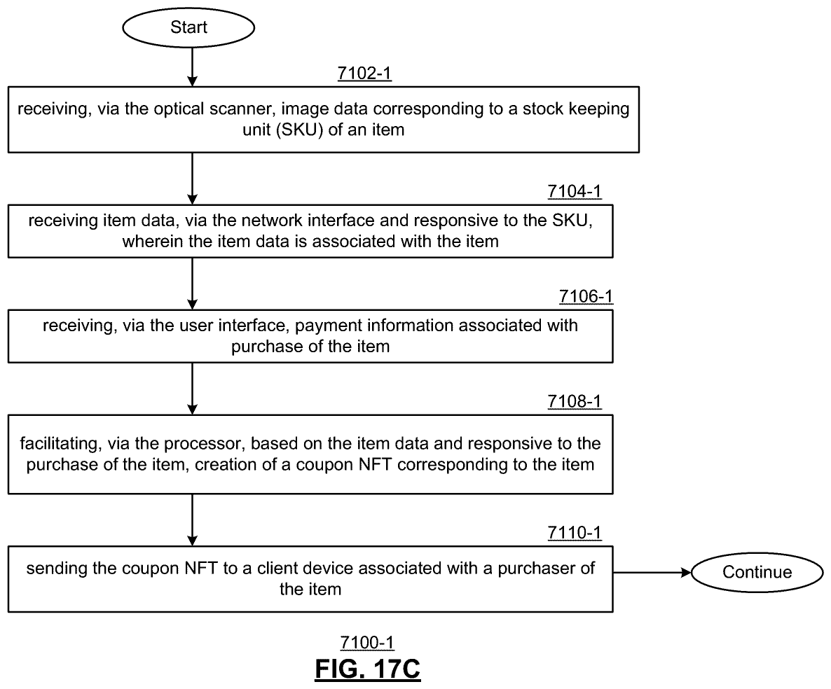

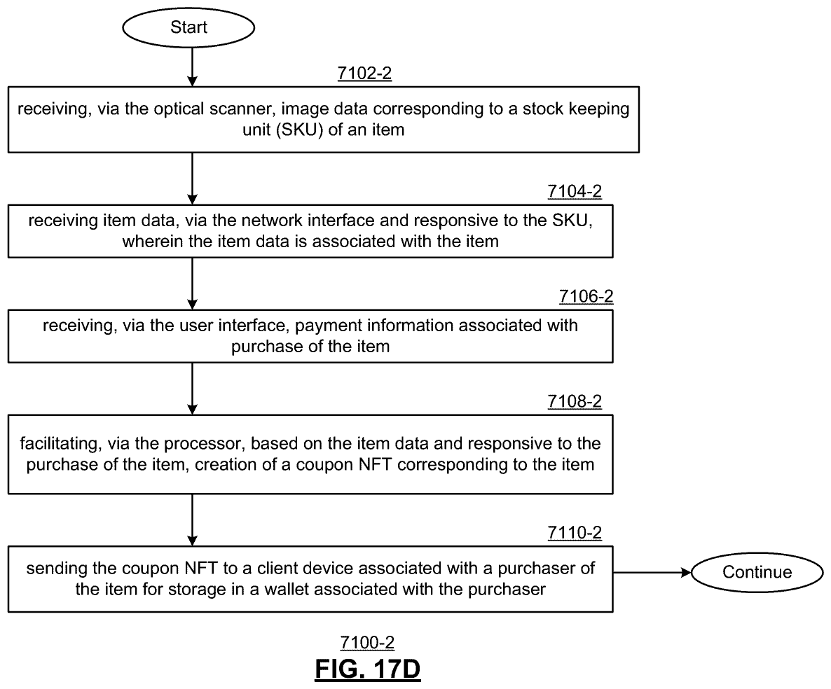

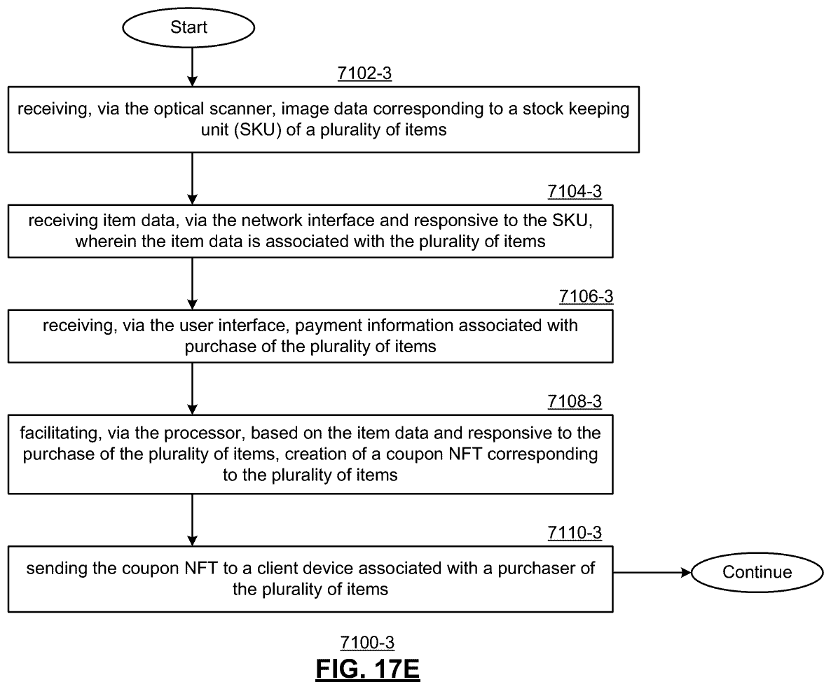

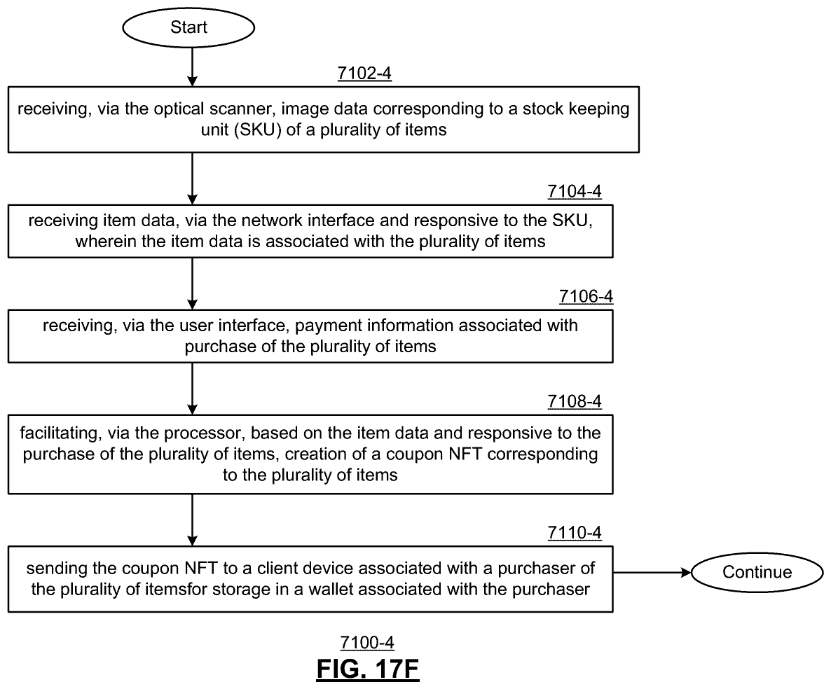

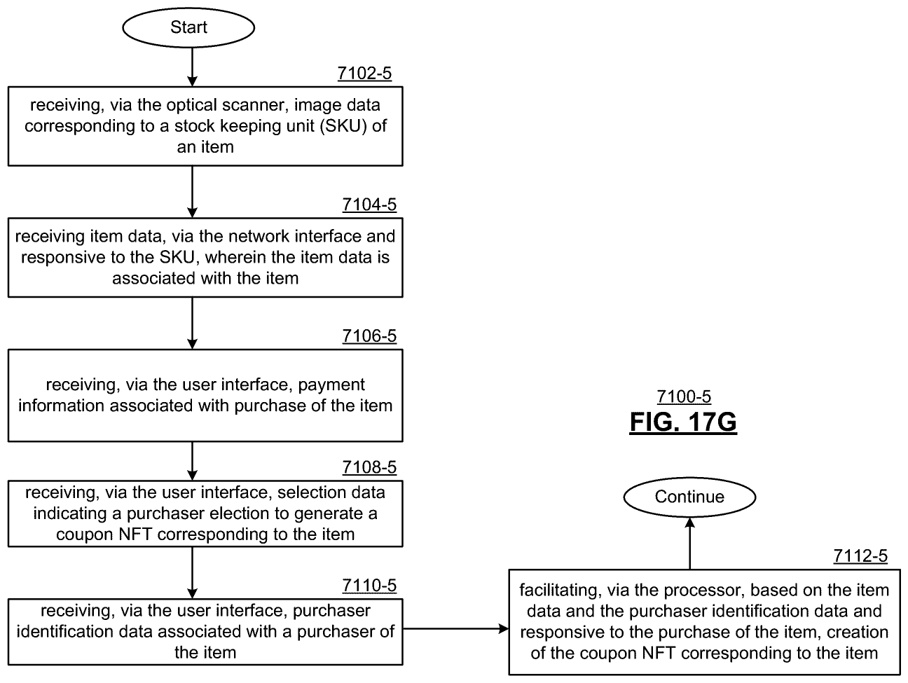

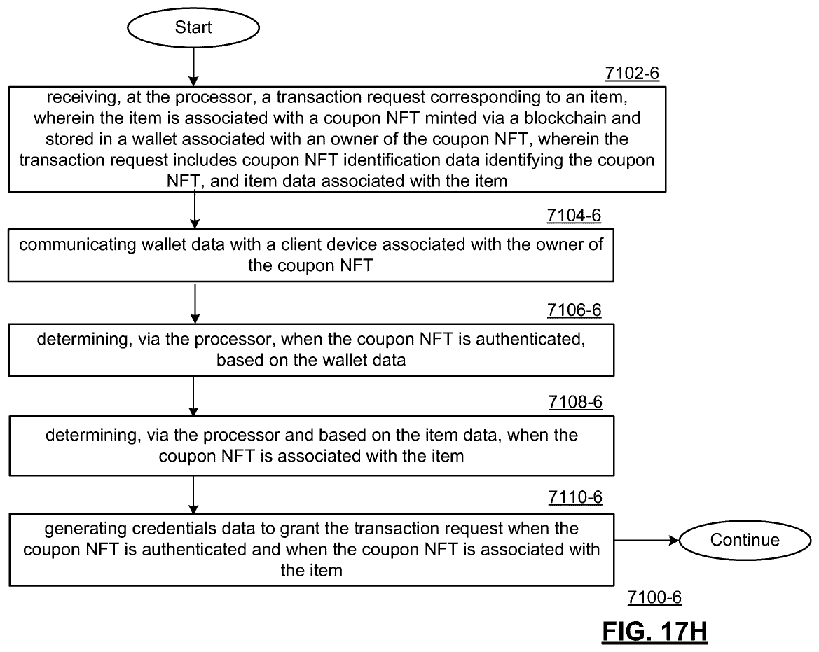

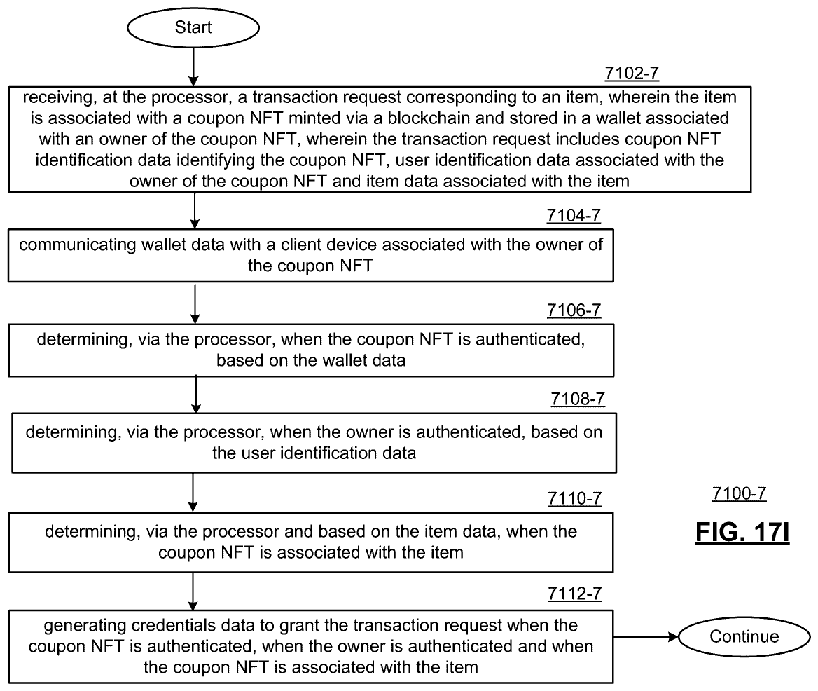

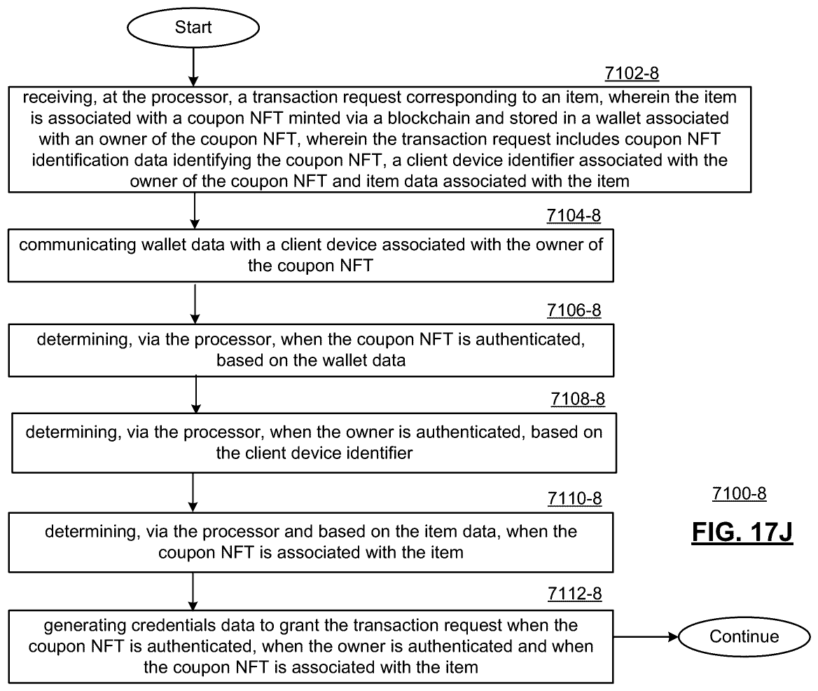

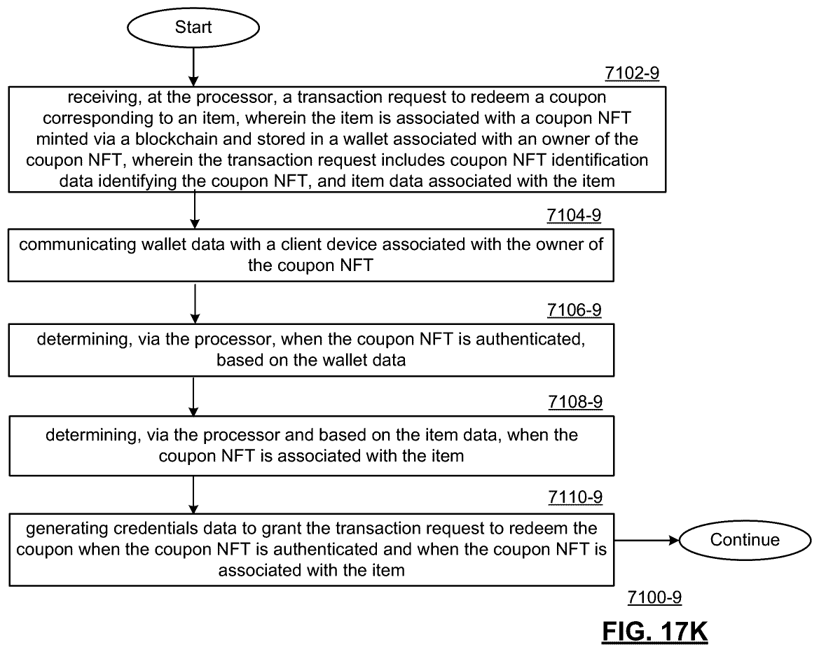

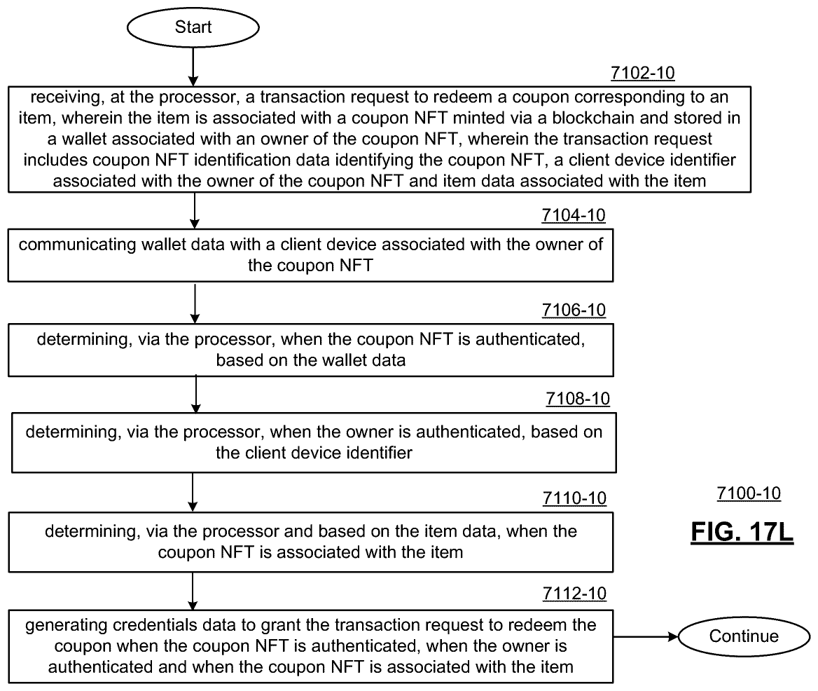

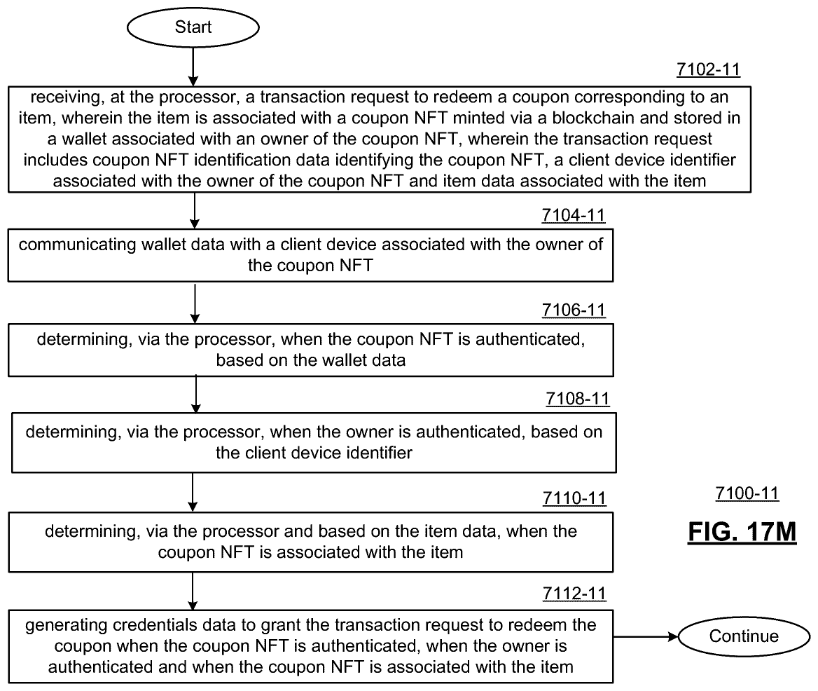

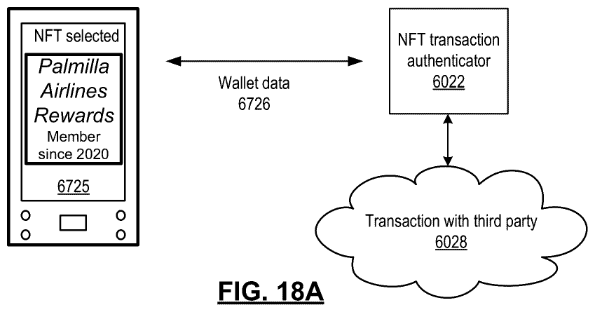

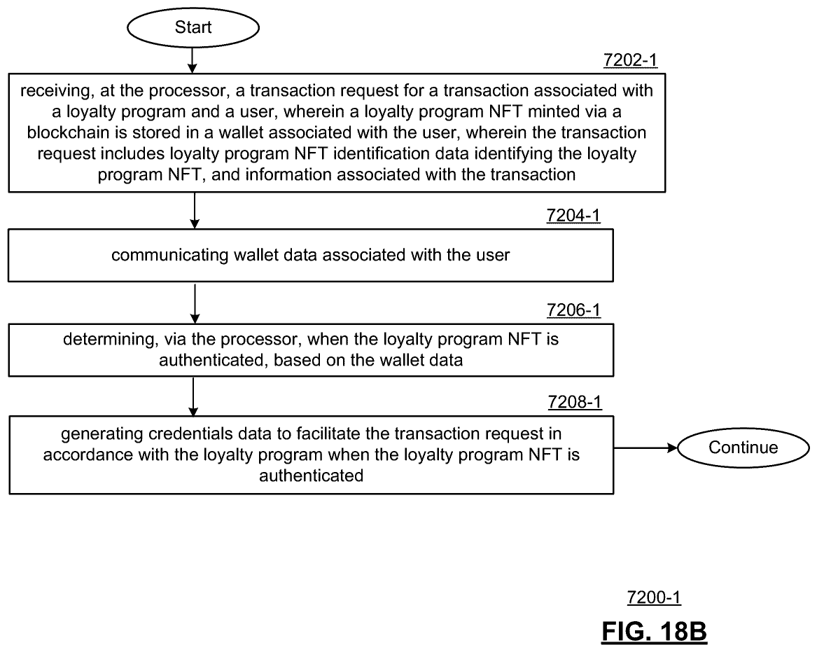

FIG. 17A presents pictorial representations of a plurality of example screen displays. This set of example screen displays represent instances of user interface 6709 that are numbered 7109-1 through 7109-8 that are presented to a user in conjunction with the sale of a Weber gas grill. In 7109-1 the user (e.g., the purchaser) is prompted to scan their first item. In 7109-2 the user has scanned the bar code for the grill, and an item description, model number and price are presented. In 7109-3, the user was prompted to select whether or not they wish to receive a coupon NFT and has elected to receive such an NFT. In 7109-4, the user is prompted to present payment information via their phone or card that can be entered, for example, via card reader, smartphone NFC, etc. In 7109-5, the user is prompted to enter purchaser ID data. This step may or may not be required. If so, this information can be entered manually, via credit card, via interaction with the user's smartphone and/or via capturing or scanning a driver's license or other identification. In 7109-6 the user is prompted to enter their wallet ID data. This information can be entered, for example, manually or via interaction with the user's smartphone. In 7109-7, the system indicates that the transaction has been completed. An example representation of the minted POS NFT 7022 is presented in FIG. 17B.

It should be noted that the example above provides a number of interactions via a user interface. In other examples, these interactions can be modified and/or presented in a different order, one or more of the interactions can be skipped and/or additional interactions (not specifically shown) may be presented. It should be noted that, in the example above, the purchase of a single item was sufficient to qualify for the coupon NFT. In other examples, multiple items, including multiple different items may need to be purchased to qualify for this coupon NFT.

FIG. 17C presents a flowchart representation 7100-1 of an example method. In particular, a method is presented for use in conjunction with one or more functions or features described herein. For example, the method can be implemented via a POS platform such as POS platform 6727, an NFT platform or other system that includes a processor and a user interface.

Step 7102-1 includes receiving, via an optical scanner, image data corresponding to a stock keeping unit (SKU) of an item. Step 7104-1 includes receiving item data, via the network interface and responsive to the SKU, wherein the item data is associated with the item. Step 7106-1 includes receiving, via the user interface, payment information associated with purchase of the item. Step 7108-1 includes facilitating, via the processor, based on the item data and responsive to the purchase of the item, creation of a coupon NFT corresponding to the item. Step 7110-1 includes sending the coupon NFT to a client device associated with a purchaser of the item.

FIG. 17D presents a flowchart representation 7100-2 of an example method. In particular, a method is presented for use in conjunction with one or more functions or features described herein. For example, the method can be implemented via a POS platform such as POS platform 6727, an NFT platform or other system that includes a processor and a user interface. Step 7102-2 includes receiving, via the optical scanner, image data corresponding to a stock keeping unit (SKU) of an item. Step 7104-2 includes receiving item data, via the network interface and responsive to the SKU, wherein the item data is associated with the item. Step 7106-2 includes receiving, via the user interface, payment information associated with purchase of the item.

Step 7208-2 includes facilitating, via the processor, based on the item data and responsive to the purchase of the item, creation of a coupon NFT corresponding to the item. Step 7110-2 includes sending the coupon NFT to a client device associated with a purchaser of the item for storage in a wallet associated with the purchaser.

FIG. 17E presents a flowchart representation 7100-3 of an example method. In particular, a method is presented for use in conjunction with one or more functions or features described herein. For example, the method can be implemented via a POS platform such as POS platform 6727, an NFT platform or other system that includes a processor and a user interface.

Step 7102-3 includes receiving, via the optical scanner, image data corresponding to a stock keeping unit (SKU) of a plurality of items. Step 7104-3 includes receiving item data, via the network interface and responsive to the SKU, wherein the item data is associated with the plurality of items. Step 7106-3 includes receiving, via the user interface, payment information associated with purchase of the plurality of items. Step 7108-3 includes facilitating, via the processor, based on the item data and responsive to the purchase of the plurality of items, creation of a coupon NFT corresponding to the plurality of items. Step 7110-3 includes sending the coupon NFT to a client device associated with a purchaser of the plurality of items.

FIG. 17F presents a flowchart representation 7100-4 of an example method. In particular, a method is presented for use in conjunction with one or more functions or features described herein. For example, the method can be implemented via a POS platform such as POS platform 6727, an NFT platform or other system that includes a processor and a user interface.

Step 7102-4 includes receiving, via the optical scanner, image data corresponding to a stock keeping unit (SKU) of a plurality of items. Step 7204-4 includes receiving item data, via the network interface and responsive to the SKU, wherein the item data is associated with the plurality of items. Step 7406-4 includes receiving, via the user interface, payment information associated with purchase of the plurality of items. Step 7108-4 includes facilitating, via the processor, based on the item data and responsive to the purchase of the plurality of items, creation of a coupon NFT corresponding to the plurality of items. Step 7110-4 includes sending the coupon NFT to a client device associated with a purchaser of the plurality of items for storage in a wallet associated with the purchaser.

FIG. 17G presents a flowchart representation 7100-5 of an example method. In particular, a method is presented for use in conjunction with one or more functions or features described herein. For example, the method can be implemented via a POS platform such as POS platform 6727, an NFT platform or other system that includes a processor and a user interface.

Step 7102-5 includes receiving, via the optical scanner, image data corresponding to a stock keeping unit (SKU) of an item. Step 7104-5 includes receiving item data, via the network interface and responsive to the SKU, wherein the item data is associated with the item. Step 7106-5 includes receiving, via the user interface, payment information associated with purchase of the item.

Step 7108-5 includes receiving, via the user interface, selection data indicating a purchaser election to generate a coupon NFT corresponding to the item. Step 7110-5 includes receiving, via the user interface, purchaser identification data associated with a purchaser of the item. Step 7112-5 includes facilitating, via the processor, based on the item data and responsive to the purchase of the item, creation of the coupon NFT corresponding to the item.

FIG. 17H presents a flowchart representation 7100-6 of an example method. In particular, a method is presented for use in conjunction with one or more functions or features described herein. For example, the method can be implemented via a POS platform such as POS platform 6727, an NFT platform or other system that includes a processor and a user interface.

Step 7102-6 includes receiving, at the processor, a transaction request corresponding to an item, wherein the item is associated with a coupon NFT minted via a blockchain and stored in a wallet associated with an owner of the coupon NFT, wherein the transaction request includes coupon NFT identification data identifying the coupon NFT, and item data associated with the item. Step 7104-6 includes communicating wallet data with a client device associated with the owner of the coupon NFT. Step 7106-6 includes determining, via the processor, when the coupon NFT is authenticated, based on the wallet data. Step 7108-6 includes determining, via the processor and based on the identifier associated with the item, when the coupon NFT is associated with the item. Step 7110-6 includes generating credentials data to grant the transaction request when the coupon NFT is authenticated and when the coupon NFT is associated with the item.

FIG. 17I presents a flowchart representation 7100-7 of an example method. In particular, a method is presented for use in conjunction with one or more functions or features described herein. For example, the method can be implemented via a POS platform such as POS platform 6727, an NFT platform or other system that includes a processor and a user interface.

Step 7102-7 includes receiving, at the processor, a transaction request corresponding to an item, wherein the coupon is associated with a coupon NFT minted via a blockchain and stored in a wallet associated with an owner of the coupon NFT, and wherein the transaction request includes coupon NFT identification data identifying the coupon NFT, user identification data associated with the owner of the coupon NFT received via a client device of the owner and item data associated with the item. Step 7104-7 includes communicating wallet data with the client device associated with the owner of the coupon NFT. Step 7106-7 includes determining, via the processor, when the coupon NFT is authenticated, based on the wallet data.

Step 7108-7 includes determining, via the processor, when the owner is authenticated, based on the user identification data. Step 7110-7 includes determining, via the processor and based on the item data associated with the item, when the coupon NFT is associated with the item. Step 7112-7 includes generating credentials data to grant the transaction request when the coupon NFT is authenticated, when the owner is authenticated and when the coupon NFT is associated with the item.

FIG. 17J presents a flowchart representation 7100-8 of an example method. In particular, a method is presented for use in conjunction with one or more functions or features described herein. For example, the method can be implemented via a POS platform such as POS platform 6727, an NFT platform or other system that includes a processor and a user interface.

Step 7102-8 includes receiving, at the processor, a transaction request corresponding to an item, wherein the coupon is associated with a coupon NFT minted via a blockchain and stored in a wallet associated with an owner of the coupon NFT, and wherein the transaction request includes coupon NFT identification data identifying the coupon NFT, a client device identifier associated with the owner of the coupon NFT and item data associated with the item. Step 7104-8 includes communicating wallet data with a client device associated with the owner of the coupon NFT. Step 7106-8 includes determining, via the processor, when the coupon NFT is authenticated, based on the wallet data/

Step 7108-8 includes determining, via the processor, when the owner is authenticated, based on the client device identifier. Step 7110-8 includes determining, via the processor and based on the item data, when the coupon NFT is associated with the item. Step 7112-8 includes generating credentials data to grant the transaction request when the coupon NFT is authenticated, when the owner is authenticated and when the coupon NFT is associated with the item.

FIG. 17K presents a flowchart representation 7100-9 of an example method. In particular, a method is presented for use in conjunction with one or more functions or features described herein. For example, the method can be implemented via a POS platform such as POS platform 6727, an NFT platform or other system that includes a processor and a user interface.

Step 7102-9 includes receiving, at the processor, a transaction request to redeem a coupon corresponding to an item, wherein the coupon is associated with a coupon NFT minted via a blockchain and stored in a wallet associated with an owner of the coupon NFT, wherein the transaction request includes coupon NFT identification data identifying the coupon NFT, and item data associated with the item. Step 7104-9 includes communicating wallet data with a client device associated with the owner of the coupon NFT. Step 7106-9 includes determining, via the processor, when the coupon NFT is authenticated, based on the wallet data. Step 7108-9 includes determining, via the processor and based on the item data, when the coupon NFT is associated with the item. Step 7110-9 includes generating credentials data to grant the transaction request to redeem the coupon when the coupon NFT is authenticated and when the coupon NFT is associated with the item.

FIG. 17L presents a flowchart representation 7100-10 of an example method. In particular, a method is presented for use in conjunction with one or more functions or features described herein. For example, the method can be implemented via a POS platform such as POS platform 6727, an NFT platform or other system that includes a processor and a user interface.

Step 7102-10 includes receiving, at the processor, a transaction request to redeem a coupon corresponding to an item, wherein the coupon is associated with a coupon NFT minted via a blockchain and stored in a wallet associated with an owner of the coupon NFT, and wherein the transaction request includes coupon NFT identification data identifying the coupon NFT, user identification data associated with the owner of the item received via a client device of the owner and item data associated with the item. Step 7104-10 includes communicating wallet data with the client device associated with the owner of the item. Step 7106-10 includes determining, via the processor, when the coupon NFT is authenticated, based on the wallet data.

Step 7108-10 includes determining, via the processor, when the owner is authenticated, based on the user identification data. Step 7110-10 includes determining, via the processor and based on the item data, when the coupon NFT is associated with the item. Step 7112-10 includes generating credentials data to grant the transaction request to redeem the coupon when the coupon NFT is authenticated, when the owner is authenticated and when the coupon NFT is associated with the item.

FIG. 17M presents a flowchart representation 7100-11 of an example method. In particular, a method is presented for use in conjunction with one or more functions or features described herein. For example, the method can be implemented via a POS platform such as POS platform 6727, an NFT platform or other system that includes a processor and a user interface.

Step 7102-11 includes receiving, at the processor, a transaction request to redeem a coupon corresponding to an item, wherein the coupon is associated with a coupon NFT minted via a blockchain and stored in a wallet associated with an owner of the coupon NFT, and wherein the transaction request includes coupon NFT identification data identifying the coupon NFT, a client device identifier associated with the owner of the coupon NFT and item associated with the item. Step 7104-11 includes communicating wallet data with a client device associated with the owner of the coupon NFT. Step 7106-11 includes determining, via the processor, when the coupon NFT is authenticated, based on the wallet data.

Step 7108-11 includes determining, via the processor, when the owner is authenticated, based on the client device identifier. Step 7110-11 includes determining, via the processor and based on the item data, when the coupon NFT is associated with the item. Step 7112-11 includes generating credentials data to grant the transaction request to redeem the coupon when the coupon NFT is authenticated, when the owner is authenticated and when the coupon NFT is associated with the item.

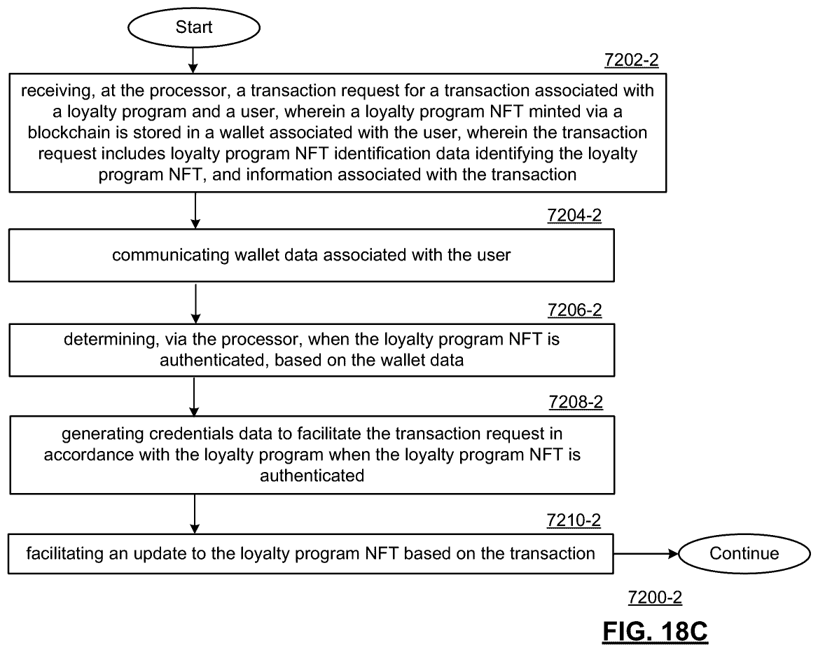

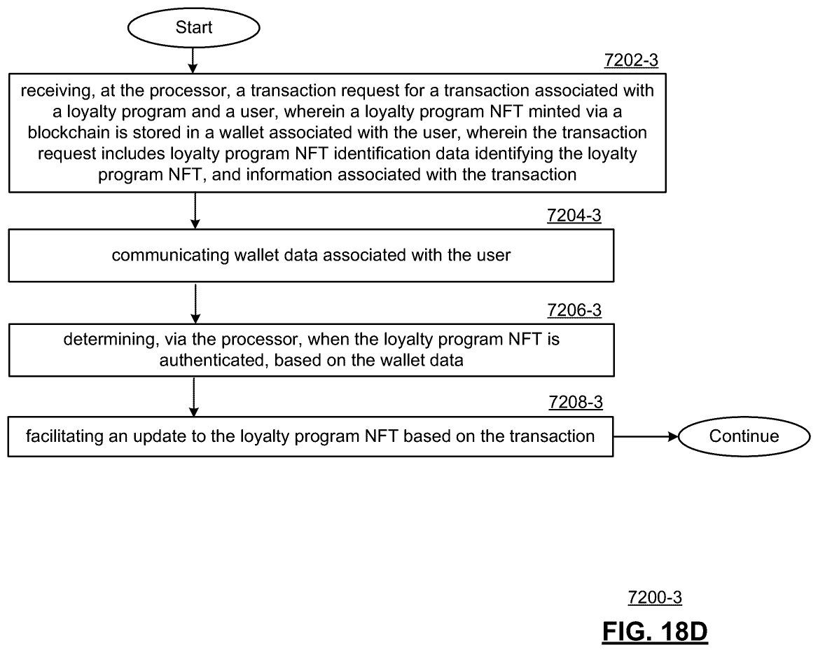

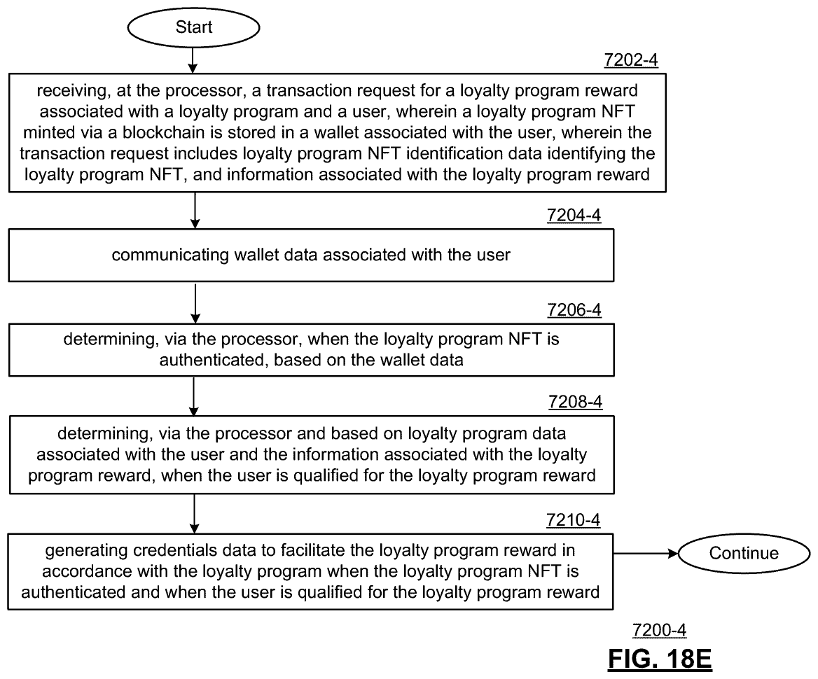

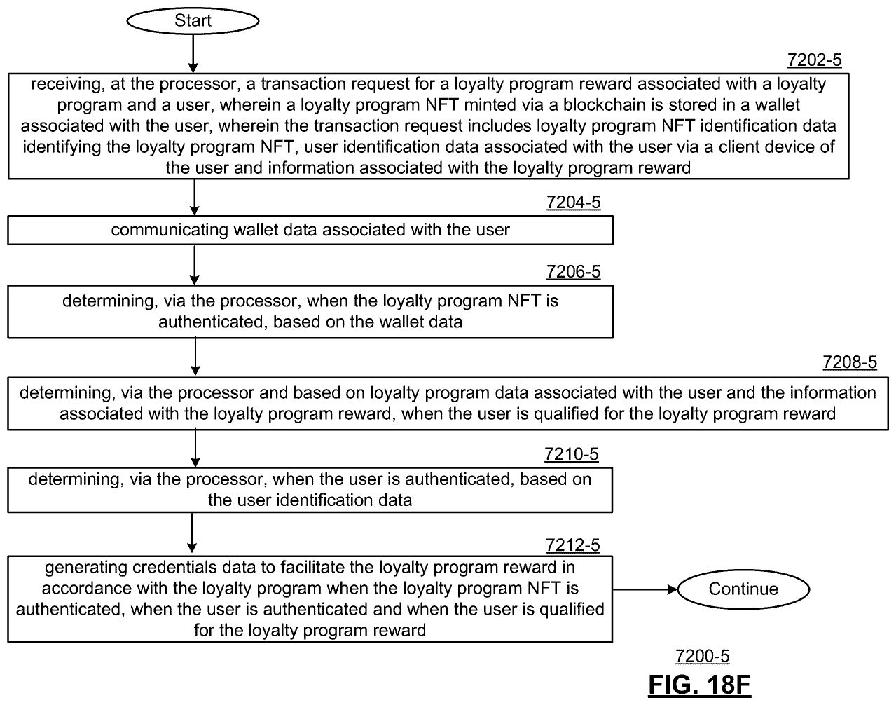

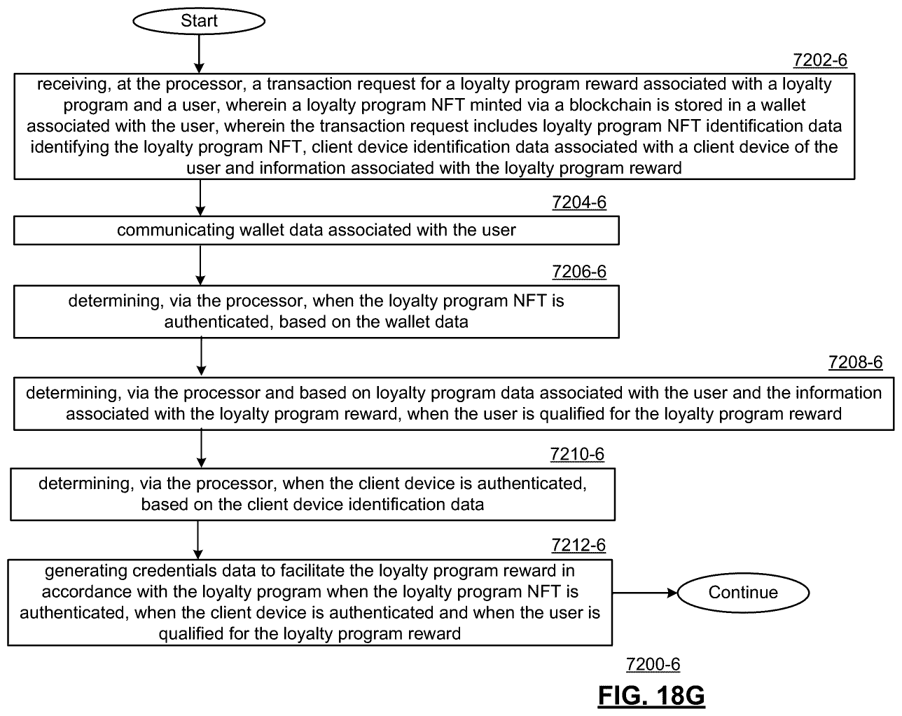

FIG. 18A presents a pictorial block/flow diagram/flow representation of a further example of transaction authentication. In this case a client device, such as client device 825 or 6020 of an NFT owner includes an NFT wallet 6725 that stores one or more NFTs. These NFTs can include a loyalty program NFT to be used to authenticate a transaction associated with the owner via an NFT platform such as NFT transaction authenticator 6022 with a third party associated with the loyalty program. The client device and the NFT transaction authenticator 6022 share wallet data 6726 via a secure link, such as via NFC communication or other secure link, that can be used to authenticate the NFT as part of the transaction.

In various examples, the loyalty program is a customer loyalty program associated with a business that tracks transactions of a customer and grants benefits based on the amount/type of transactions, for example, enhanced status with the business and/or other businesses, discounts, rewards, coupons, invitations to events, gift cards, etc. The loyalty program NFT can be used to authenticate the user to a transaction with the business, to authenticate the user and/or device with association with the user's loyalty program, to redeem rewards, to track the user's status in terms of the amount/type of transactions and/or to otherwise support the loyalty program and the user's access thereof.

FIG. 18B presents a flowchart representation 7200-1 of an example method. In particular, a method is presented for use in conjunction with one or more functions or features described herein. For example, the method can be implemented via a POS platform such as POS platform 6727, an NFT platform or other system that includes a processor and a user interface.

Step 7202-1 includes receiving, at the processor, a transaction request for a transaction associated with a loyalty program and a user, wherein a loyalty program NFT minted via a blockchain is stored in a wallet associated with the user, wherein the transaction request includes loyalty program NFT identification data identifying the loyalty program NFT, and information associated with the transaction. Step 7204-1 includes communicating wallet data associated with the user. Step 7206-1 includes determining, via the processor, when the loyalty program NFT is authenticated, based on the wallet data. Step 7208-1 includes generating credentials data to facilitate the transaction request in accordance with the loyalty program when the loyalty program NFT is authenticated.

FIG. 18C presents a flowchart representation 7200-2 of an example method. In particular, a method is presented for use in conjunction with one or more functions or features described herein. For example, the method can be implemented via a POS platform such as POS platform 6727, an NFT platform or other system that includes a processor and a user interface.

Step 7202-2 includes receiving, at the processor, a transaction request for a transaction associated with a loyalty program and a user, wherein a loyalty program NFT minted via a blockchain is stored in a wallet associated with the user, wherein the transaction request includes loyalty program NFT identification data identifying the loyalty program NFT, and information associated with the transaction. Step 7204-2 includes communicating wallet data associated with the user. Step 7206-2 includes determining, via the processor, when the loyalty program NFT is authenticated, based on the wallet data. Step 7208-2 includes generating credentials data to facilitate the transaction request in accordance with the loyalty program when the loyalty program NFT is authenticated. Step 7210-2 includes facilitating an update to the loyalty program NFT based on the transaction.

FIG. 18D presents a flowchart representation 7200-3 of an example method. In particular, a method is presented for use in conjunction with one or more functions or features described herein. For example, the method can be implemented via a POS platform such as POS platform 6727, an NFT platform or other system that includes a processor and a user interface.

Step 7202-3 includes receiving, at the processor, a transaction request for a transaction associated with a loyalty program and a user, wherein a loyalty program NFT minted via a blockchain is stored in a wallet associated with the user, wherein the transaction request includes loyalty program NFT identification data identifying the loyalty program NFT, and information associated with the transaction.

Step 7204-3 includes communicating wallet data associated with the user. Step 7206-3 includes determining, via the processor, when the loyalty program NFT is authenticated, based on the wallet data. Step 7208-3 includes facilitating an update to the loyalty program NFT based on the transaction.

FIG. 18E presents a flowchart representation 7200-4 of an example method. In particular, a method is presented for use in conjunction with one or more functions or features described herein. For example, the method can be implemented via a POS platform such as POS platform 6727, an NFT platform or other system that includes a processor and a user interface.

Step 7202-4 includes receiving, at the processor, a transaction request for a loyalty program reward associated with a loyalty program and a user, wherein a loyalty program NFT minted via a blockchain is stored in a wallet associated with the user, wherein the transaction request includes loyalty program NFT identification data identifying the loyalty program NFT, and information associated with the loyalty program reward. Step 7204-4 includes communicating wallet data associated with the user. Step 7206-4 includes determining, via the processor, when the loyalty program NFT is authenticated, based on the wallet data. Step 7208-4 includes determining, via the processor and based on loyalty program data associated with the user and the information associated with the loyalty program reward, when the user is qualified for the loyalty program reward. Step 7210-4 includes generating credentials data to facilitate the loyalty program reward in accordance with the loyalty program when the loyalty program NFT is authenticated and when the user is qualified for the loyalty program reward.

FIG. 18F presents a flowchart representation 7200-5 of an example method. In particular, a method is presented for use in conjunction with one or more functions or features described herein. For example, the method can be implemented via a POS platform such as POS platform 6727, an NFT platform or other system that includes a processor and a user interface.

Step 7202-5 includes receiving, at the processor, a transaction request for a loyalty program reward associated with a loyalty program and a user, wherein a loyalty program NFT minted via a blockchain is stored in a wallet associated with the user, wherein the transaction request includes loyalty program NFT identification data identifying the loyalty program NFT, user identification data associated with the user via a client device of the user and information associated with the loyalty program reward. Step 7204-5 includes communicating wallet data associated with the user. Step 7206-5 includes determining, via the processor, when the loyalty program NFT is authenticated, based on the wallet data.

Step 7208-5 includes determining, via the processor and based on loyalty program data associated with the user and the information associated with the loyalty program reward, when the user is qualified for the loyalty program reward. Step 7210-5 includes determining, via the processor, when the user is authenticated, based on the user identification data. Step 7212-5 includes generating credentials data to facilitate the loyalty program reward in accordance with the loyalty program when the loyalty program NFT is authenticated, when the user is authenticated and when the user is qualified for the loyalty program reward.

FIG. 18G presents a flowchart representation 7200-6 of an example method. In particular, a method is presented for use in conjunction with one or more functions or features described herein. For example, the method can be implemented via a POS platform such as POS platform 6727, an NFT platform or other system that includes a processor and a user interface.

Step 7202-6 includes receiving, at the processor, a transaction request for a loyalty program reward associated with a loyalty program and a user, wherein a loyalty program NFT minted via a blockchain is stored in a wallet associated with the user, wherein the transaction request includes loyalty program NFT identification data identifying the loyalty program NFT, client device identification data associated with a client device of the user and information associated with the loyalty program reward. Step 7204-6 includes communicating wallet data associated with the user. Step 7206-6 includes determining, via the processor, when the loyalty program NFT is authenticated, based on the wallet data.

Step 7208-6 includes determining, via the processor and based on loyalty program data associated with the user and the information associated with the loyalty program reward, when the user is qualified for the loyalty program reward. Step 7210-6 includes determining, via the processor, when the client device is authenticated, based on the client device identification data. Step 7212-6 includes generating credentials data to facilitate the loyalty program reward in accordance with the loyalty program when the loyalty program NFT is authenticated, when the client device is authenticated and when the user is qualified for the loyalty program reward.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if item/signal A matches item/signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein involve NFTs that are generated (“minted”) and secured via blockchain or other decentralized computer network technology. The distributed nature of these technologies over different nodes, the contemporaneous nature of geographically distinct calculations, coupled with the extreme computational complexity of the required calculations means that these decentralized computer network technologies cannot practically be performed by the human mind.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more examples have been expressly described herein, other combinations of these features and functions are likewise possible. The present disclosure is not limited by the particular examples disclosed herein and expressly incorporates these other combinations.

What is claimed is:

1. A method for use with a client device that includes a processor and a memory and that utilizes a graphical user interface to interact with a user, the method comprising:
reading, via the client device, an optical code associated with a coupon;
sending, via the client device and in response to reading the optical code, a request to download a coupon non-fungible token (NFT) associated with the coupon from an NFT distribution platform;
downloading from the NFT distribution platform, via the client device, the coupon NFT associated with the coupon; and
storing the coupon NFT in a wallet associated with a user of the client device.

2. The method of claim 1, wherein the coupon is associated one of a series of coupons.

3. The method of claim 2, further comprising:
downloading from the NFT distribution platform, via the client device, other coupon NFTs associated with other coupons of the series of coupons.

4. The method of claim 3, further comprising:
determining when the client device has downloaded the other coupon NFTs associated with each coupon of the series of coupons; and
facilitating a transaction utilizing the series of coupons, via the client device, when the client device has downloaded coupon NFTs associated with each coupon of the series of coupons.

5. The method of claim 1, wherein the coupon NFT is minted via a blockchain.

6. The method of claim 1, further comprising:
receiving, at the processor, a transaction request corresponding to an item, wherein the item is associated with the coupon NFT, wherein the transaction request includes coupon NFT identification data identifying the coupon NFT;
determining, via the processor, when the coupon NFT is authenticated.

7. The method of claim 6, wherein the transaction request further includes item data associated with the item.

8. The method of claim 7, wherein the method further comprises:
determining, via the processor and based on the item data, when the coupon NFT is associated with the item; and
generating credentials data to grant the transaction request when the coupon NFT is authenticated and when the coupon NFT is associated with the item.

9. The method of claim 1, wherein the wallet is associated with a purchaser of an item associated with the coupon NFT.

10. The method of claim 9, wherein the method further comprises:
receiving, at the processor, a transaction request corresponding to the item, wherein the transaction request includes coupon NFT identification data identifying the coupon NFT received via the wallet and item data associated with the item;
determining, via the processor, when the coupon NFT is authenticated;
determining, via the processor and based on the item data, when the coupon NFT is associated with the item; and
generating credentials data to grant the transaction request when the coupon NFT is authenticated and when the coupon NFT is associated with the item.

11. A client device comprises:
a network interface configured to communicate via a network;
a processor;
a non-transitory machine-readable storage medium that stores operational instructions that, when executed by the processor, cause the processor to perform operations that include:
reading, via the client device, an optical code associated with a coupon;
sending, via the client device and in response to reading the optical code, a request to download a coupon non-fungible token (NFT) associated with the coupon from an NFT distribution platform;
downloading from the NFT distribution platform, via the client device, the coupon NFT associated with the coupon; and
storing the coupon NFT in a wallet associated with a user of the client device.

12. The client device of claim 11, wherein the coupon is associated one of a series of coupons.

13. The client device of claim 12, wherein the operations further include:
downloading from the NFT distribution platform, via the client device, other coupon NFTs associated with other coupons of the series of coupons.

14. The client device of claim 13, wherein the operations further include:
determining when the client device has downloaded the other coupon NFTs associated with each coupon of the series of coupons; and
facilitating a transaction utilizing the series of coupons, via the client device, when the client device has downloaded coupon NFTs associated with each coupon of the series of coupons.

15. The client device of claim 11, wherein the coupon NFT is minted via a blockchain.

16. The client device of claim 11, wherein the operations further include:
receiving, at the processor, a transaction request corresponding to an item, wherein the item is associated with the coupon NFT, wherein the transaction request includes coupon NFT identification data identifying the coupon NFT;
determining, via the processor, when the coupon NFT is authenticated.

17. The client device of claim 16, wherein the transaction request further includes item data associated with the item.

18. The client device of claim 17, wherein the operations further include:
determining, via the processor and based on the item data, when the coupon NFT is associated with the item; and
generating credentials data to grant the transaction request when the coupon NFT is authenticated and when the coupon NFT is associated with the item.

19. The client device of claim 11, wherein the wallet is associated with a purchaser of an item associated with the coupon NFT.

20. The client device of claim 19, wherein the operations further include: receiving, at the processor, a transaction request corresponding to the item, wherein the transaction request includes coupon NFT identification data identifying the coupon NFT received via the wallet and item data associated with the item;
determining, via the processor, when the coupon NFT is authenticated;
determining, via the processor and based on the item data, when the coupon NFT is associated with the item; and
generating credentials data to grant the transaction request when the coupon NFT is authenticated and when the coupon NFT is associated with the item.
